(19) United States
(12) Patent Application Publication
(10) Pub. No.: US 2023/0019794 A1
(43) Pub. Date: Jan. 19, 2023

(54) AUTOMATIC ITEM RECOMMENDATIONS BASED ON VISUAL ATTRIBUTES AND COMPLEMENTARITY

(71) Applicant: AMELUE TECHNOLOGIES INC., North Vancouver (CA)

(72) Inventors: Frank Alan SAVILLE, North Vancouver (CA); Christine Kimberly SAVILLE, North Vancouver (CA)

(73) Assignee: AMELUE TECHNOLOGIES INC., North Vancouver, BC (CA)

(21) Appl. No.: 17/779,910

(22) PCT Filed: Nov. 24, 2020
(86) PCT No.: PCT/CA2020/051601

§ 371 Date: May 25, 2022

Related U.S. Application Data
(60) Provisional application No. 62/940,136, filed on Nov. 25, 2019.

(51) Int. Cl. G06Q 30/06; G06F 16/55; G06F 16/54; G06F 16/532

(52) U.S. Cl. CPC G06Q 30/0631; G06F 16/55; G06F 16/54; G06F 16/532

(57) ABSTRACT

A user device is caused to display a visual attribute representation for a plurality of visual attributes. Each visual attribute is based at least in part on an image and each visual attribute representation is selectable. A processor is caused to identify a plurality of items, each item is associated with a visual attribute matching at least one of the plurality of visual attributes. The items are classified a first set and a second set. The items in the first and second sets are mutually exclusive and simultaneously displayed. If the processor receives a single selection of a first visual attribute representation of a first visual attribute of the plurality of visual attributes, the first set consist of items associated with a visual attribute matching the first visual attribute and the second set comprise items associated with a visual attribute matching at least one of the plurality of visual attributes.

### FIELD

This disclosure relates generally to recommending items based on visual attributes associated with the items and complementarity of the items, and more particularly to recommending items based on visual attributes which match one or more visual attributes associated with an image or a palette and based on complementarity of items with other items.

### BACKGROUND

Shopping for items online may enable users to purchase a large variety of items from a large variety of vendors. However, traditional online shopping vendors may present users with too many item options, may present users with items in a random order or a haphazard manner, or may present users with unrelated or irrelevant items. Traditional online shopping may also present users with items that do not meet current needs or desires, such as items which are behind current trends or which are not popular in a demographic. In such traditional online shopping environments, users may be unable to purchase desirable items and unable to visualize a desirable combination of items or a desirable ensemble.

### SUMMARY

In one embodiment, there is provided a computer-implemented method involving causing at least one processor configured with specific computer-executable instructions to cause a user device to display a visual attribute representation for each visual attribute of a plurality of visual attributes generated from at least one image. Each visual attribute is based at least in part on the at least one image and each visual attribute representation is selectable by a user of the user device. The computer-implemented method further involves causing the at least one processor to identify a plurality of items based on information stored in an electronic database. Each item of the plurality of items is associated with a visual attribute matching at least one visual attribute of the plurality of visual attributes. The computer-implemented method further involves causing the at least one processor to classify the plurality of items into a first set and a second set. The items in the first set and the items in the second set are mutually exclusive. If the at least one processor receives a single selection of a first visual attribute representation of a first visual attribute of the plurality of visual attributes, the first set consist of items associated with a visual attribute matching the first visual attribute and the second set comprise items associated with a visual attribute matching at least one visual attribute of the plurality of visual attributes. The computer-implemented method further involves causing the at least one processor to cause the user device to simultaneously display the first set and the second set proximate to each other.

Other aspects and features of the present disclosure will become apparent to those ordinarily skilled in the art upon review of the following description of specific embodiments of the disclosure in conjunction with the accompanying figures.

### BRIEF DESCRIPTION OF THE DRAWINGS

FIG. 1 is a schematic representation of an item recommendation server for recommending items in accordance with one embodiment.

FIG. 2 is an entity-relationship diagram of an application database of the assessment server of FIG. 1 in accordance with one embodiment.

FIG. 3 is a schematic representation of a user entry of the application database of FIG. 2 in accordance with one embodiment.

FIG. 4 is a schematic representation of an image entry of the application database of FIG. 2 in accordance with one embodiment.

FIG. 5 is a schematic representation of a palette entry of the application database of FIG. 2 in accordance with one embodiment.

FIG. 6 is a schematic representation of a visual attribute entry of the application database of FIG. 2 in accordance with one embodiment.

FIG. 7 is a schematic representation of an item entry of the application database of FIG. 2 in accordance with one embodiment.

FIG. 8 is a schematic representation of a vendor entry of the application database of FIG. 2 in accordance with one embodiment.

FIG. 9 is a schematic representation of a taxonomy entry of the application database of FIG. 2 in accordance with one embodiment.

FIG. 10 is a schematic representation of an interaction history entry of the application database of FIG. 2 in accordance with one embodiment.

FIG. 11 is a schematic representation of a combination history entry of the application database of FIG. 2 in accordance with one embodiment.

FIG. 12 is a schematic representation of a purchase history entry of the application database of FIG. 2 in accordance with one embodiment.

FIG. 13 is a schematic representation of an embodiment of a login page generated according to user interface codes of the item recommendation server of FIG. 1.

FIG. 14 is a schematic representation of an embodiment of a home page generated according to the user interface codes of the item recommendation server of FIG. 1.

FIG. 15 is a schematic representation of an embodiment of a user profile page generated according to the user interface codes of the item recommendation server of FIG. 1.

FIG. 16 is a schematic representation of an embodiment of an image page generated according to the user interface codes of the item recommendation server of FIG. 1.

FIG. 17 is a schematic representation of an embodiment of a visual attribute search page generated according to the user interface codes of the item recommendation server of FIG. 1.

FIG. 18 is a schematic representation of an embodiment of an “album mode” of a select image page generated according to the user interface codes of the item recommendation server of FIG. 1.

FIG. 19 is a schematic representation of an embodiment of a “camera mode” of the select image page generated according to the user interface codes of the item recommendation server of FIG. 1.

FIG. 20 is a schematic representation of an embodiment of a confirm image page generated according to the user interface codes of the item recommendation server of FIG. 1.

FIG. 21 is a schematic representation of process image codes stored in program memory of the item recommendation server of FIG. 1 in accordance with one embodiment.

FIG. 22 is a schematic representation of an embodiment of an upload image page generated according to the user interface codes of the item recommendation server of FIG. 1.

FIG. 23 is a schematic representation of modified version of the upload image page of FIG. 22 in accordance with one embodiment.

FIG. 24 is a schematic representation of process item codes stored in program memory of the item recommendation server of FIG. 1 in accordance with one embodiment.

FIG. 25 is a schematic representation of an embodiment of a shop image page generated according to the user interface codes of the item recommendation server of FIG. 1.

FIGS. 26A and 26B are schematic representations of a visual attribute array of the shop image page of FIG. 25 in accordance with one embodiment.

FIGS. 27A to 27C are schematic representations of recommend items codes stored in program memory of the item recommendation server of FIG. 1 in accordance with one embodiment.

FIG. 28 is a schematic representation of an embodiment of a recommend items page generated according to the user interface codes of the item recommendation server of FIG. 1.

FIG. 29 is a schematic representation of a modified version of the recommend items page of FIG. 28 in accordance with one embodiment.

FIG. 30 is a schematic representation of the recommend items page of FIG. 28 in accordance with another embodiment.

FIG. 31 is a schematic representation of the recommend items page of FIG. 28 in accordance with another embodiment.

FIG. 32 is a schematic representation of the recommend items page of FIG. 28 in accordance with another embodiment.

FIG. 33 is a schematic representation of an embodiment of a palette selection page generated according to the user interface codes of the item recommendation server of FIG. 1.

FIG. 34 is a schematic representation of an embodiment of a custom palette page generated according to the user interface codes of the item recommendation server of FIG. 1.

FIG. 35 is a schematic representation of an embodiment of a shopping cart page generated according to the user interface codes of the item recommendation server of FIG. 1.

### DETAILED DESCRIPTION

Methods and systems for providing recommendations for items based on a plurality visual attributes generated from an image and/or a custom palette and on complementarity of the items with other items are disclosed.

A user, upon viewing an image or a palette with desirable visual attributes, may wish to locate and purchase items which have those desirable visual attributes. Such “visual attributes” include without limitation, colors, patterns, textures, reflectivity etc. Further, when a user is shopping or searching for a particular item, the user may be interested in “complementary” items which match, or are often purchased together with, the initially shopped for item. “Complementary” items include without limitation items which fall into macro-item categories that are often found together (tops and bottoms, shoes and socks, sofas and cushions etc. for example), items which fall into micro-item categories that are often found together (dress shirts and suits, dresses and heels, etc. for example), items which have a history of being selected and viewed by users when the users are searching for another item (“interaction history”), items which have a history of being combined by users (“combination history”), items which have a history of being purchased by users together (“purchase history”), and items which are simply associated with visual attributes which match one or more visual attributes of the desirable visual attributes of an image or a palette. Further, items may be “complementary” to other items at an item-level (a specific dress is complementary with a specific pair of shoes for example), and items may also be “complementary” to other items at an category-level (dresses are generally complementary with heels for example).

Presenting the user with multiple complementary items which have the desirable visual attributes may encourage the user to purchase more than one item or purchase more and different items than initially intended.

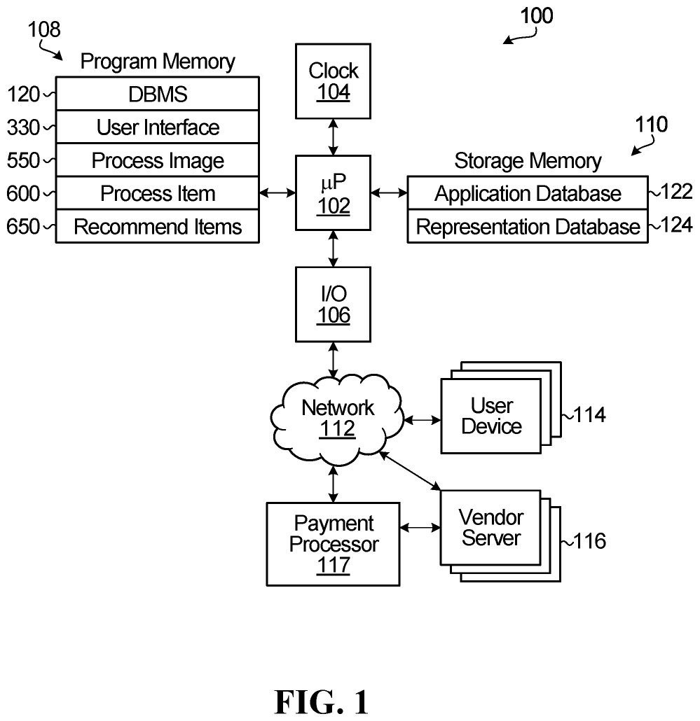

An illustrative embodiment of an item recommendation server is shown generally at 100 in FIG. 1. The item recommendation server 100 includes a processor circuit, which in the embodiment shown includes at least one microprocessor 102, and a clock 104, an input/output (“I/O”) interface 106, a program memory 108, and a storage memory 110, all in communication with the microprocessor 102. In other embodiments, the item recommendation server 100 may include different components, a greater or a fewer number of components, and can be structured differently.

The clock 104 maintains values representing a current date and time and provides the values to the microprocessor 102 for storage in various data stores in the storage memory 110 as described below. The I/O interface 106 includes an interface for communicating, over components of a network shown generally at 112, with at least one user device 114 and at least one vender server 116, and in some embodiments, at least one payment processor 117.

Although only a few user devices 114 and a few vendor servers 116 are shown in FIG. 1, other embodiments may include a larger or a fewer number of user devices 114 or vendor servers 116. In some embodiments, the microprocessor 102 may communicate with the user devices 114 and the vendor servers 116 without the network 112.

The program and storage memories 108 and 110 may each be implemented as one or a combination of a random-access memory (“RAM”), a hard disk drive (“HDD”), and other computer-readable and/or -writable memory. In other embodiments, the item recommendation server 100 may be partly or fully implemented using different hardware logic, which may include discrete logic circuits and/or an application specific integrated circuit (“ASIC”), for example. In some embodiments, the microprocessor 102 may communicate with the storage or program memories 110 and 108 via the network 112 or another network.

The storage memory 110 may store information obtained by the microprocessor 102 and may be an information or data store. The program memory 108 includes various blocks of code, including codes for directing the microprocessor 102 to execute various functions of the item recommendation server 100, such as image processing services, item processing services and item recommendation services. The program memory 108 also includes database management system (“DBMS”) codes 120 for managing an application database 122 and a representation database 124 in the storage memory 110. In other embodiments, the program memory 108 may include additional or alternative blocks of code.

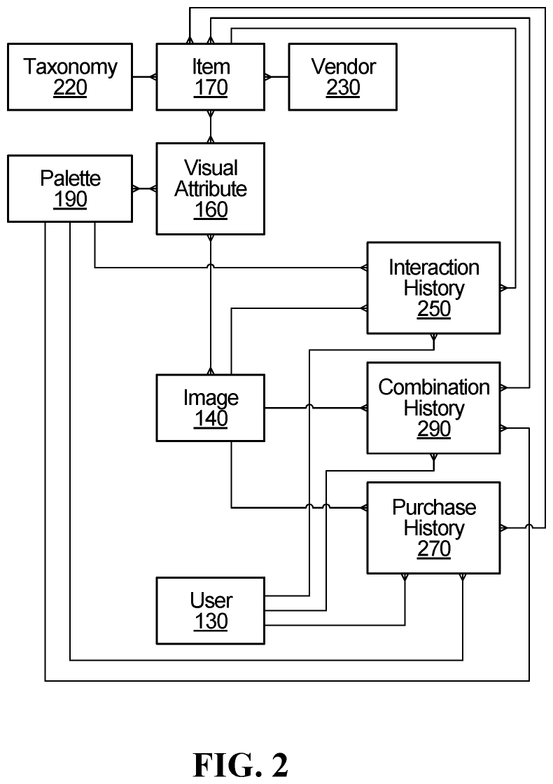

An embodiment of the application database 122 is shown generally in FIG. 2; in the embodiment shown, application database 122 is a relational database including a plurality of tables. The various tables of the application database 122 can each store various. The various entries each include various fields, and an instance of such an entry can store specific values in such fields. In other embodiments, the application database 122 may include different components, a greater or a fewer number of components, can be structured differently, can be a graph database, and can be an unstructured database. The representation database 124 may store representations of different images, items, palettes and visual attributes.

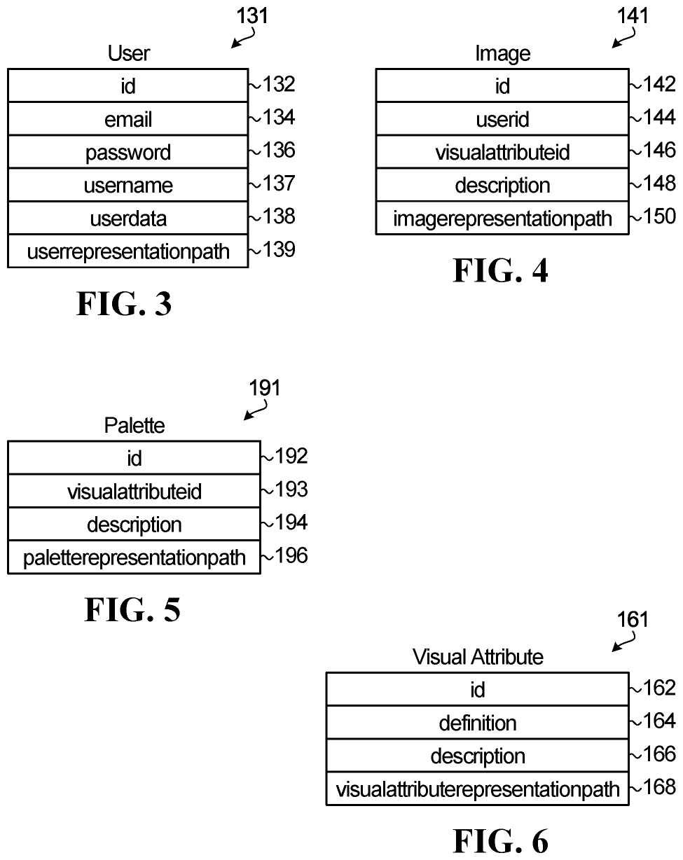

Referring now to FIG. 2, in the embodiment shown, the application database 122 includes a user table 130 that can store any number of instances of a user entry, an embodiment of which is shown generally at 131 in FIG. 3. An instance of the user entry 131 stores data associated with a user registered with the item recommendation server 100 that may access the item recommendation server 100 through one or more user devices 114 (shown in FIG. 1). In the embodiment of FIG. 3, the user entry 131 includes an identifier field 132 for storing an integer (a user identifier) assigned by the DBMS codes 120 (shown in FIG. 1) to identify an instance of the user entry 131 uniquely in the user table 130. The user entry 131 may also include an email field 134 for storing an electronic mail address, a password field 136 for storing a password and a username field 137 for storing a username. A user associated with the user entry 131 may access the item recommendation server 100 by using the email or username stored in fields 134 and 137 in combination with the password stored in field 136. The user entry 131 may also include a user data field 138 for storing various demographic information associated with the user, such as “age”, “gender”, “address” and “income range” for example. In the embodiment shown, user data field 138 is a single field, but in other embodiments, the user data field 138 may be a plurality of fields. The user entry 131 may also include a user representation path field 139 for storing a uniform resource identifier (“URI”) identifying a storage location of a representation of the user in the representation database 124 (shown in FIG. 1) to allow the microprocessor 102 to retrieve a representation of the user for display.

Referring back to FIG. 2, the application database 122 also includes an image table 140 that can store any number of instances of an image entry, an embodiment of which is shown generally at 141 in FIG. 4. An instance of image entry 141 represents a stored image which may be processed by the item recommendation server 100 to generate image posts and/or to extract one or more visual attributes. In the embodiment of FIG. 4, the image entry 141 includes an identifier field 142 storing an integer (an image identifier) assigned by the DBMS codes 120 (shown in FIG. 1) to identify an instance of the image entry 141 uniquely in the image table 140. The image entry 141 may also include a user identifier field 144 storing an user identifier stored in the identifier field 132 of an instance of the user entry 131 (shown in FIG. 3), such that an instance of the image entry 141 identifies an instance of the user entry 131 to associate an image with a particular user (images which are uploaded by the user would be associated with that user for example). In the embodiment shown, multiple instances of the image entry 141 can identify a particular instance of the user entry 131, indicating that a single user can upload multiple images. The image entry 141 may also include a visual attribute identifier field 146 storing a visual attribute identifier stored in an identifier field 162 of an instance of a visual attribute entry 161 (shown in FIG. 6) described below, such that an instance of the image entry 141 identifies an instance of the visual attribute entry 161 to associate an image with a particular visual attribute (image is associated with a color, a pattern, or a texture). In the embodiment shown, an instance of the image entry 141 can identify multiple instances of the visual attribute entry 161 indicating that a particular image can be associated with more than one visual attribute. The image entry 141 may also include a description field 148 storing a description of the image, which may be a text string and may provide keywords associated with the image, such as “blue” or “cityscape” or “outfit” or “female”. The image entry 141 may also include an image representation path field 150 storing a URI identifying a storage location of the image in the representation database 124 (shown in FIG. 1) to allow the microprocessor 102 to retrieve the image for display.

Referring back to FIG. 2, the application database 122 also includes a palette table 190 that can store any number of instances of a palette entry, an embodiment of which is shown generally at 191 in FIG. 5. An instance of the palette entry 191 represents a stored palette including a collection of visual attributes. In certain embodiments, the visual attributes associated with a palette may originate from an image stored in the representation database 124. In the embodiment of FIG. 5, the palette entry 191 includes an identifier field 192 for storing an integer (a palette identifier) assigned by the DBMS codes 120 (shown in FIG. 1) to identify an instance of the palette entry 191 uniquely in the palette table 190. The palette entry 191 may also include a visual attribute identifier field 146 for storing a visual attribute identifier stored in the identifier field 162 of an instance of the visual attribute entry 161 (shown in FIG. 6) described below, such that an instance of the palette entry 191 identifies an instance of the visual attribute entry 161 to associate a palette with a particular visual attribute. In the embodiment shown, an instance of the palette entry 191 can identify multiple instances of the visual attribute entry 161 indicating that a particular palette can be associated with more than one visual attribute. The palette entry 191 may also include a description field 194 for storing a description of the custom palette, which may be a text string and may provide some keywords associated with the palette, such as “rust” or “spring” for example. The palette entry 191 may also include a palette representation path field 196 for storing a URI identifying a storage location of representations of the custom palette in the representation database 124 (shown in FIG. 1) to allow the microprocessor 102 to retrieve a representation of the custom palette for display.

Referring back to FIG. 2, the application database 122 also includes a visual attribute table 160 that can store any number of instances of the visual attribute entry 161, an embodiment of which is shown generally in FIG. 6. An instance of the visual attribute entry 161 represents a visual attribute which may be associated with an image, a palette, or an item. In the embodiment of FIG. 6, the visual attribute entry 161 includes an identifier field 162 storing an integer (a visual attribute identifier) assigned by the DBMS codes 120 (shown in FIG. 1) to identify an instance of the visual attribute entry 161 uniquely in the visual attribute table 160. The visual attribute entry 161 may also include a definition field 164 for storing a definition of the visual attribute that can be compared to definitions of other visual attributes to determine if the two visual attributes match and the degree of match between the two visual attributes. For example, if the visual attribute is a color, the definition field 164 may store the red, green and blue pixel values associated with the color; if the visual attribute is a pattern or a texture, the definition field 164 may store a visual attribute representation representing the pattern or the texture. The visual attribute entry 161 may also include a description field 166 for storing a description of the visual attribute, which may be a text string and may provide some keywords associated with and for identifying the visual attribute, such as “green”, “periwinkle”, “aqua”, “yellow”, “strawberry”, “fuchsia”, “plaid”, or “floral” for example. The visual attribute entry 161 may also include a visual attribute representation path field 168 for storing a URI identifying a storage location of visual attribute representations in the representation database 124 to allow the microprocessor 102 to retrieve a representation of the visual attribute for display.

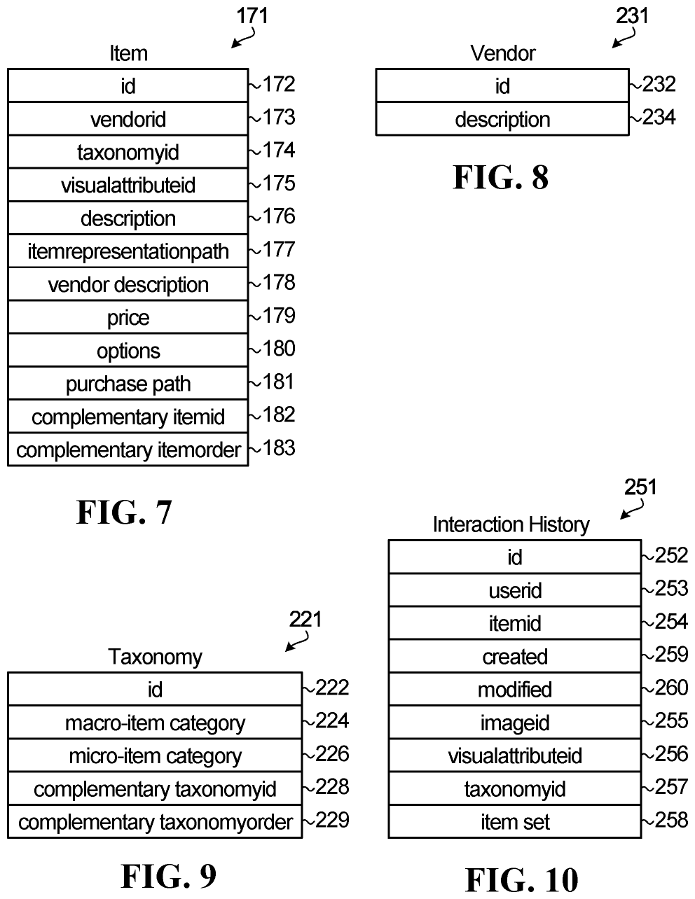

Referring back to FIG. 2, the application database 122 also includes an item table 170 that can store any number of instances of the item entry, an embodiment of which is shown generally at 171 in FIG. 7. An instance of item entry 171 represents a stored item which may be obtained by the microprocessor 102 from one or more vendor servers 116 (or websites operated by one or more vendors) and which may be recommended by the microprocessor 102 to a user. In the embodiment of FIG. 7, the item entry 171 includes an identifier field 172 storing an integer (an item identifier) assigned by the DBMS codes 120 (shown in FIG. 1) to identify an instance of the item entry 171 uniquely in the item table 170. The item entry 171 may also include a vendor identifier field 173 for storing an vendor identifier stored in an identifier field 232 of an instance of a vendor entry 231 (shown in FIG. 8) described below, such that an instance of the item entry 171 identifies an instance of the vendor entry 231 to associate an item with a particular vendor (items which are retrieved by the microprocessor 102 from a vendor server 116 operated by a particular vendor would be associated with that vendor for example). In the embodiment shown, a particular instance of the item entry 171 can identify a particular instance of the vendor entry 231, indicating that a particular item is associated with one vendor. In other embodiments, a particular item may be associated with more than one vendor. The item entry 171 may also include: a vendor description field 178 for storing a description of the item from the vendor, and which may be presented to a user when the user is examining the item to determine whether the user would like to purchase the item; a price field 179 for storing a price of the item retrieved from the vendor, and which may be presented to the user; and an options field 180 for storing various options associated with item provided by the vendor, such as clothing size, shoe widths, and furniture configurations for example, and which may be presented to the user. The item entry 171 may also include a purchase path field 181 for storing information to facilitate purchase of the item by a user from the vendor, such as a link to a vendor's webpage for purchasing the item or information which facilitates direct communication between the item recommendation server 100 and the payment processor 117 associated with the vendor sever 116 to facilitate direct purchase of the item through the item recommendation server 100.

The item entry 171 may also include a taxonomy identifier field 174 for storing a taxonomy identifier stored in an identifier field 222 of an instance of a taxonomy entry 221 (shown in FIG. 9), such that an instance of the item entry 171 identifies an instance of the taxonomy entry 221 to associate an item with a particular item category represented by the taxonomy entry 221. In the embodiment shown, the item entry 171 can identify multiple instances of the taxonomy entry 221, indicating that an item can be associated with more than one item category. The item entry 171 may also include a visual attribute identifier field 175, storing a visual attribute identifier stored in the identifier field 162 of an instance of the visual attribute entry 161 (shown in FIG. 3), such that an instance of the item entry 171 identifies an instance of the visual attribute entry 161 to associate an item with the visual attribute. In the embodiment shown, an instance of the item entry 171 can identify multiple instances of the visual attribute entry 161, indicating that a particular item can be associated with one or more visual attributes. The item entry 171 may also include a description field 176 for storing a description of the item, which may be a text string and may provide some keywords associated with the item, such as “shoes” or “heels” or “SS 2019” for example. The item entry 171 may also include an item representation path field 177 for storing a URI identifying a storage location of one or more representations of the item in the representation database 124 (shown in FIG. 1) to allow the microprocessor 102 to retrieve one or more representation of the item for display. The item entry 171 may also include a complementary item identifier field 182 for storing an item identifier stored in the identifier field 172 of another instance of the item entry 171 that is complementary to the current item entry 171 and a complementary item order field 183, which may store a level of complementarity of the item identified in the complementary item identifier field 182 with the current item.

Referring back to FIG. 2, the application database 122 also includes a vendor table 230 that can store any number of instances of the vendor entry 231, an embodiment of which is shown in FIG. 8. An instance of vendor entry 231 represents information about a vendor and may represent a source of items obtained by the microprocessor 102. In the embodiment of FIG. 8, the vendor entry 231 includes the identifier field 232 storing an integer (a vendor identifier) assigned by the DBMS codes 120 (shown in FIG. 1) to identify an instance of the vendor entry 231 uniquely in the vendor table 230. The vendor entry 231 also includes description field 234, storing a description of the vendor, and which may include a link back to a vendor website.

Referring back to FIG. 2, the application database 122 also includes a taxonomy table 220 that can store any number of instances of the taxonomy entry 221, an embodiment of which is shown in FIG. 9. An instance of the taxonomy entry 221 stores information about an item category and may identify complementary item categories. In the embodiment shown in FIG. 9, the taxonomy entry 221 includes the identifier field 222 storing an integer (a taxonomy identifier) assigned by the DBMS codes 120 (shown in FIG. 1) to identify an instance of the taxonomy entry 221 uniquely in the taxonomy table 220. The taxonomy entry 221 may also include a macro-item category field 224 and a micro-item category field 226. In certain embodiments, the macro-item category field 224 may store an indication of a broad item category, such as “clothing”, “cosmetics”, “home & garden” or “shoes” for example, and the micro-item category field 226 may store an indication of narrower item types, such as “dress”, “skirt”, “sofa”, “bed” or “heels” for example. In some embodiments, the taxonomy entry 221 may include one of the macro-item category field 224 and the micro-item category field 226. The taxonomy entry 221 may also include: a complementary taxonomy identifier field 228 for storing a taxonomy identifier stored in the identifier field 222 of another instance of the taxonomy entry 221 complementary to the current taxonomy entry 221, such that an instance of the taxonomy entry 221 identifies one or more other instances of complementary taxonomy entries 221; and a complementary taxonomy order field 229 for storing a level of complementarity of the taxonomy identified in the complementary taxonomy identifier field 228 with the current taxonomy.

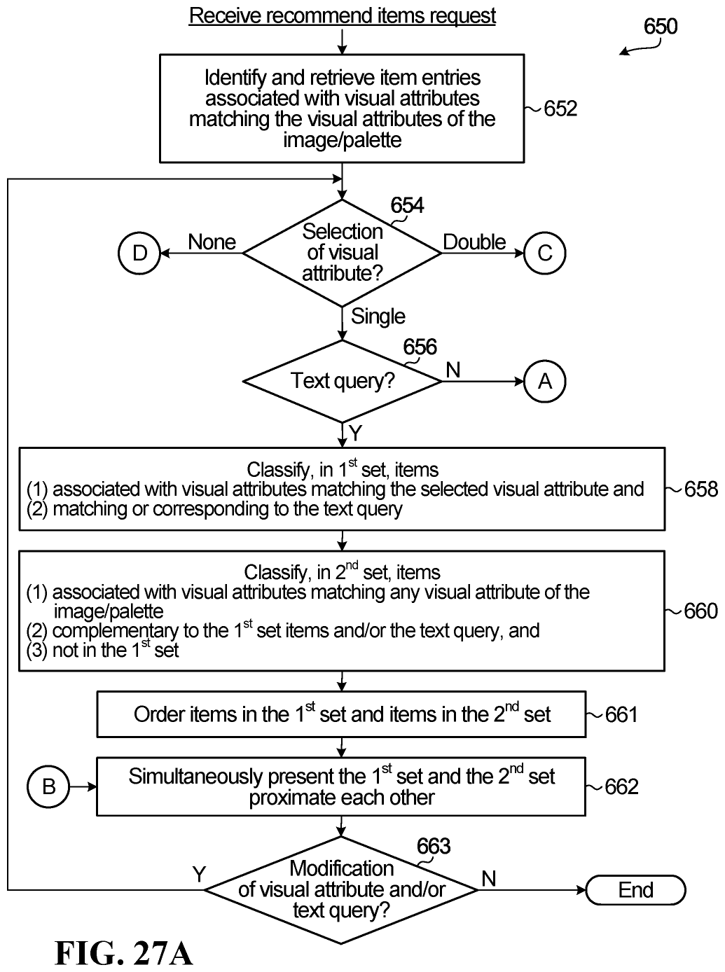

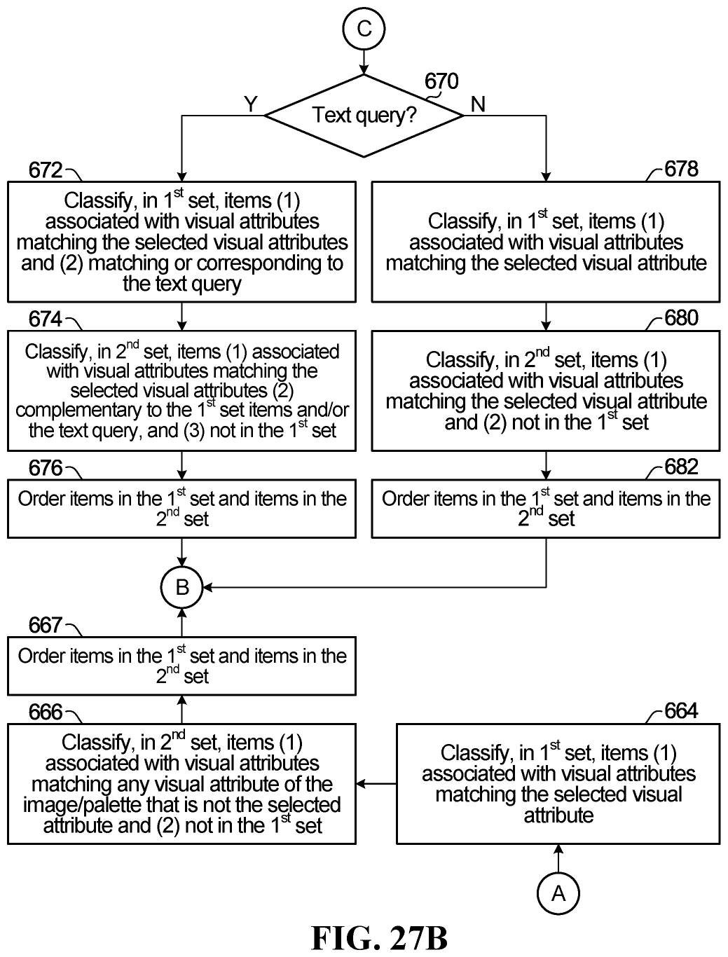

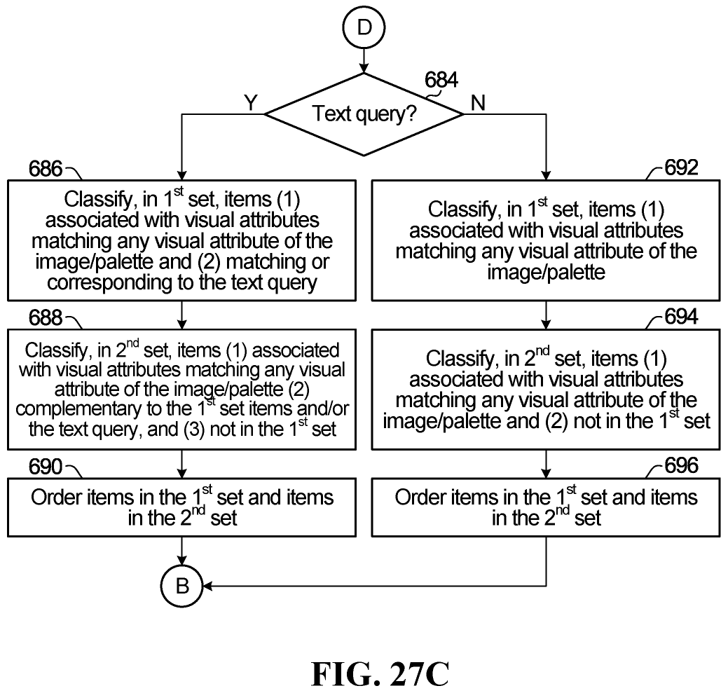

Referring back to FIG. 2, the application database 122 also includes an interaction history table 250 that can store any number of instances of an interaction history entry, an embodiment of which is shown generally at 251 in FIG. 10. An instance of the interaction history entry 251 represents a record of a user interacting with a particular item via an interface implemented by the item recommendation server 100, and may more generally function as a record of which items are being interacted with by users in general, which items may be interacted with by a particular user, and/or which items may be interacted with when recommended by the item recommendation server 100 in association with a particular image or palette. The interaction history entries 251 may be utilized by a complementarity model to determine which items are complementary with other items and/or a ranking model to determine which items should be ordered first in a first set of items and a second set of items as described below in connection with recommend items codes 650 of FIGS. 27A-27C.

In the embodiment shown in FIG. 10, the interaction history entry 251 includes an identifier field 252 storing an integer (an interaction history identifier) assigned by the DBMS codes 120 (shown in FIG. 1) to identify an instance of the interaction history entry 251 uniquely in the interaction history table 250. The interaction history entry 251 may also include: a user identifier field 253 for storing a user identifier stored in the identifier field 132 of an instance of the user entry 131 (shown in FIG. 3), an item identifier field 254 for storing an item identifier stored in the identifier field 172 of an instance of the item entry 171 (shown in FIG. 7), and an image identifier field 255 for storing an image identifier stored in the identifier field 142 of an instance of the image entry 141 (shown in FIG. 4) or a palette identifier stored in the identifier field 192 of a palette entry 191 (shown in FIG. 5). The interaction history entry 251 may further include an item set field 258 for storing an indication of whether the item identified in the item identifier field 254 was classified within the first set or the second set as described below in connection with recommend items codes 650 of FIGS. 27A-27C. As briefly described above, an instance of the interaction history entry 251 functions as a record associating a particular user with a particular item and a particular image (or a particular palette) and represents an indication of a user's interest in a particular item. In the embodiment shown, an instance of the interaction history entry 251 can identify one user, one item and one image (or one palette), indicating a single interaction of a user with an item. In other embodiments, the interaction history entry 251 can identify more than one user, more than one item or more than one image. The interaction history entry 251 may further include: a visual attribute identifier field 256 for storing a visual attribute identifier stored in the identifier field 162 of an instance of the visual attribute entry 161 (shown in FIG. 6) in embodiments where a user selects a particular visual attribute associated with the image or the palette identified in the image identifier field 255; and a taxonomy identifier field 257 for storing a taxonomy identifier stored in the identifier field 222 of an instance of the taxonomy entry 221 (shown in FIG. 9) in embodiments where a user enters a particular text query that match or correspond to an instance of the taxonomy entry 221. The interaction history entry 251 may further include a created field 259 and a modified field 260 for storing a date and time at which the instance of the interaction history entry 251 was created and modified respectively. For example, a user may interact with a particular item at a particular time, and that particular time may be stored in the created field 259; the user may then interact with that same item at a different point in time, and that different time may be stored in the modified field 260. In some embodiments, the interaction history entry 251 only includes the created field 259, such that a new instance of the interaction history entry 251 is created each time a user interacts with a same item.

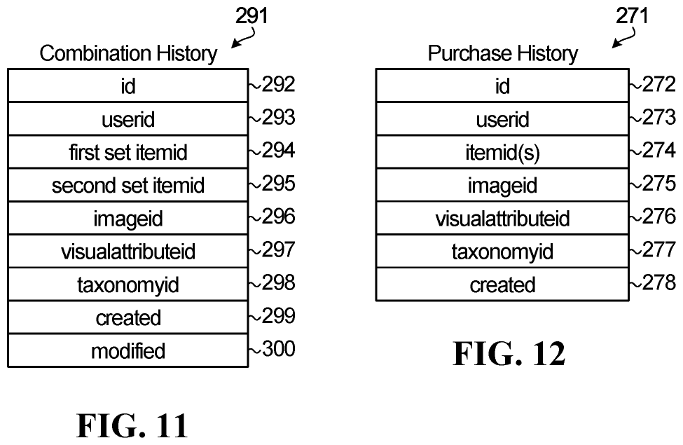

Referring back to FIG. 2, the application database 122 also includes a combination history table 290 that can store any number of instances of a combination history entry, an embodiment of which is shown generally at 291 in FIG. 11. An instance of the combination history entry 291 represents a record of a user interacting with more than one item at the same time via an interface implemented by the item recommendation server 100, and may function as a record of which items are often combined by users in general, which items are often combined by a particular user, and which items may be combined by users when recommended by the item recommendation server 100 in association with a particular image for example. The combination history entries 291 may be utilized by a complementarity model to determine which items are complementary with other items and/or a ranking model to determine which items should be ordered first in a first set of items and a second set of items as described below in connection with the recommend items codes 650 of FIGS. 27A-27C.

In the embodiment shown in FIG. 11, the combination history entry 291 includes an identifier field 292 storing an integer (a combination history identifier) assigned by the DBMS codes 120 (shown in FIG. 1) to identify an instance of the combination history entry 291 uniquely in the combination history table 290. The combination history entry 291 may also include: a user identifier field 293 storing a user identifier stored in the identifier field 132 of an instance of the user entry 131 (shown in FIG. 3), a first set item identifier field 294 storing at least one item identifier stored in identifier fields 172 of instances of the item entry 171 (shown in FIG. 7) classified within the first set as described below in connection with the recommend items codes 650 of FIGS. 27A-27C, a second set item identifier field 295 storing at least one item identifier stored in identifier fields 172 of instances of the item entry 171 (shown in FIG. 7) classified within the second set as described below in connection with the recommend items codes 650 of FIGS. 27A-27C, and an image identifier field 296 storing an image identifier stored in the identifier field 142 of an instance of the image entry 141 (shown in FIG. 4) or a palette identifier stored in the identifier field 192 of an instance of the palette entry 191 (shown in FIG. 5). As described briefly above, an instance of the combination history entry 291 thus functions as a record associating a particular user with at least one item from the first set and/or at least one item from the second set and a particular image (or a particular palette), and represents that the user's simultaneous interest in at least two items or the user's combination of at least two items. In the embodiment shown, an instance of the combination history entry 291 can identify one user, one or more items and one image (or one palette), indicating a combination of one or more items by a user. In other embodiments, the combination history entry 291 can identify more than one user, only one item or more than one image. The combination history entry 291 may further include: a visual attribute identifier field 297 for storing a visual attribute identifier stored in the identifier field 162 of an instance of the visual attribute entry 161 (shown in FIG. 6) in embodiments where a user provides a selection of a visual attribute associated with the image or the palette identified in the image identifier field 296; and a taxonomy identifier field 298 for storing a taxonomy identifier stored in the identifier field 222 of an instance of the taxonomy entry 221 (shown in FIG. 9) in embodiments where a user enters a particular text query that may match or correspond to a taxonomy entry 221. The combination history entry 291 may further include a created field 299 and a modified field 300 for storing a date and time at which the instance of the combination history entry 291 was created and modified respectively. For example, a user may make a combination of two or more items at a particular time, and that particular time may be stored in the created field 299; the user may then add another item to the combination, or remove an item from the combination at a later point in time, and that later time may be stored in the modified field 300. In some embodiments, the combination history entry 291 only includes the created field 299, such that a new instance of the combination history entry 291 is created each time a user combines one or more items.

Referring back to FIG. 2, the application database 122 also includes a purchase history table 270 that can store any number of instances of a purchase history entry, an embodiment of which is shown generally at 271 in FIG. 12. An instance of the purchase history entry 271 represents a record of a user purchasing a particular item or a plurality of items in combination with each other, via an interface implemented by the item recommendation server 100, and may more generally function as a record of which items are often purchased by users in general, which items are often purchased by a particular user, which items may be purchased together, and which items may be purchased by users when recommended by the item recommendation server 100 in association with a particular image or a particular palette for example. The purchase history table entries 271 may be utilized by a complementarity model to determine which items are complementary with other items and/or a ranking model to determine which items should be ordered first in a first set of items and a second set of items as described below in connection with the recommend items codes 650 of FIGS. 27A-27C.

In the embodiment shown in FIG. 12, the purchase history entry 271 includes an identifier field 272 storing an integer (a purchase history identifier) assigned by the DBMS codes 120 (shown in FIG. 1) to identify an instance of the purchase history entry 271 uniquely in the purchase history table 270. The purchase history entry 271 may also include: a user identifier field 273 for storing a user identifier stored in the identifier field 132 of an instance of the user entry 131 (shown in FIG. 3), an item identifier field 274 for storing an item identifier stored in the identifier field 172 of at least one instance of the item entry 171 (shown in FIG. 7), and an image identifier field 275 for storing an image identifier stored in the identifier field 142 of an instance of the image entry 141 (shown in FIG. 4) or a palette identifier stored in the identifier field 192 of an instance of the palette entry 191 (shown in FIG. 5). As briefly described above, an instance of the purchase history entry 271 thus functions as a record associating a particular user with one or more items and a particular image (or a particular palette), and represents that the user purchased the one or more items. In the embodiment shown, an instance of the purchase history entry 271 can identify one user, one or more items and one image (or one palette), indicating a purchase of one or more items by a user. In other embodiments, the purchase history entry 271 can identify more than one user or more than one image. The purchase history entry 271 may further include: a visual attribute identifier field 276 for storing a visual attribute identifier stored in the identifier field 162 of an instance of the visual attribute entry 161 (shown in FIG. 6) in embodiments where a user provides a selection of a visual attribute associated with the image or the palette identified in the image identifier field 275; and a taxonomy identifier field 277 for storing a taxonomy identifier stored in the identifier field 222 of an instance of the taxonomy entry 221 (shown in FIG. 9) in embodiments where a user enters a particular text query that may match or correspond to a taxonomy entry 221. The purchase history entry 271 may further include a created field 278 for storing a date and time at which the instance of the purchase history entry 271 was created. For example, a user may purchase a particular item at a particular time, and that particular time may be stored in the created field 278.

Referring back to FIG. 1, the program memory 108 includes user interface codes 330 for communicating with user interfaces of the user devices 114 and for displaying information on displays of the user devices 114. For example, the user interface codes 330 may include various codes to enable a user of the user device 114 to interact with the item recommendation server 100 via a mobile application, and descriptions of embodiments below illustrate various mobile application interfaces for display on the user device 114. Other configurations may allow the item recommendation server 100 and the user device 114 to interact in a similar manner. For example, the user may access a web page hosted by the item recommendation server 100 using an internet browser installed on the user device 114.

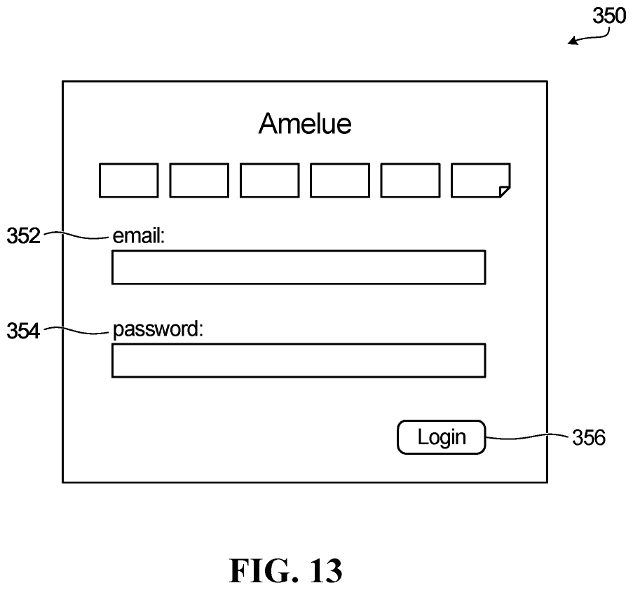

Referring to FIG. 13, a login page produced by the user interface codes 330 for display by the user device 114 is shown generally at 350. The login page 350 may be accessed by opening a mobile application installed on the user device 114. In the embodiment shown, the login page 350 includes an email input field 352, a password input field 354 and a login button 356.

When the user is registered with the item recommendation server 100, the user may enter an electronic mail address into the email input field 352, enter a password into the password input field 354, and select the login button 356. When the user selects the login button 356, the user interface codes 330 may direct the user device 114 to transmit the entered email and password to the microprocessor 102 in a user login request. The microprocessor 102 may respond to the user login request by determining whether the user table 130 (shown in FIG. 2) includes a user entry 131 storing the transmitted email address in the email field 134 and storing the transmitted password in the password field 136. If the transmitted email and address do not both match an instance of the user entry 131, the user interface codes 330 may transmit an error message to the user device 114 indicating that, for example, the email entered could not be found or that the password entered is incorrect or that the user needs to register with the item recommendation server 100. If the user is not already registered with the item recommendation server 100, the user may be prompted to navigate to a separate registration page (not shown) which includes fields prompting the user to enter an email, a password, a username, and certain user data (such as demographic data or a user photo for example).

When the user has entered and submitted the required information, the user interface codes 330 may direct the user device 114 to transmit the information to the microprocessor 102 in an add user request. The microprocessor 102 may respond to the add user request by adding a new instance of the user entry 131 (shown in FIG. 3) to the user table 130 (shown in FIG. 2). This new instance of the user entry 131 may store the email, the password, the username, and the user data entered by the user in the email field 134, the password field 136, the username field 137 and the user data field 138 respectively.

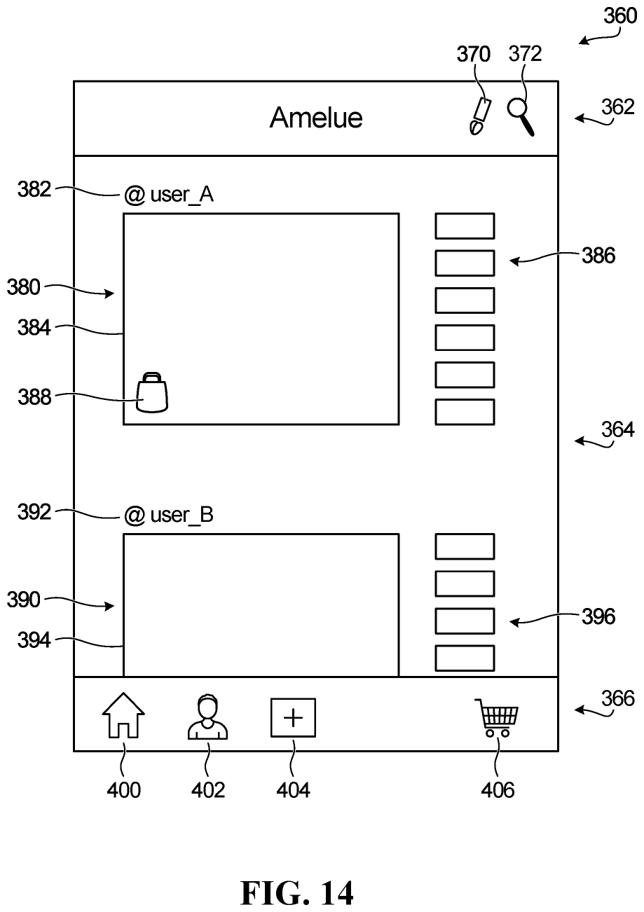

If the transmitted email and address do both match an instance of the user entry 131, the user interface codes 330 may direct the user device 114 to display a home page, an embodiment of which is shown generally at 360 in FIG. 14. Referring to FIG. 14, in the embodiment shown, the home page 360 includes a header region 362, a feed region 364 and a navigation region 366. The header region 362 and the navigation region 366 may be common to a number of different pages that the user interface codes 330 direct the user device 114 to display.

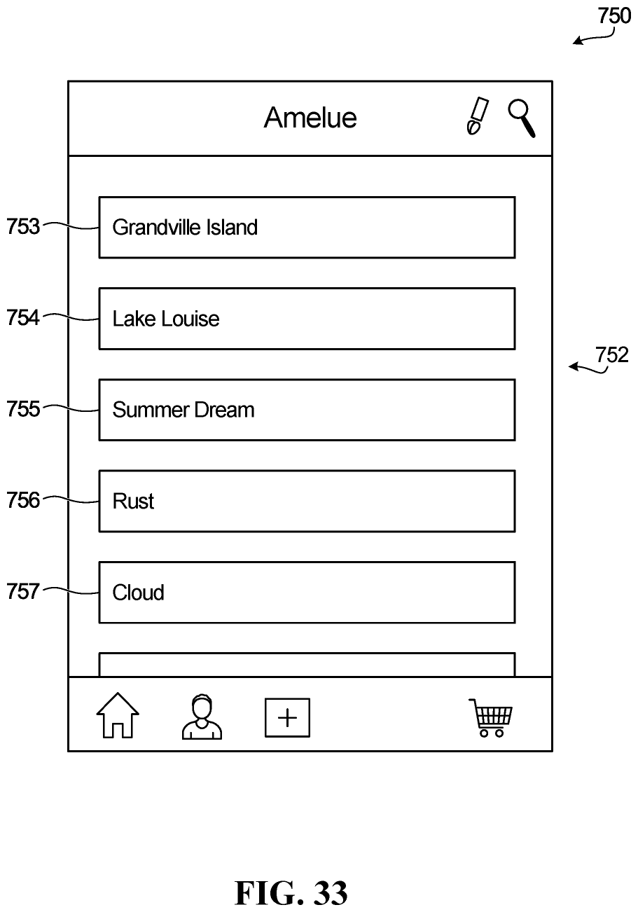

In the embodiment shown, the header region 362 includes a palette selection button 370 and a search button 372. When the user selects the palette selection button 370, the user interface codes 330 may direct the user device 114 to display a palette selection page 750 described below in connection with FIG. 33. When the user selects the search button 372, the user interface codes 330 may direct the user device 114 to display a search page (not shown) with a query region (not shown) operable to receive a text query from the user. If the user enters a query in the query region, the microprocessor 102 may search the application database 122 for, and retrieve, for example, user entries 131 in the user table 130, image entries 141 in the image table 140, item entries 171 in the item table 170, palette entries 191 in the palette table 190, vendor entries 231 in the vendor table 230, and visual attribute entries 161 in the visual attribute table 160, which match or correspond to the query entered by the user in the query region. An entry may match or correspond to the query entered by the user by storing, in one of the entry's fields, text matter which is identical, similar to, or synonymous with, the text of the query entered by the user. For example, if the user searches for the query “kitten” in the query region, the microprocessor 102 may locate and retrieve: (1) user entries 131 (shown in FIG. 3) which store “kitten”, “cat” or “kitty” in the email field 134, the username field 137, and/or the user data field 138; (2) image entries 141 (shown in FIG. 4) which store similar terms in the description field 148; (3) item entries 171 (shown in FIG. 7) which store similar terms in the description field 176 or the vendor description field 176; (4) palette entries 191 (shown in FIG. 5) which store similar terms in the description field 194; and/or visual attribute entries 161 (shown in FIG. 6) which store similar terms in the description field 166. The user interface codes 330 may then direct the user device 114 to display the entries retrieved by the microprocessor 102 on the search page (not shown). In certain embodiments, the search page may display the entries from different tables of the application database 122 as a group on the search page. For example, the retrieved user entries 131 under a header of “People”, the retrieved image entries 141 under a header of “Posts”, and the retrieved item entries 171 under a header of “Items”.

The feed region 364 displays images and associated visual attributes posted by users. In the embodiment shown in FIG. 14, the feed region 364 may display images and associated visual attributes by displaying a plurality of image posts 380, 390, wherein each image post 380, 390 includes an image 384, 394, a user indicator 382, 392, a visual attribute array 386, 396, and a shop image button 388. In the embodiment shown, the feed region 364 is vertically scrollable to view the image posts 380, 390. In other embodiments, the feed region may be horizontally scrollable, or may have a page flip format where each page corresponds to an image post.

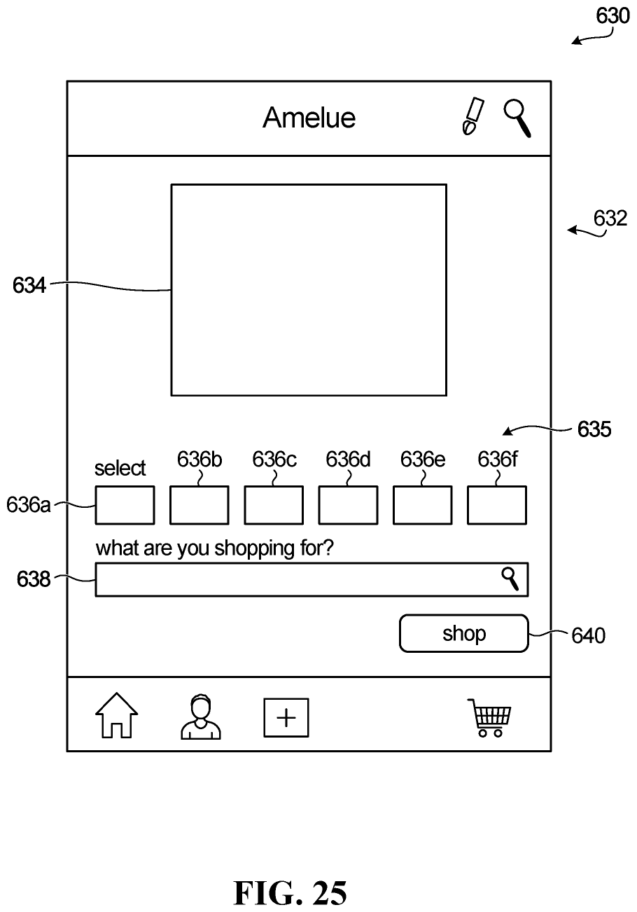

Each image post 380, 390 may correspond to an image entry 141 (shown in FIG. 4) stored in the image table 140. The image 384, 394 may display the image representation stored in the representation database 124 (shown in FIG. 1) directed to by a URI in the image representation path field 150 of that image entry 141. The user indicator 382, 392 may display an indication of the user that uploaded the image 384, 394, and may display the username stored in the username field 137 of the user entry 131 identified in the user identifier field 144 of the image entry 141. The visual attribute arrays 386, 396 generally represent the visual attributes associated with the image 384, 394. In the embodiment shown, each visual attribute array 386, 396 includes a plurality of visual attribute representations. Each visual attribute representation may display a visual attribute representation stored in the representation database 124 (shown in FIG. 2) directed to by a URI in the visual attribute representation path field 168 of one or more visual attribute entries 161 (shown in FIG. 6) identified in the visual attribute identifier field 175 of the image entry 141 (shown in FIG. 4). The shop image button 388 is selectable by a user and allows the item recommendation server 100 to recommend items associated with visual attributes which match the visual attributes associated with the image 384, 394 (such visual attributes of the visual attribute array 386, 396). If a user selects the shop image button 388, the user interface codes 330 may direct the user device 114 to display a shop image page 630 described below in connection with FIG. 25.

Still referring to FIG. 14, in the embodiment shown, the navigation region 366 includes a home button 400, a user profile button 402, an upload image button 404 and a shopping cart button 406. When the user selects the home button 400, the user interface codes 330 may direct the user device 114 to display the home page 360.

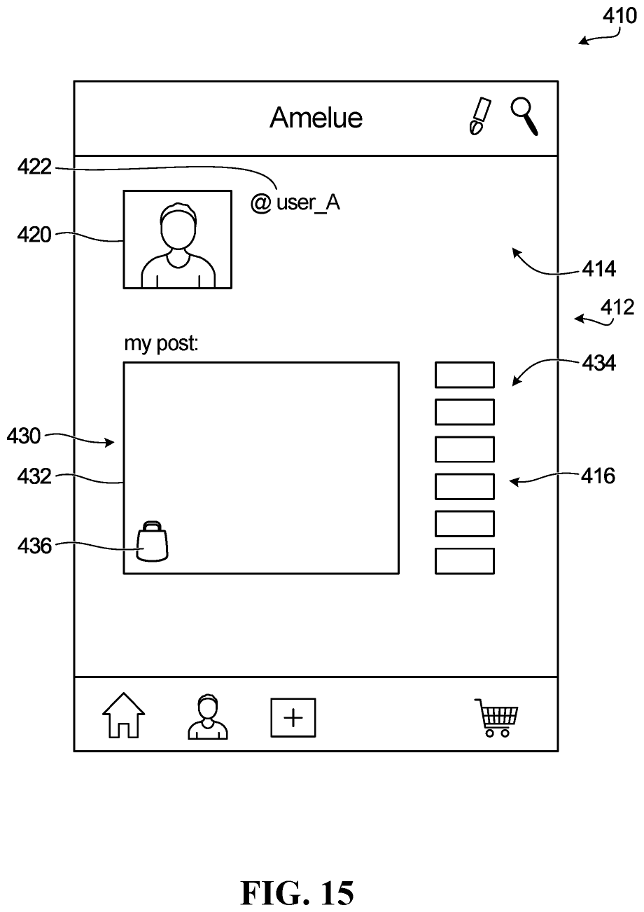

When the user selects the user profile button 402, the user interface codes 330 may direct the user device 114 to display a user profile page as shown generally at 410 in FIG. 15. Referring to FIG. 15, the user profile page 410 displays information associated with a particular user corresponding to a particular user entry 131 (shown in FIG. 3) in the user table 130, and images posted by that user. When the user selects the user profile button 402 of the navigation region 310, the user interface codes 330 direct the user device 114 to display the user profile page 410 corresponding to the current user (such as the user that initially logged on using the login page 350 (shown in FIG. 13) for example). However, when the user selects a user indictor of another user, such as the user indicator 382, 392 (shown in FIG. 14) for example, the user interface codes 330 may display the user profile page 410 associated with that other user. In the embodiment shown in FIG. 15, the user profile page 410 includes a profile region 412 which can be vertically scrolled to view data associated with the user corresponding to the user profile page 410 and image posts posted by the user. In other embodiments, the profile region 412 may be horizontally scrolled or may have a page-flip format.

The profile region 412 may include a user data region 414 and a user post region 416. The user data region 414 may display various user data associated with the user, such as information stored in the user entry 131 representing that user. For example, the user data region 414 includes a user representation 420, which may display a user representation stored in the representation database 124 (shown in FIG. 2) directed to by a URI in the user representation path field 139 of the user entry 131 (shown in FIG. 3). The user data region 414 also includes a user indicator 422, which may display the username stored in username field 137 of the user entry 131. In other embodiments, the user data region 414 may include more or less user data. For example, in other embodiments, the user data region 414 may include a biography or other information stored in the user data field 138 of the user entry 131.

The user post region 416 displays a plurality of image posts 430 associated with the user in a manner similar to the feed region 364 (shown in FIG. 14). For example, each image post 430 of the user post region 416 may correspond to an image entry 141 (shown in FIG. 4) which identify the user entry 131 representing the user in the user identifier field 144. The user post region 416 may display, as image posts 430, every image entry 141 associated with the user entry 131. In some embodiments, the user post region 416 may only display a subset of the image entries 141 associated with the user entry 131. The image posts 430 may be displayed chronologically, such that the image post 430 corresponding to the most recent image entry 141 is displayed first; the image posts 430 may also be displayed in some other order, such as popularity with other users or user preference for example.

Each image post 430 displays information associated with an image corresponding to an image entry 141 (shown in FIG. 4) of the image table 140. In the embodiment shown in FIG. 15, each image post includes an image 432, a visual attribute array 434, and a shop image button 436. The image 432 may be similar to image 384, 394 (shown in FIG. 14), and may display the image representation stored in the representation database 124 directed to by a URI in the image representation path field 150 of that image entry 141. The visual attribute array 434 may be similar to visual attribute arrays 386, 396 (shown in FIG. 14), and may display a plurality of visual attributes associated with the image entry 141 as a plurality of visual attribute representations. For example, the visual attribute array 434 may display visual attribute representations stored in the representation database 124 directed to by a URI in the visual attribute representation path field 168 of the visual attribute entries 161 (shown in FIG. 6) identified in the visual attribute identifier field 146 of the image entry 141. The shop image button 436 may be similar to the shop image button 388 (shown in FIG. 14) and may be is selectable by a user. If a user selects the shop image button 436, the user interface codes 330 may direct the user device 114 to display the shop image page 630 (shown in FIG. 25).

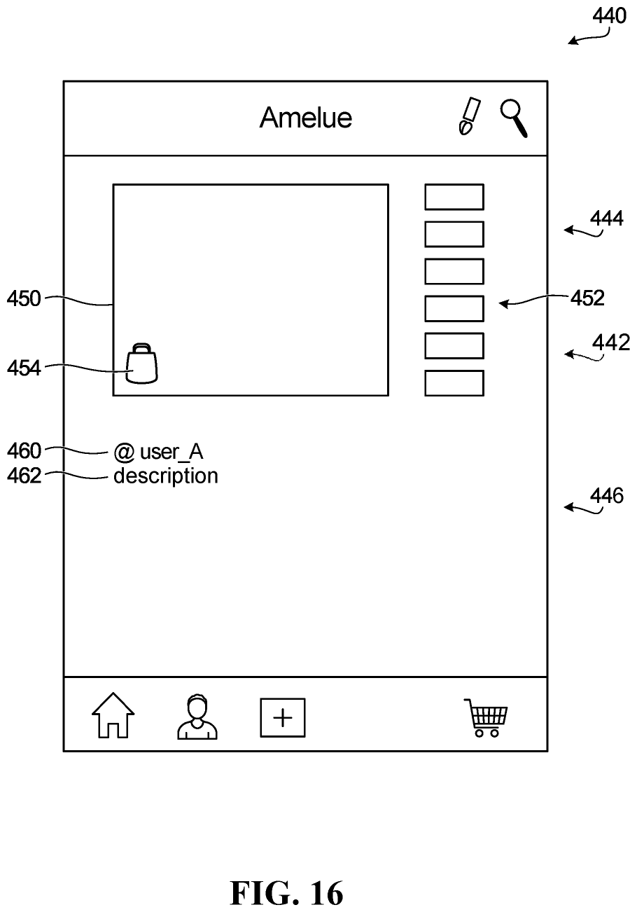

When the user selects an image of an image post, such as the images 384, 394 (shown in FIG. 14) or 432 (shown in FIG. 15), the user interface codes 330 may direct the user device 114 to display an image page 440, an embodiment of which is shown in FIG. 16. Referring to FIG. 16, the image page 440 displays information associated with an image post corresponding to a particular image entry 141 (shown in FIG. 4) in the image table 140. In the embodiment shown, the image page 440 includes an image region 442 which can be vertically scrolled to view the image, the visual attributes, and other information, all associated with that particular image entry 141. In other embodiments, the image region 442 may be horizontally scrolled or may have a page flip format. The image region 442 may include an image post 444 and an image post region shown generally at 446.

The image post 444 includes an image 450, a visual attribute array 452, and a shop image button 454. The image 450 may be similar to images 384, 394 (shown in FIG. 14) and 432 (shown in FIG. 15), and may display an image stored in the representation database 124 (shown in FIG. 2) directed to by a URI in the image representation path field 150 of the image entry 141. The visual attribute array 452 may be similar to visual attribute arrays 386, 396 (shown in FIG. 14) and 434 (shown in FIG. 15) and may display a plurality of visual attributes associated with the image entry 141 as a plurality of visual attribute representations. Each visual attribute representation may display a visual attribute representation stored in the representation database 124 (shown in FIG. 2) directed to by a URI in the visual attribute representation path field 168 of visual attribute entries 161 (shown in FIG. 6) identified in the visual attribute identifier field 146 of the image entry 141. The shop image button 454 may be similar to the shop image buttons 388 (shown in FIG. 14) and 436 (shown in FIG. 15) and may be is selectable by a user. If a user selects the shop image button 454, the user interface codes 330 may direct the user device 114 to display the shop image page 630 (shown in FIG. 25).

The image data region 446 includes a user indicator 460 and a description 462. The user indicator 460 may display an indicator of the user that uploaded the image 450 and may specifically display a username stored in username field 137 of a user entry 131 identified in the user identifier field 144 of the image entry 141. The user entry 131 may correspond to the user that uploaded the image post 444 for example. The user indicator 460 may be selectable, and when selected by the user, the user interface codes 330 may direct the user device 114 to display the user profile page 410 (shown in FIG. 15) which corresponds to the user entry 131. The description 462 may display a description stored in the description field 148 (shown in FIG. 4) of the image entry 141. In other embodiments, the image data region 446 may include more or less data. For example, the image data region 446 may include comments posted by other users associated with the image 450 (not shown) and alternative indications that other users like or otherwise appreciate the image 450 (not shown).

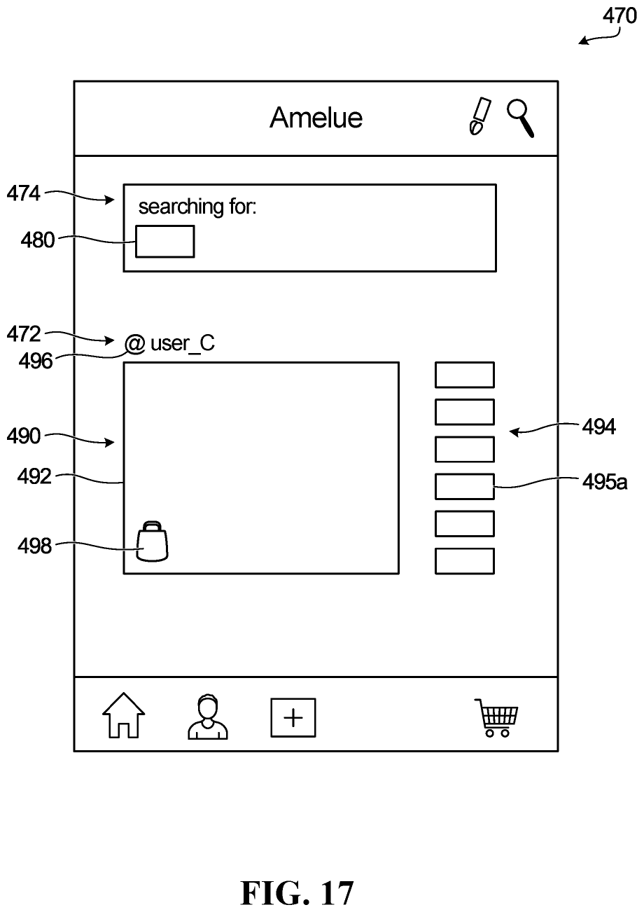

The item recommendation server 100 may allow a user to search for images based on visual attributes associated with the image. In some embodiments, when the user selects one or more visual attribute representations from a visual attribute array associated with an image (such as the visual attribute representations from the visual attribute arrays 386, 396 (shown in FIG. 14), 434 (shown in FIG. 15) and 452 (shown in FIG. 16) for example), the user interface codes 330 may direct the microprocessor 102 to search for, and retrieve, a visual attribute entry 161 (shown in FIG. 6) in the visual attribute table 160 which corresponds to the selected visual attribute representation. In embodiments where more than one visual attribute representation is selected, the microprocessor 102 may retrieve more than one visual attribute entry 161. A visual attribute entry 161 may correspond to the selected visual attribute representation when the visual attribute entry 161 stores a URI in the visual attribute representation path field 168 which identifies the selected visual attribute representation in the representation database 124 (shown in FIG. 2). The microprocessor 102 may then search for, and retrieve, image entries 141 (shown in FIG. 4) in the image table 140 which identify the retrieved visual attribute entry 161 in the visual attribute identifier field 146. In embodiments where more than one visual attribute entry 161 is retrieved, the microprocessor 102 may retrieve image entries 141 which identify, in the visual attribute identifier field 146, (1) any one of the more than one retrieved visual attribute entries 161 and/or (2) each one of the every retrieved visual attribute entries 161. After the image entries 141 are retrieved, the user interface codes 330 may direct the user device 114 to display a visual attribute search page 470 shown in FIG. 17 to display the retrieved image entries 141 as search results, and may display the retrieved image entries 141 as image posts.

Referring to FIG. 17, the visual attribute search page 470 displays results of a visual attribute search as noted above, and may further allow a user to refine an initial search by adding or removing visual attributes, or to search for additional or alternative images based on visual attributes. In the embodiment shown, the visual attribute search page 470 includes a visual attribute results region 472. The visual attribute results region 472 includes a visual attribute query region 474 and a plurality of image posts 490.

The visual attribute query region 474 may be automatically populated with one or more visual attribute queries corresponding to the visual attribute initially selected by the user. For example, when the user selects a visual attribute representations from a visual attribute array associated with an image (such as the representations from the visual attribute arrays 386, 396 (shown in FIG. 14), 434 (shown in FIG. 15), or 452 (shown in FIG. 16)), the user interface codes 330 may display visual attribute query region 474 automatically populated with a selected visual attribute query 480. In embodiments where the user selects more than one visual attribute, the visual attribute query region 474 may be automatically populated with more than one selected visual attribute query.

The visual attribute results region 472 can be vertically scrolled to view the plurality of image posts 490. In other embodiments, the visual attribute results region 472 may be horizontally scrolled or may have a page flip format. Each image post 490 may correspond to an image entry 141 (shown in FIG. 4) of the image entries 141 retrieved by microprocessor 102 based on the initially selected visual attribute representation. The image post 490 includes a user indicator 496, an image 492, a visual attribute array 494, and a shop image button 498. The user indicator 496 may be similar to the user indicators 382, 392 (shown in FIG. 14) and 460 (shown in FIG. 16), and may display an indication of the user that uploaded the image 492, and may specifically display the username stored in the username field 137 of the user entry 131 identified in the user identifier field 144 of the image entry 141. The image 492 may be similar to image 384, 394 (shown in FIG. 14), 432 (shown in FIG. 15), and the image 450 (shown in FIG. 16), and may display an image stored in the representation database 124 (shown in FIG. 2) directed to by a URI in the image representation path field 150 of the image entry 141. The visual attribute array 494 may be similar to the visual attribute arrays 386, 396 (shown in FIG. 14), 434 (shown in FIG. 15) and 452 (shown in FIG. 16), and may display visual attributes associated with the image entry 141 as a plurality of visual attribute representations. Each visual attribute representation may display a visual attribute representation stored in the representation database 124 directed to by a URI in the visual attribute representation path field 168 of visual attribute entries 161 (shown in FIG. 6) identified in the visual attribute identifier field 146 of the image entry 141. As described above, because the visual attribute results region 472 displays image entries 141 which are associated with the visual attribute initially queried for, at least one visual attribute representation of the visual attribute array 494 of each image post 490 will match the visual attribute initially queried for. For example, in the embodiment shown in FIG. 17, only a single visual attribute was selected as the visual attribute query 480, and thus a visual attribute representation 495a of the visual attribute array 494 matches the visual attribute query 480. In embodiments where a plurality of visual attributes are selected as the visual attribute query, (1) one visual attribute of the visual attribute array 494 of each image post 490 may match any visual attribute of the selected visual attributes or (2) the visual attribute array 494 of each image post 490 may include visual attributes which match each visual attribute of the selected visual attributes. The shop image button 498 may be similar to the shop image buttons 388 (shown in FIG. 14), 436 (shown in FIG. 15) and 454 (shown in FIG. 16) and may be selectable by a user. If a user selects the shop image button 498, the user interface codes 330 may direct the user device 114 to display the shop image page 630 (shown in FIG. 25).

In some embodiments, the visual attribute query region 474 may be operable to receive additional, or modifications of, the visual attribute query. For example, a user may delete the visual attribute query or enter one or more descriptions or definitions of visual attributes in the visual attribute query region 474. If the user adds or modifies the visual attribute query, the user interface codes 330 may direct the microprocessor 102 to search the visual attribute table 160 for one or more visual attribute entries 161 (shown in FIG. 6) which match the visual attribute query as added or modified by the user. For example, the user may delete the visual attribute query 480 (shown in FIG. 17) pre-populated in the visual attribute query region 474 and may type in “red”, “plaid” or “R:255 B:94 G:120” instead. The microprocessor 102 may search for, and retrieve, visual attribute entries 161 which match the added or modified visual attribute query from the visual attribute table 160. Such visual attribute entries 161 may store, in the definition field 164 or in the description field 166, text matter which is identical to, similar to, or synonymous with, the added or modified visual attribute query. For example, if the visual attribute query entered by the user in the visual attribute query region 474 is “red”, the microprocessor 102 may retrieve all visual attribute entries 161 which store “red” in the description field 166 or which store red, blue and green values in the definition field 164 that result in a color which generally corresponds to common definitions of “red”.

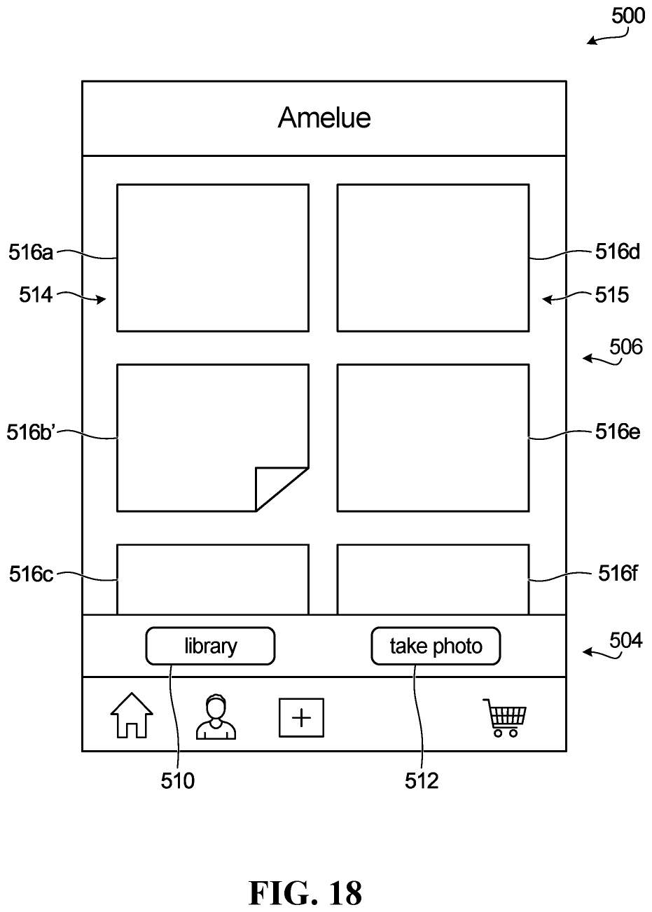

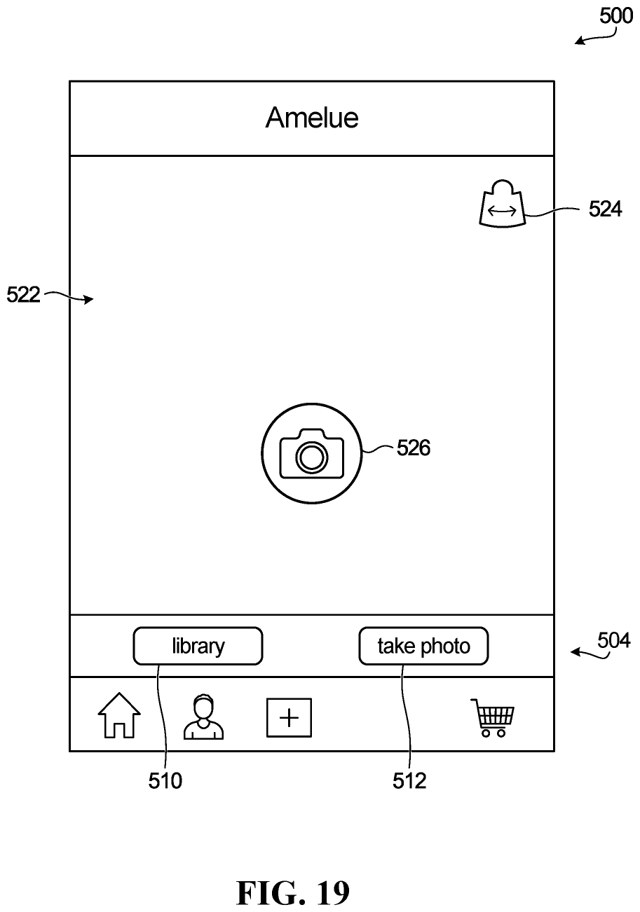

Referring generally to the navigation region 366 (labelled in FIG. 14), when the user selects the upload image button 404, the user interface codes 330 may direct the user device 114 to display sect image page is shown generally at 500 in FIGS. 18 and 19. The select image page 500 allow a user to search for, capture and select an image that the user may wish to upload to the item recommendation server 100 and generate visual attributes from. When a user selects the upload image button 404, the microprocessor 102 may communicate with the user device 114 to access and retrieve photos and other images from a storage memory (not shown) of the user device 114 (“album mode”, embodiment shown in FIG. 18) or to access and command cameras (not shown) of the user device 114 to capture new photos and new images (“camera mode”, embodiment shown in FIG. 19). In certain embodiments, the user interface codes 330 may direct the user device 114 to display the album mode when the user initially selects the upload image button 404 by default; alternatively, the item recommendation server 100 may have a record of the preferred mode of the user, and the user interface codes 330 may direct the user device 114 to display the preferred mode when the user initially selects the upload image button 404.

Referring to FIG. 18, in the embodiment of the album mode shown, the select image page 500 includes a mode selection region 504 and an album display region 506. The mode selection region 504 allows the user to switch between the album mode and the camera mode and includes an album mode button 510 and a camera mode button 512. When a user selects the album mode button 510, the user interface codes 330 direct the user device 114 to display the album mode of the select image page 500 (shown in FIG. 18). When the user selects the camera mode button 512, the user interface codes 330 direct the user device 114 to display the camera mode of the select image page 500 (shown in FIG. 19).

The album display region 506 may display a plurality of images and photos retrieved by the microprocessor 102 from the storage memory of the user device 114. In the embodiment shown, the album display region 506 can be vertically scrolled to view the retrieved images and photos, and more specifically includes a first column 514 displaying photo representations 516a, 516b and 516c, and a second column 515 displaying photo representations 516d, 516e and 516f. The first and second columns 514 and 515 may be scrolled simultaneously or may be independently scrollable. In other embodiments, the album display region 506 may be horizontally scrolled or may have a page flip format.

The user can select one of the retrieved photos and images by selecting the photo representation 516a-516f. When the user selects a photo representation 516b, the user interface codes 330 may modify the selected representation 516b and direct the user device 114 to display a modified representation 516b′. For example, non-selected representations 516a, 516c, 516d, 516e, and 516f may be displayed with rectangular outlines; in other embodiments, the non-selected photo representations 516a-516f may be displayed with circular outline, a square outline, etc. Selection of one of the representations 516b may cause the user interface codes 330 to direct the user device 114 to display the modified photo representation 516b′, wherein the modified photo representation 516b′ is a rectangular outline with a folded bottom-right corner. In other embodiments, different portions of the outlines of the representations may be folded when the representation is selected, such as the entire bottom half of the outline or different corners of the outline, such as the top-left, top-right or bottom-left corners for example. In other embodiments, the user interface codes 330 may direct the user device 114 to modify the selected representation in an additional or an alternative manner, such as coloring the outline of the selected representation with a specific or a random color for example. A user may re-select a modified photo representation 516b′ to de-select a photo, and the user interface codes 330 may direct the user device 114 to re-display the unmodified photo representation 516b in response to user re-selection.

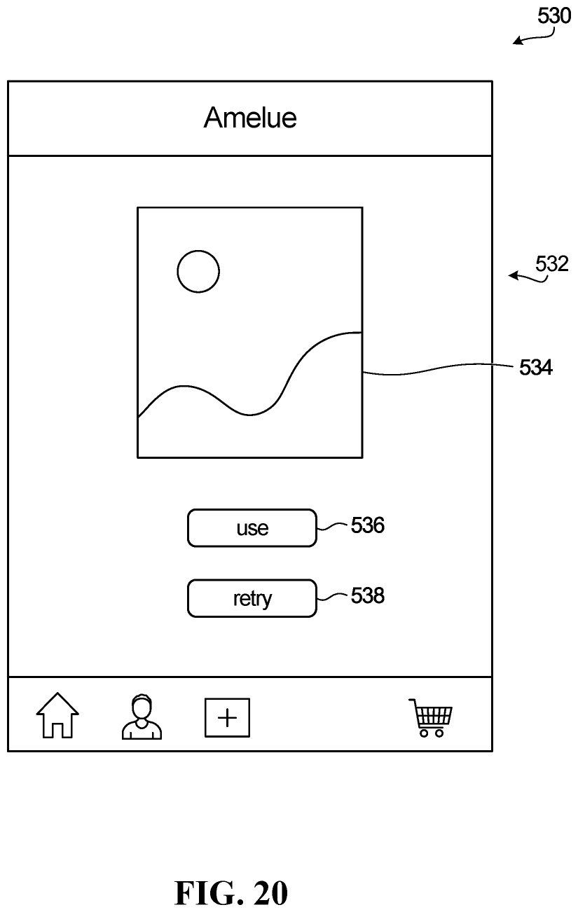

When the user has selected at least one retrieved photo or image, the user interface codes 330 may also direct the user device 114 to display a “Next” button (not shown). If the user further selects the “Next” button, the user interface codes 330 may then direct the user device 114 to display a confirm image page 530 described below in connection with FIG. 20.

Referring now to FIG. 19, in the embodiment of the camera mode shown, the select image page 500 includes the mode selection region 504 and a camera region 522. When the user interface codes 330 directs the user device 114 to display the camera mode of the select image page 500 shown in FIG. 19, the microprocessor 102 may communicate with at least one camera of the user device 114 to display images acquired by the at least one camera and to control functionality of the at least one camera to capture new images and photos using the at least one camera. For example, in the embodiment shown, the camera region 522 may display, in real-time, the images acquired by the at least one camera of the user device 114. The camera region 522 may also include a switch camera button 524 and a capture image button 526. The switch camera button 524 may allow a user to switch between different cameras of the user device 114. For example, the user device 114 may include a front facing camera and a rear facing camera (not shown); selecting the switch camera button 524 toggle between displaying images acquired by the front facing camera and the rear facing camera in the camera region 522. The capture image button 526 allows a user to capture an image acquired by the at least one camera and displayed in the camera region 522 as a photo. When the user selects the capture image button 526, the user interface codes 330 may then direct the user device 114 to display the confirm image page 530 (shown in FIG. 20).

Referring now to FIG. 20, the confirm image page 530 may allow a user to confirm their selection or capture of an image and to perform minor edits to the image, such as to change zoom or dimension of the image. With respect to the latter functionality, the user interface codes 330 may display the images of image posts (such as images 384, 394 (shown in FIG. 14), 432 (shown in FIG. 15), 450 (shown in FIG. 16), and 492 (shown in FIG. 17)) at a set dimension to ensure that both the images and visual attribute arrays (such as visual attribute arrays 386, 396 (shown in FIG. 14), 434 (shown in FIG. 15), 452 (shown in FIG. 16), and 492 (shown in FIG. 17)) of the image posts are be simultaneously displayed on the display of the user device 114. In the embodiment shown in FIG. 20, the confirm image page 530 includes a confirm selection region 532. The confirm selection region 532 includes an image 534, a use button 536 and a retry button 538.

The image 534 may display the image selected by the user using the album mode of the select image page 500 shown in FIG. 18 or the captured by the user using the camera mode of the select image page 500 shown in FIG. 19. The user interface codes 330 may require the user to crop the selected or captured image to the set dimension for images noted above to enable subsequent display in image posts, and may also allow the user to move the image 534 to select a specific region of the image 534 or to modify zoom of the image 534. When the user selects the use button 536, the user interface codes 330 may transmit the image 534 to process image codes 550 stored in the program memory 108 (shown in FIG. 1) in a process image request. When the user selects the retry button 538, the user interface codes 330 may direct the user device 114 to re-display the select image page 500 to enable the user to select a different image or photo using the album mode (shown in FIG. 18) or capture a different new image or photo using the camera mode (shown in FIG. 19).

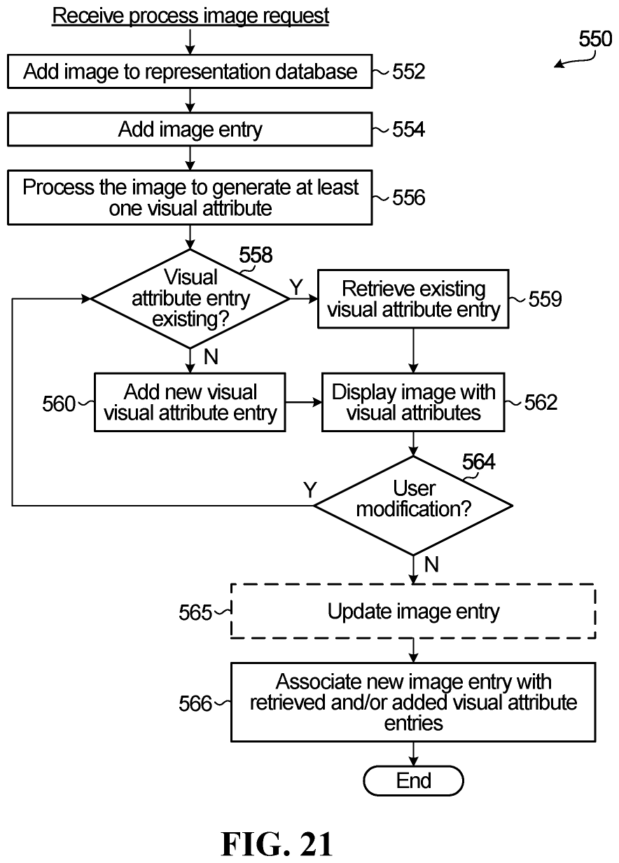

The process image codes 550 generally includes blocks of code for directing the microprocessor 102 to generate and add an instance of the image entry 141 (shown in FIG. 4) to the image table 140, the new instance of the image entry 141 representing the image uploaded by the user using the select image page 500 and the confirm image page 530. The process image codes 550 also include blocks of code for processing the image uploaded by the user to associate the new instance of image entry 141 with new or existing visual attribute entries 161 (shown on FIG. 6). An illustrative embodiment of the process image codes 550 is shown in FIG. 21. In the embodiment shown, the process image codes 550 begin at block 552, which include code for directing the microprocessor 102 to store an image representation of the image, which may be contained in the process image request, in the representation database 124 (shown in FIG. 1).

The process image codes 550 then continue to block 554, which include code for directing the microprocessor 102 to add a new instance of the image entry 141 (shown in FIG. 4) to the image table 140 (shown in FIG. 2). This new instance of the image entry 141 stores an identifier identifying the instance of the user entry 131 representing the user that uploaded the image in the user identifier field 144. This new instance of the image entry 141 also stores a URI directing to the location in the representation database 124 where the image representation was initially stored in block 552 in the image representation path field 150.

The process image codes 550 then continue to block 556, which includes codes for directing the microprocessor 102 to process the image representation request to extract certain visual attributes associated with that image. As described above, “visual attributes” include without limitation colors, patterns, textures, and reflectivity. Block 556 may thus include code for directing the microprocessor 102 to generate visual attributes by extracting color of the image, patterns included in the image, textures included in the image, and reflectivity of the image. In different embodiments, block 556 may include different blocks of code for generating different visual attributes from the image representation in different manners.

For example, visual attributes which are colors of the image may be generated from the image representation using K-means clustering, median-cut clustering, or binning via color histogram. In one embodiment, where the visual attributes to be extracted from the image representation are colors defined by RBG values, the codes of block 556 may extract the dominant colors from the image representation by plotting each pixel of the image representation in three-dimensional pixel space, wherein the x-axis are the red pixel values, the y-axis are the green pixel values, and the z-axis are the blue pixel values. Block 556 may then specify six clusters (k=6); in other embodiments, block 556 may specify different numbers of clusters. Block 556 may then assign each pixel of the image representation to a specific cluster, depending on which centroid pixel of a cluster is the minimum distance away from the pixel to be assigned. As more pixels are assigned to a particular cluster, the centroid pixel of that cluster changes to correspond to the mean of the pixels in the cluster. After each pixel extracted from the image representation has been assigned to a cluster, the centroid pixel of the six clusters may each be designated as the visual attributes generated based at least in part on the image representation, and block 556 may direct the microprocessor 102 to extract the RBG value of the corresponding six centroid pixels of the six clusters as the value or definition of the generated visual attributes.

Alternatively, visual attributes which are patterns or textures may be extracted from the image using manual cropping or using a pattern/texture classification model. For example, the pattern/texture classification model may be trained on pixel matrices of a plurality of training visual attribute representations which are previously labelled with known patterns and textures (such as “floral”, “plaid” or “stripes” for example) and may be adapted to clustering together different training visual attribute representations associated with similar labels. For example, visual attribute representations which correspond to a “floral” pattern may be clustered together in a first cluster, while visual attribute representations which correspond to a “stripe” pattern may then be clustered together in a second cluster. The pattern/texture classification model may be trained to increase the distance between clusters associated with different patterns or textures by, for example, weighing different pixels of the pixel matrices differently. After training, the pattern/texture classification model may be capable of outputting a pattern label or a texture label based on an input of the pixel matrix of a visual attribute representation, and may be able to predict the pattern label or the texture label based on the pixel matrix of a particular visual attribute representation. The pattern label or the texture label associated with the visual attribute representation by the pattern/texture may be defined as the visual attribute generated based at least in part on the image representation. The codes of block 556 may thus include code for extracting a portion of the image representation as a visual attribute representation, generating a pixel matrix thereof, and inputting the generated pixel matrix into the pattern/texture classification model. The codes of block 556 may then receive the text of the pattern label or the texture label from the pattern/texture classification model as the value or definition of the generated visual attribute. In other embodiments, the pixel matrix extracted from the visual attribute representation may be defined as the value or definition of generated visual attribute.

The process image codes 550 then continue to block 558, which include code for directing the microprocessor 102 to search the visual attribute table 160 (shown in FIG. 2) to determine whether it already stores instances of the visual attribute entry 161 (shown in FIG. 6) representing each visual attribute of the generated visual attributes. In some embodiments, the microprocessor 102 may search for visual attribute entries 161 which store a value or definition in the definition field 164 which matches the generated value or definition of each visual attribute. For example, the codes of block 558 may direct the microprocessor 102 to search for, and retrieve, visual attribute entries 161 which store the extracted RBG values, the extracted pattern labels or texture labels, or the extracted pixel matrices in the definition field 164; and/or visual attribute entries 161 which store a description in the description field 166 which matches the value or other definition of each generated visual attribute (such as a stored description corresponding to the extracted RBG values, the extracted pattern labels, or the extracted texture labels).

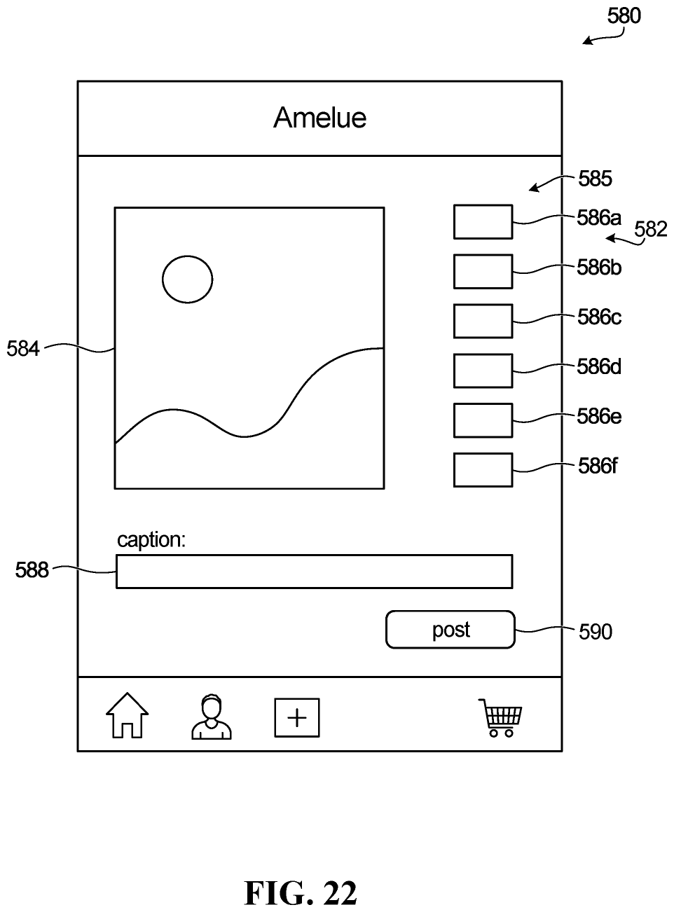

If the microprocessor 102 determines, at block 558, that one of the generated visual attributes does not have a corresponding existing visual attribute entry 161 in the visual attribute table 160, the process image codes 550 then continue to block 560 which includes codes for directing the microprocessor 102 to add a new instance of the visual attribute entry 161 for such an generated visual attribute. The new instance of the visual attribute entry 161 stores a value or a definition which corresponds to the value or other definition of the generated visual attribute in the definition field 164, and may further store a portion of the value or the definition also in the description field 166. Block 560 may also include code for causing the microprocessor 102 to store a representation, such as image data or other data, of the generated visual attribute in the representation database 124 (shown in FIG. 1) and a URI identifying the storage location of the visual attribute representation in the representation database 124 in the visual attribute representation path field 168. For example, where the generated visual attribute is a pattern or a texture, the stored visual attribute representation may be a cropped image of that pattern or texture; and where the generated visual attribute is a color, the stored visual attribute representation may be an image filled with that color. Block 560 may also include code for causing the microprocessor 102 to automatically generate an appropriate description to populate the description field 166. The generated description may be based at least in part on the values or other definition of the generated visual attribute in the definition field 164. For example, if the definition field 164 stored particular ranges of RBG values generally corresponding to the color blue, the description field 166 may be populated with different human readable descriptions of the color blue, such as “baby blue”, “navy blue” or “periwinkle”; if the definition field 164 stored pixel matrices of particular patterns and textures, the description field 166 may be populated with human-readable labels of patterns and textures which are generated by inputting the pixel matrix into pattern/texture classification model described above. The process image codes 550 then continue at block 562 as described below. If the microprocessor 102 determines at block 558 that the visual attribute table 160 does include an existing visual attribute entry 161 representing the generated visual attribute, process image codes 550 then continue at block 559, which include code for directing the microprocessor 102 to retrieve the existing visual attribute entry 161 from the visual attribute table 160. The process image codes 550 may cycle through block 558 and then either block 560 (add new instance of visual attribute entry) or block 559 (retrieve existing instance of visual attribute entry) for each visual attribute generated by the microprocessor 102 based at least in part on the image at block 556. The process image codes 550 then continue at block 562, which includes codes for directing the microprocessor 102 to display the image with the visual attributes extracted from the image. In certain embodiments, the user interface codes 330 may then direct the user device 114 to display an upload image page shown generally at 580 in FIG. 22.

Referring now FIG. 22, the upload image page 580 may generally allow a user to: (1) confirm that certain visual attributes should be associated with an image, (2) to modify which visual attribute are associated with the image, and (3) to upload the image as an image post. In the embodiment shown, the upload image page 580 includes an upload region 582. The upload region 582 includes an image 584, a visual attribute array 585 including plurality of visual attribute representations 586a-586f, a description field 588, and an upload button 590.

The image 584 corresponds to the image uploaded by the user using the select image page 500 (shown in FIGS. 18 and 19) and the confirm image page 530 (shown in FIG. 20), and represented by the new instance of the image entry 141 added at block 554. The image 584 may display the image stored in the representation database 124 directed to by the URI in the image representation path field 150 of the new instance of the image entry 141. The plurality of representations 586a-586f of visual attributes may represent the plurality of visual attributes automatically generated by the microprocessor 102 from the image 584 at block 556 and may display visual attribute representations stored in the representation database 124 directed to by the URIs in the visual attribute representation path field 168 of the visual attribute entries 161 identified at block 558 and/or added at block 560 (shown in FIG. 21). The user may enter a text string in the description field 588 of the upload region 582 describing or otherwise captioning the image 584.

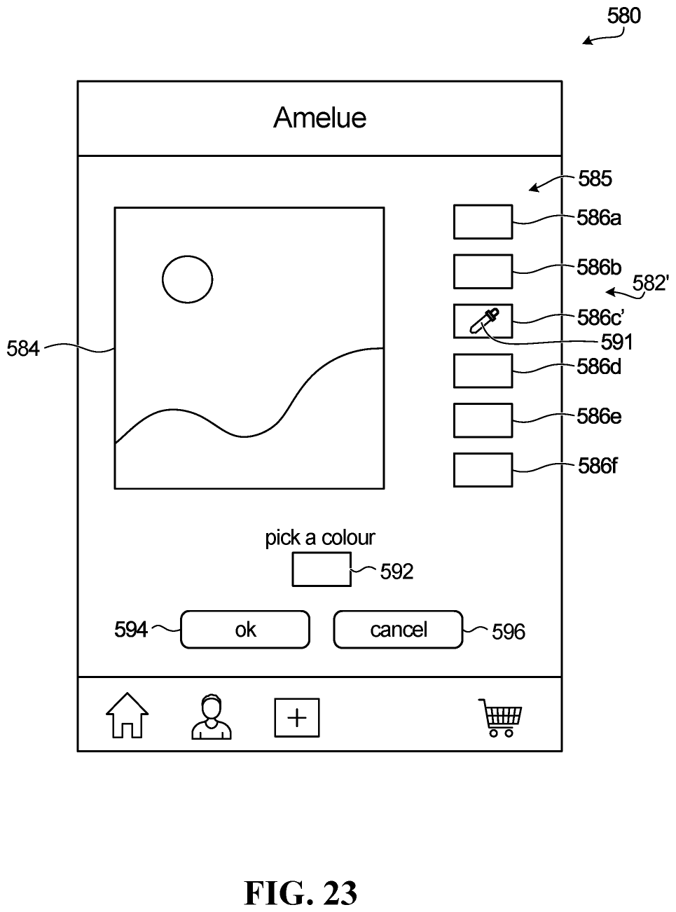

Referring back to FIG. 21, the process image codes 550 continue at block 564, which includes codes for directing the microprocessor 102 to determine whether the user modifies or overrides any of the visual attributes automatically generated from the image representation at block 556. For example, referring now to FIGS. 22 and 23, the user may modify or override the automatically generated visual attributes by selecting the visual attribute representation 586a-586f of the visual attribute that the user wishes to modify or override, such as representation 586c in the embodiment shown, which may cause the user interface codes 330 to direct the user device 114 to display the upload region 582 (shown in FIG. 22) as a modified upload region 582′ (shown in FIG. 23).

The modified upload region 582′ includes the image 584, the visual attribute array 585 including the plurality of visual attribute representations 586a-586f, wherein the selected visual attribute representation is a modified visual attribute representation 586c′, a representation of a sampled visual attribute 592, a confirm button 594 and a cancel button 596. The modified visual attribute representation 586c′ may include an indication that the visual attribute represented by the visual attribute representation 586c is being modified or overridden by the user. In the embodiment shown, the modified representation 586c′ includes a dropper icon 591 overlaying the representation 586c; in other embodiments, the modified representation 586c′ may include additional or alternative indications. The user may modify or override the visual attribute represented by the modified representation 586c′ by selecting a portion of the image 584, and the user interface codes 330 may direct the microprocessor 102 to extract the visual attribute represented by the selected portion of the image 584 in a manner similar to that described above in connection with block 556 (shown in FIG. 21). The user interface codes 330 may further direct the user device 114 to display a representation of that visual attribute as the sampled visual attribute representation 592. For example, if the selected portion of the image 584 corresponds to a pixel having a color with a particular RBG value, the user interface codes 330 may display the color with that RBG value as the sampled visual attribute representation 592; if the selected portion of the image 584 corresponds to a pattern or texture, the user interface codes 330 may crop the selected portion and display the selected portion as the sampled visual attribute representation 592.

When the user is satisfied with the visual attribute displayed by the sampled visual attribute representation 592, the user may select the confirm button 594. Referring back to FIG. 21, selecting the confirm button 594 may direct the microprocessor 102 to determine at block 564 that the user has modified or overridden at least one of the visual attributes initially extracted at block 556, and direct the process image codes 550 to return to block 558 and proceed from block 558 as described above. For example, block 558 directs the microprocessor 102 to determine whether the visual attribute table 160 includes a visual attribute entry 161 (shown in FIG. 6) representing the visual attribute selected by the user and displayed in the sampled visual attribute representation 592. The process image codes 550 continue from block 556 to either retrieve an existing instance of the visual attribute entry 161 at block 559 or add a new instance of the visual attribute entry 161 at block 560 as described above, before proceeding again to block 562 to display the image with the visual attributes as modified or overridden. For example, block 562 may also include code for re-displaying the upload image page 580 (shown in FIG. 22) with the visual attribute selected by the user from the image 584 using the modified upload image page 580′ (shown in FIG. 23) as the visual attribute representation 586c.

If the user decides against modifying or overriding a particular visual attribute after selecting a particular visual attribute representation 586a-586f, the user may select the cancel button 596. Selecting the cancel button 596 may cause the user interface codes 330 to direct the user device 114 to re-display the upload image page 580 (shown in FIG. 22) with no modification of the visual attributes associated with the image 584.

If the user is satisfied with the image 584, the visual attributes associated with the image 584 represented by the plurality of visual attribute representations 586a-586f, and description entered in the description field 588, the user may select the upload button 590. Referring back to FIG. 21, selecting the upload button 590 may cause the microprocessor 102 to determine at block 564 that the user has not modified or overridden any of the visual attribute entries 161 (shown in FIG. 6) retrieved at block 559 or added at block 556. The process image codes 550 then continue at optional block 565, which include code for directing the microprocessor 102 to update the image entry 141 (shown in FIG. 4) added at block 554 by storing the text string entered in the description field 588 of the upload image page 580 (shown in FIG. 22) in the description field 148, before continuing to block 566. If the user did not enter any text in the description field 588, then the process image codes 550 may continue directly to block 566.

Block 566 includes codes for associating the visual attribute entries 161 (shown in FIG. 6) retrieved at block 559 or added at block 560 (and displayed on the upload image page 580 shown in FIG. 21) with the image entry 141 (shown in FIG. 4) added at block 554 to persistently associate a particular image uploaded by a user with one or more visual attributes.

In the embodiment shown, block 566 may direct the microprocessor 102 to store visual attribute identifiers from the identifier field 162 of the newly added or existing instances of the visual attribute entries 161 in the visual attribute identifier field 146 of the new instance of the image entry 141. The process image codes 550 then end.

As a result of the process image codes 550, the image initially uploaded by the user via the select image page 500 (shown in FIGS. 18 and 19) and the confirm image page 530 (shown in FIG. 20) is stored in the image table 140 as an image entry 141 and is persistently associated with one or more visual attributes. The user interface codes 330 may display the image and the associated visual attributes as an image post on various pages of the mobile application, such as on the home page 360 (shown in FIG. 14) and on the user profile page 410 associated with the user (shown in FIG. 15). User selection of the image on such pages may also direct the user interface codes 330 to display the image page 440 (shown in FIG. 16).

Referring back to FIG. 1, the program memory 108 further stores process item codes 600, which may be executed by the item recommendation server 100 intermittently, such as when the item recommendation server 100 receives a process item message from a vendor server 116, or at set intervals, such as when the item recommendation server 100 retrieves the process item message from a vendor website or the vendor server. Each process item message may correspond to one or more items offered for sale by a vendor operating the vendor server 116, such as on a vendor website hosted by the vendor server 116 for example. The process item message may include at least one item representation of the item, a description of the item from the vendor, a price for the item, different options associated with the item (such as size of the item or different lengths of the item for example) and a link to the vendor webpage for purchasing the item or other information which facilitates direct communication between the item recommendation server 100 and the payment processor 117 associated with the vendor for direct purchase of the item through the item recommendation server 100.

The process item codes 600 generally include blocks of code for generating and adding an instance of the item entry 171 (shown in FIG. 7) to the item table 170 (shown in FIG. 2), the new instance of the item entry 171 representing an item offered for sale by a vendor and included in the process item message. The process item codes 600 also include blocks of code for processing an item representation (such as the at least one item representation in the process item message) to associate the new instance of the item entry 171 with new or existing visual attribute entries 161 (shown on FIG. 6) and with new or existing taxonomy entries 221 (shown in FIG. 9).

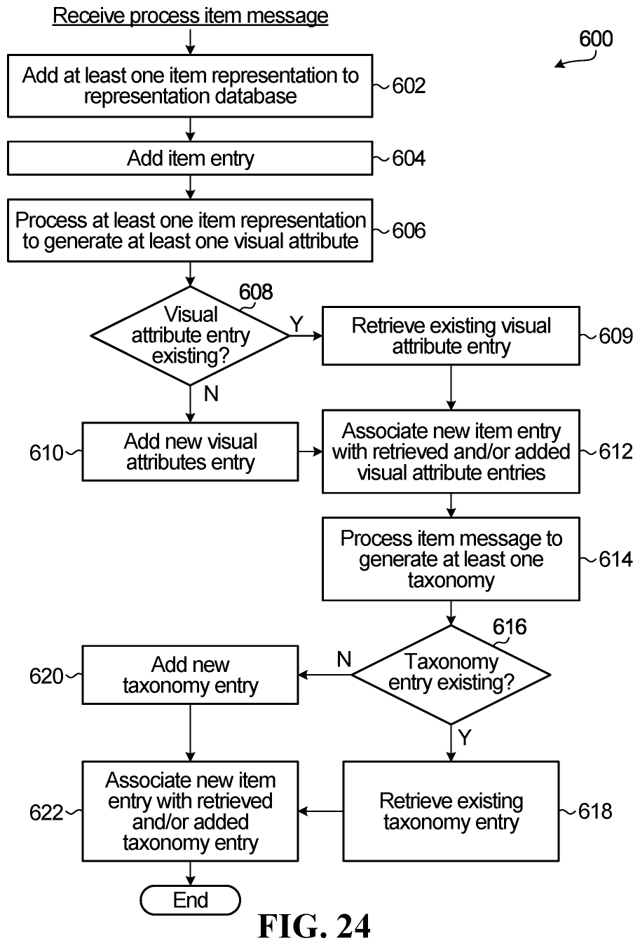

An illustrative embodiment of the process item codes 600 is shown in FIG. 24. In the embodiment shown, the process item codes 600 begin at block 602, which include code for directing the microprocessor 102 to store the at least one item representation contained in the process item message in the representation database 124 (shown in FIG. 1).

The process item codes 600 then continue at block 604, which include code for directing the microprocessor 102 to add a new instance of the item entry 171 (shown in FIG. 7) to the item table 170 (shown in FIG. 2). This new instance of the item entry 171 may store, in the vendor identifier field 173, a vendor identifier identifying an instance of the vendor entry 231 representing the vendor operating the vendor server 116 from which the item recommendation server 100 received the process item message and, in the item representation path field 177, URI(s) directing to location(s) in the representation database 124 where the at least one item representation was initially stored in block 602. This new instance of the item entry 171 may also store information included in the process item message, such as the description of the item from the vendor in the vendor description field 178, price of the item in the price field 179, different sizes of the item in the options field 180 and the link to the vendor webpage or the other information for facilitating purchase of the item in the purchase path field 181.

The process item codes 600 then continue to block 606, which include code for directing the microprocessor 102 to process the information in the item message (such as the at least one image representation) to generate visual attributes associated with the item. For example, the block 606 may include code for directing the microprocessor 102 to extract colors, patterns, textures and reflectivity of the item from the at least one item representation as visual attributes which are similar to the codes of block 556 of the process image codes 550 (shown in FIG. 21). For example, block 606 may also extract different values or definitions of generated visual attributes from the at least one item representation using the K-means cluster and the pattern/texture classification model.

The process item codes 600 then continue at block 608, which include code for directing the microprocessor 102 to search the visual attribute table 160 to determine whether it already stores instances of the visual attribute entry 161 representing a visual attribute generated at block 606, and may be similar to the codes of block 558 of the process image codes 550 (shown in FIG. 21). For example, block 608 may also direct the microprocessor 102 to search for visual attribute entries 161 which: store a definition in the definition field 164 which matches the value or other definition of the generated visual attribute; or store a description in the description field 166 which matches the value or other definition of the generated visual attribute.

If the microprocessor 102 determines, at block 608, that one of the generated visual attributes does not have a corresponding existing visual attribute entry 161 in the visual attribute table 160, the process item codes 600 then continue to block 610, which include code for directing the microprocessor 102 to add a new instance of the visual attribute entry 161 for such an generated visual attribute and may be similar to the codes of block 560 of the process image codes 550 (shown in FIG. 21). For example, the new instance of the visual attribute entry 161 may store a value or a definition which corresponds to the value or other definition of the generated visual attribute in the definition field 164 and/or the description field 166, a representation of the generated visual attribute in the representation database 124 (shown in FIG. 1), and a URI identifying the storage location of a visual attribute representation of the generated visual attribute in the visual attribute representation path field 168. The process item codes 600 then continue at block 612. If the microprocessor 102 determines, at block 608, that the visual attribute table 160 does include a visual attribute entry 161 representing the visual attribute, the process item codes 600 then continue at block 609, which include code for directing the microprocessor 102 to retrieve the existing visual attribute entry 161 from the visual attribute table 160. The process item codes 600 may cycle through block 608 and then either block 610 (add new instance of visual attribute entry) or block 609 (retrieve existing instance of visual attribute entry) for each visual attribute generated by the microprocessor 102 from the process item message (such as the at least one item representation) at block 606.

The process item codes 600 then continue to block 612, which may include code for directing the microprocessor 102 to associate the visual attribute entries 161 (shown in FIG. 6) retrieved at block 609 or added at block 610 with the new instance of the item entry 171 (shown in FIG. 7) added at block 604 to persistently associate a particular item received or retrieved from a vendor with one or more visual attributes. The codes of block 612 may be similar to the codes of block 566 of the process image codes 550 (shown in FIG. 21). For example, block 612 may include code for directing the microprocessor 102 to store the visual attribute identifiers from the identifier fields 162 of the retrieved or added visual attribute entries 161 in the visual attribute identifier field 175 of the new instance of the item entry 171.

The process item codes 600 then continue to block 614, which may include code for directing the microprocessor 102 to process the information in the process item message to classify or categorize the item into a particular macro-item category and/or into a particular micro-item category. In some embodiments, the microprocessor 102 may analyze the description of the item from the vendor or the at least one item representation received in the process item message. For example, if a description of an item from the vendor included “Cardigan; Embroidered Cashmere; Camel; P62535 K48069 13E367”, then block 614 may include code for directing the microprocessor 102 extract text from the description and label the item with “top”, “sweater”, “cardigan” and “cashmere” category labels; alternatively, if the description of an item from the vendor included “Necklace; Metal, Glass Pearls, Imitation Pearls & Resin; Gold, Blue, Pearly White; AB2394 Y47901 Z8798” then block 614 may include code for directing the microprocessor 102 to extract text from the description and label the item with “jewelry”, “necklace”, “resin”, “pearl” and “glass” category labels. Alternatively or additionally, block 614 may include code for implementing an item category classification model that automatically classifies an item into a macro-item category and/or a micro-item category based on a representation of the item. For example, the classification model may be trained on pixel matrices of a plurality of training item representations which are previously labelled with known item category labels, such as “tops”, “pants”, “sweaters”, or “shoes” and may be adapted to cluster together different training item representations associated with similar labels using the pixel matrix. For example, item representations which correspond to the “tops” category may be clustered together in a first cluster, while item representations which correspond to a “pants” category may then be clustered together in a second cluster. The item category classification model may be trained to increase the distance between clusters associated with different item categories by, for example, weighing different pixels of the pixel matrices differently or by considering additional information, such as descriptions received from the vendor. After training, the item category classification model may be capable of outputting at least one item category label based on an input of the pixel matrix of an item representation, and may be able to predict the item category label based on the pixel matrix of a particular item representation of. The item category label may be defined as the item category generated based at least in part on the item representation. The microprocessor 102 may extract one or more category labels from the information in the process item message.

The process item codes 600 then continue to block 616, which include code for directing the microprocessor 102 to search the taxonomy table 220 to determine whether it stores instances of the taxonomy entries 221 (shown in FIG. 9) representing each item category label of the one or more extracted item category labels. For example, the microprocessor 102 may search for, and retrieve, taxonomy entries 221 which store a text string in the macro-item category field 224 and/or the micro-item category field 226 which matches the text string of the item category label extracted from the information in the process item message at block 614.

If the microprocessor 102 determines, at block 616, that one of the one or more extracted item category labels does not have a corresponding existing taxonomy entry 221 in the taxonomy table 220, the process item codes 600 then continue to block 620, which include code for directing the microprocessor 102 to add a new instance of the taxonomy entry 221 for such an extracted item category label. This new instance of the taxonomy entry 221 may store the extracted item category label in the macro-item category field 224 and/or the micro-item category field 226. In certain embodiments, block 620 may also include code for directing the microprocessor 102 to automatically generate an item category label for the macro-item category field 224 if the extracted item category label is stored in the micro-item category field 226 and vice versa. For example, if “lucite” is the extracted item category label in the micro-item category field 226, the microprocessor 102 may store “jewelry” or “acrylic” in the macro-item category field 224. Block 620 may include code for directing the microprocessor 102 to automatically generate corresponding item category labels utilizing an item ontology. The process item codes 600 then continue at block 622. If the microprocessor 102 determines, at block 616, that the taxonomy table 220 does include an existing taxonomy entry 221 representing the extracted item category label, the process item codes 600 proceed to block 618, which include code for directing the microprocessor 102 to retrieve the existing taxonomy entry 221. The process item codes 600 may cycle through block 616 and then either block 620 (add new instance of taxonomy entry) or block 618 (retrieve existing instance of visual attribute entry) for each item category label extracted by the microprocessor 102 at block 614. The process item codes 600 then continue to block 622.

Block 622 includes codes for directing the microprocessor 102 to associate the taxonomy entries 221 (shown in FIG. 9) retrieved at block 618 or added at block 620 with the new instance of the item entry 171 (shown in FIG. 7) added at block 604 to persistently associate a particular item received or retrieved from a vendor with one or more item categories. In the embodiment shown, block 622 may include code for directing the microprocessor 102 to store the taxonomy identifiers from the identifier field 222 of the newly added or existing instances of the taxonomy entries 221 in the taxonomy identifier field 174 of the new instance of the item entry 171. The process item codes 600 then end.

As a result of the process item codes 600, the item received or retrieved from a vendor in the process item message is stored in the item table 170 (shown in FIG. 2) as an item entry 171 and is persistently associated with one or more visual attributes and one or more taxonomies. As described above, the process image codes 550 associated an image uploaded by a user persistently with one or more visual attributes. The combination of the process item codes 600 and the process image codes 550 thus associate both items and images with visual attributes, which enables item recommendation server 100 to retrieve both items and images based on the visual attributes which are associated with the item and the image. A user whom identifies an image having an attractive or desirable color scheme or patterns (visual attributes), may search for items that have similar colors or similar patterns and vice versa. More particularly, the item recommendation server 100 allow the user to search for items which are associated with at least one visual attribute which match at least one visual attribute associated with an image.

In the embodiment shown, image posts (such as the image posts 380, 390 (shown in FIG. 14), 430 (shown in FIG. 15), 444 (shown in FIG. 16), and 490 (shown in FIG. 17) for example) include a shop image button (such as shop image buttons 388, 436, 454 and 498 for example). When a user selects such shop image buttons, the user interface codes 330 may direct the user device 114 to display the shop image page 630 shown in FIG. 25.

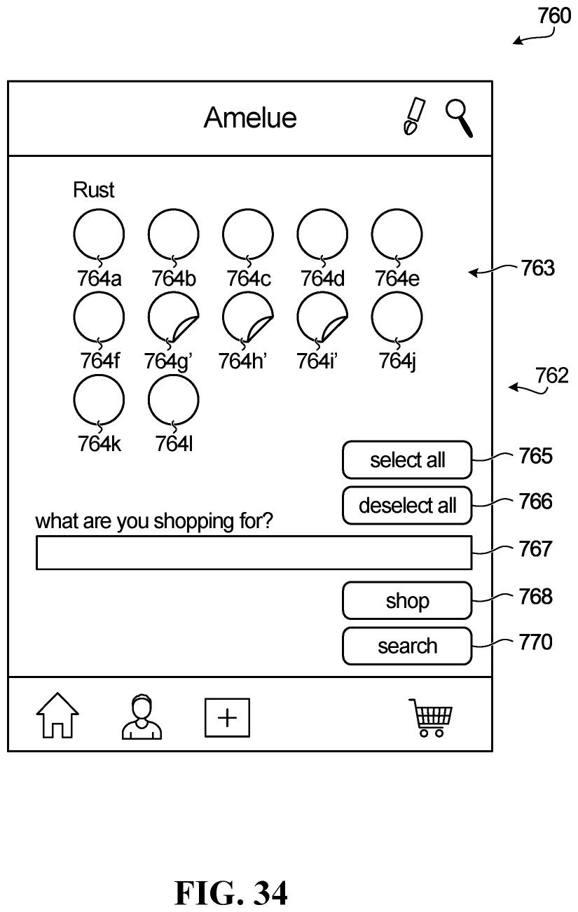

In other embodiments, as will be described below in connection with FIGS. 33 and 34, the user may be directed to different embodiments of the shop image page 630 by selecting the palette selection button 370 (labelled in FIG. 14) of the header region 362, which may direct the user to select visual attributes associated with a palette. The palettes may be selected by a vendor or a host of the item recommendation server 100 or other users of the item recommendation server 100 or the current user at a previous point in time. The palette may be based on at least one image representation stored in the representation database 124. In other embodiments (not shown), the item recommendation server 100 may enable a user to search for items using visual attributes which are associated with images which do not correspond to images uploaded by users via the process image codes 550. For example, a user may select visual attributes from a representation of all possible colors, such as from an image of a color wheel with all possible RBG or hexadecimal values, or from a representation of a plurality of possible colors in a color hue, such as from an image of different shades of red or a different shades of orange. The user may also select visual attributes from a representation of a plurality of textures and/or patterns, such as from a list of different textures and/or patterns. Such representations of visual attributes may be at least one image representation stored in the representation database 124 or may be an image generated by the microprocessor 102 automatically based on all or a portion of the visual attribute entries 161 stored in the visual attribute table 160.

Referring now to FIG. 25, in the embodiment shown, the shop image page 630 includes a shop image region 632. The shop image region 632 displays an image 634, a visual attribute array 635 including a plurality of visual attribute representations 636a-636f associated with the image 634, a query field 638, and a shop button 640.

The image 634 corresponds to the image (such as images 384, 394 (shown in FIG. 14), 432 (shown in FIG. 15), 450 (shown in FIG. 16), and 492 (shown in FIG. 17)) of an image post displayed on the home page 360, the user profile page 410, the image page 440 or the visual attribute search page 470 and selected by the user. The user interface codes 330 may display, as the image 634, the image representation stored in the representation database 124 (shown in FIG. 2) directed to by a URI in the image representation path field 150 of the image entry 141 (the “selected image entry”, shown in FIG. 4) corresponding to the image post selected by the user.

The visual attribute array 635 includes the visual attributes which are associated with the image 634. In certain embodiments, the user interface codes 330 may display, as the plurality of visual attribute representations 636a-636f, the representations stored in the representation database 124 (shown in FIG. 2) directed to by a URI in the visual attribute representation path field 168 of the visual attribute entries 161 (shown in FIG. 6) identified in the visual attribute identifier field 146 of the selected image entry 141 corresponding to the image post selected by the user. In the embodiment shown, the visual attribute array 635 includes six visual attribute representations 636a-636f, indicating that six instances of visual attribute entries 161 are identified by the selected image entry 141. In other embodiments, the visual attribute array 635 may include a greater or a fewer number of visual attribute representations, the number of representations indicating the number of visual attributes that are associated with the selected image. In embodiments where the number of visual attribute representations is greater, the visual attribute array 635 may include two rows of visual attribute representations or may be horizontally or vertically scrollable by the user.

Each of the plurality of visual attribute representations 636a-636f may be selectable, and user selection of one or more of the visual attribute representations 636a-636f may indicate that the user is interested in finding items which are associated with visual attributes that match or correspond to the selected visual attribute. The user may not select any of the visual attribute representations 636a-636f, single select one of the visual attribute representations 636a-636f, double select one of the visual attribute representations 636a-636f or select more than one of the visual attribute representations 636a-636f. In some embodiments, the user may only select a single one of the visual attribute representations 636a-636f.

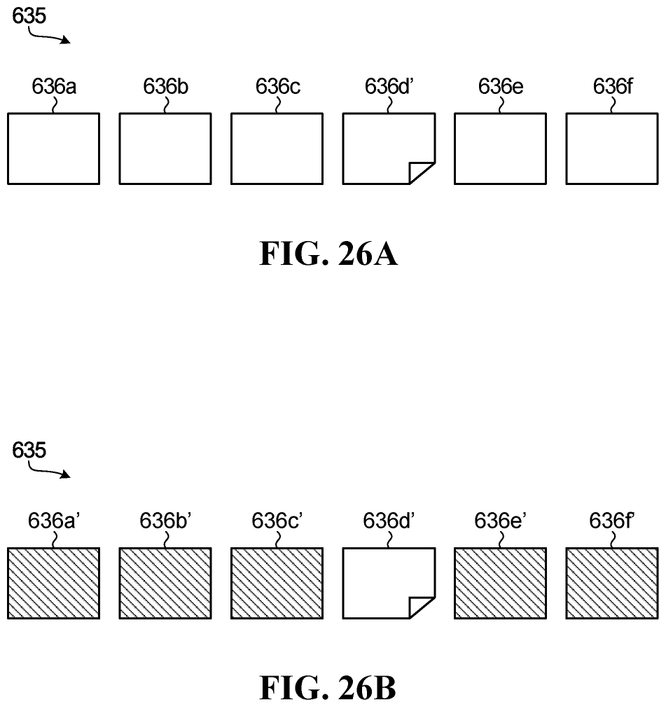

When the user single selects a particular visual attribute representation 636a-636f, the user interface codes 330 may direct the user device 114 to display a modification of the selected visual attribute representation. For example, referring to FIG. 26A, in the embodiment shown, non-selected visual attribute representations 636a, 636b, 636c, 636e, and 636f have rectangular outlines, but the single-selected visual attribute representation 636d is displayed as a modified selected visual attribute representation 636d′ having a rectangular outline with a folded bottom-right corner. In other embodiments, the non-selected visual attribute representations 636a-636f may be displayed with circular outline, a square outline, etc. Further, different portions of the outlines of the visual attribute representations may be folded when the visual attribute representation is single-selected, such as the entire bottom half of the outline or a different corner of the outline for example. In some other embodiments, the user interface codes 330 may modify the single-selected visual attribute representation in an additional or an alternative manner than folding the outline of the visual attribute representation. For example, the outline of the visual attribute representation may be colored with a specific or random color. When the user double selects a particular visual attribute representation, the user interface codes 330 may direct the user device 114 to display a modification of the double-selected visual attribute representation, as well as a modification of every other non-selected visual attribute representation in the visual attribute array 635. For example, referring to FIG. 26B, in the embodiment shown, the double-selected visual attribute representation 636d is displayed as the modified selected visual attribute representation 636d′ having a rectangular outline with a folded bottom-right corner and the non-selected representations 636a, 636b, 636c, 636e and 636f are all displayed as modified non-selected representations 636a′, 636b′, 636c′, 636e′ and 636f′ having rectangular outline with a grayed-out color. In other embodiments, the outlines of the representations may be different, different portions of the outlines of the representations may be folded when the representation is double-selected, and the non-selected representations may be modified in alternative or additional manners.

Referring back to FIG. 25, the query field 638 is operable to receive a text query from the user entered via the user device 114. For example, the user may enter the item category that the user is interested in, such as “dress”, “sweater” or “jewelry”, as the text query. The text query may correspond to one or more macro-item categories or micro-item categories stored in, respectively, the macro-item category field 224 and the micro-item category field 226 of one or more instances of the taxonomy entry 221 (shown in FIG. 9) stored in the taxonomy table 220. In other embodiments, the user may enter a name of a clothing brand, a name of a vendor, a clothing style, or any other text string, as the text query. For example, the text query may correspond to one or more descriptions stored in the description field 234 of one or more instances of the vendor entry 231 (shown in FIG. 8). The user may not enter any text query in the query field 638, may enter one text query in the query field 638, or may enter more than one text query in the query field 638.

When the user selects the shop button 640, the user interface codes 330 may transmit information from the shop image page 630, including the image 634, the visual attribute array 635, any selection of the visual attribute representations 636a-636f and any text query entered in the query field 638, to the recommend items codes 650 (shown in FIG. 1) stored in the program memory 108 of the item recommendation server 100 in a recommend items request.

The recommend items codes 650 generally include code for retrieving a plurality of items associated with visual attributes that match one or more of the visual attributes associated with the image (or palette) that the user selected to shop from. The recommend items codes 650 also include code for (1) classifying the retrieved plurality of items into a first set and at least one separate second set, wherein items in the first set and the second set are mutually exclusive, and then (2) simultaneously displaying the first set and the second set proximate to each other. In certain embodiments, the items in the second set may be complementary to the items in the first set or may be complementary to an entered text query. Displaying different and/or complementary items proximate to each other may encourage a user to purchase matching items and may further encourage a user to provide combinations of items to the item recommendation server 100. The recommend items codes 650 may also include code for ordering the items within the first set and within the second set and displaying the first and second set items in the specific orders.

An illustrative embodiment of the recommend items codes 650 is shown in FIGS. 27A-27C. In the embodiment shown, the recommend items codes 650 begin at block 652, which include code for directing the microprocessor 102 to identify and retrieve a plurality of items associated with a visual attribute which match at least one visual attribute associated with the image (or palette) that the user initially selected to shop from. For example, block 652 may include code for directing the microprocessor 102 to identify and retrieve a plurality of item entries 171 (shown in FIG. 7) identifying a visual attribute entry 161 (shown in FIG. 6) in the visual attribute identifier fields 175 which matches with least one of the visual attribute entries 161 identified by the selected image entry 141 (in the visual attribute identifier field 146 for example, shown in FIG. 4) representing the image the user selected to shop from (such as image 634 for example) or identified by a selected palette entry 191 (in the visual attribute identifier field 193 for example, shown in FIG. 5) representing a palette a user selected to shop from. In different embodiments, block 652 may include different codes for directing the microprocessor 102 to determine whether a visual attribute identified by an item entry 171 “matches” a visual attribute identified by an image entry 141. For example, block 652 may use different codes depending on whether the visual attribute represented by the visual attribute entries 161 are colors or patterns/textures.

If the two visual attributes are colors defined by pixel values stored in the respective definition fields 164 of corresponding visual attribute entries 161 (shown in FIG. 6), block 652 may include code for directing the microprocessor 102 to determine whether the two visual attributes match by determining whether a distance between the two pixel values exceed a threshold. For example, where the visual attributes are defined by RGB values, block 652 may include code for directing the microprocessor 102 to determine the distance in 3-dimensional RGB space between a first color corresponding to a first visual attribute entry 161 and a second color corresponding to a second visual attribute entry 161 using formula (1) below.

D=\sqrt{(R_{c}_{₁}−R_{c}_{₂})²+(G_{c}_{₁}−G_{c}_{₂})²+(B_{c}_{₁}−B_{c}_{₂})²} (1)

wherein:
Rc₁, Gc₁, and Bc₁ represent R, G and B pixel values stored in the definition field 164 of the first visual attribute entry 161 representing the first color, and
Rc₂, Gc₂, and Bc₂ represent the R, G and B values stored in the definition field 164 of the second visual attribute entry 161 representing the second color.

The smaller the value of D, the closer the color match. A perfect color match between the first color and the second color occurs if D=0. The threshold for determining that the first color and the second color match may be set at D_{<}30 for example.

If the two visual attribute are patterns or textures, block 652 may include code for directing the microprocessor 102 to determine matches between a first pattern corresponding to a first visual attribute entry 161 and a second pattern corresponding to a second visual attribute entry 161 by finding matches of descriptions stored in the description fields 166 of the first and second visual attribute entries 161. For example, the microprocessor 102 may determine that the first and second patterns match if both the corresponding first and the second visual attribute entries 161 store the term “floral” or “plaid” in the description field 166. As described in connection with block 556 of the process image codes 550 and block 606 of the process item codes 600, the description field 166 of the visual attribute entries 161 may be automatically populated using a pattern label or texture label outputted by the pattern/texture classification model, and block 652 may thus determine that two patterns match if the pattern/texture classification model outputted the same pattern label based the visual attribute representations of the two patterns. In other embodiments, the microprocessor 102 may determine whether the first and second patterns match by determining whether a distance between the first pattern and the second pattern exceed a threshold. For example, block 652 may include code for directing the microprocessor 102 to extract a pixel matrix of the visual attribute representation of the first pattern and a pixel matrix of the visual attribute representation of the second pattern (directed to by a URI in the visual attribute representation path 168 of the first and second visual attribute entries 161) and then determine the distance between the two pixel matrices utilizing a model which calculates an edit distance or a graph edit distance (such as the Wagner-Fischer algorithm, the Jaro-Winkler distance algorithm or the Hamming distance calculator for example). The first and second patterns may match if the distance is below a threshold and may not match if the distance is above the threshold.

The recommend items codes 650 then continue at block 654, which includes codes for directing the microprocessor 102 to determine whether the user selected any of the visual attribute representations 636a-636f using the shop image page 630 (shown on FIG. 25), and if the user did select a visual attribute representation 636a-636f, whether the selection was a single selection or a double selection. Any such visual attribute selection may be included in the recommend items request.

Referring to FIG. 27A, if the microprocessor 102 determines at block 654 that the user provided a single selection of one of the visual attribute representations 636a-636f, the recommend items codes 650 continue at block 656, which include code for directing the microprocessor 102 to determine whether the user entered any text query (such as in the query field 638 of the shop image page 630 shown on FIG. 25). Any such text query entered may also be included in the recommend items request.

If the microprocessor 102 determines at block 656 that the user entered a text query—such that the user both (a) provided a single selection of a visual attribute representation representing a selected visual attribute and (b) entered a text query—the recommend items codes 650 then continue at block 658, which include code for directing the microprocessor 102 to identify those item entries 171 of the item entries 171 initially retrieved at block 652 which (1) are associated with visual attributes which match the selected visual attribute and (2) match or correspond to the text query. The microprocessor 102 classifies the item entries 171 which meet criteria (1) and (2) in a first set of items or as first set items.

With respect to criteria (1) above, block 658 may include code for directing the microprocessor 102 to identify items associated with visual attributes which match the single-selected visual attribute by directing the microprocessor 102 to identify, from the item entries 171 initially retrieved at block 652 (identifying visual attribute entries 161 which match any visual attribute associated with the image (or palette)), those item entries 171 which identify visual attribute entries 161 in the visual attribute identifier field 175 that match the visual attribute entry 161 representing the single-selected visual attribute. Block 658 may determine whether two visual attributes match in a manner similar to block 652 described above.

With respect to criteria (2) above, in different embodiments, block 658 may include different codes for enabling the microprocessor 102 to identify items matching or corresponding to the text query. For example, block 658 may include code for directing the microprocessor 102 to identify item entries 171 storing a text string or other descriptive matter which matches or corresponds to the text query. For example, where the text query is “green” or “wool” for example, item entries 171 which store “green” or “wool” in either the description field 176 or the vendor description field 178 may be identified. Alternatively or additionally, in embodiments where text query corresponds to an item category that the user is interested in purchasing, such as “dress” or “sweater” for example, the text query may match or correspond to certain taxonomy entries 221 (shown in FIG. 9). Block 658 may include code for directing the microprocessor 102 to (a) determine at least one taxonomy which matches or corresponds to the entered text query, such as by identifying at least one taxonomy entry 221 storing a text string matching or corresponding to the entered text query in either the macro-item category field 224 or the micro-item category field 226 and then to (b) determine, of those item entries 171 identifying visual attributes which match the single-selected visual attribute (satisfies criteria (1) above), which also identifies one or more of the taxonomy entries 221 identified at (a) above in the taxonomy identifier field 174.

The recommend items codes 650 then continue at block 660 which include code for directing the microprocessor 102 to identify those item entries 171 of the item entries 171 initially retrieved at block 652 which (1) are associated with a visual attribute matching any visual attribute of the image (or palette) the user initially selected to shop from, (2) are complementary to at least one first set item and/or complementary to the text query, and (3) is not in the first set. The microprocessor 102 may then classify the item entries 171 which meet the criteria (1), (2) and (3) above within a second set of items or as second set items. In such embodiments, the first set items includes items associated with the single-selected visual attribute and matching the text query and the second set items includes items associated with at least one visual attribute of the image (or palette) and which is complementary to the first set items and/or the text query.

With respect to criteria (1) and (3) above, in different embodiments, block 660 may include different codes for enabling the microprocessor 102 to identify items associated with a visual attribute matching at least one visual attribute of the image and which are not in the first set. For example, block 660 may direct the microprocessor 102 to identify items associated with visual attributes which match any of the visual attributes of the image, but which are not in the first set items, by excluding, from the item entries 171 initially retrieved at block 652, those item entries 171 which were classified within the first set at block 658. In other embodiments, block 660 may direct the microprocessor 102 to identify items associated with visual attributes which match any visual attribute of the image that is not the single-selected visual attribute and which are not in the first set, by: (a) identifying, from the item entries 171 initially retrieved at block 652, those item entries 171 identifying visual attributes entries 161 that match visual attribute entries 161 representing any visual attribute of the image (or palette) other than the single-selected visual attribute, and (b) exclude from the item entries 171 identified at (a), those item entries 171 which were classified within the first set at block 658. Block 660 may determine whether two visual attributes match in a manner similar to block 652 described above.

With respect to criteria (2) above, in different embodiments, block 660 may include different codes for enabling the microprocessor 102 to determine which items are complementary to at least one first set item and/or complementary to the text query. For example, block 660 may include code for directing the microprocessor 102 to determine complementary items utilizing a curated determination or a model-based determination, or utilizing a combination of the curated determination and the model-based determination.

In embodiments where block 660 directs the microprocessor 102 to utilize the curated determination, the complementarity of different item entries 171 may be explicitly programmed in the application database 122 (shown in FIG. 2). For example, the microprocessor 102 may identify complementary second set items by (a) identifying item entries 171 identified in the complementary item identifier field 182 (shown in FIG. 7) of the item entries 171 representing the first set items, and/or (b) identifying item entries 171 which identify, in their complementary item identifier field 182, item entries 171 representing the first set items. Such codes may identify complementary between specific items, and thus complementarity at the item-level (a specific dress is complementary with a specific pair of shoes for example). The specific combination of complementarity between items may be curated by the vendor selling the items or by a host of the item recommendation server 100. Alternatively or additionally, block 660 may identify complementary categories, and thus complementarity at the category-level (dresses are generally complementary with heels for example). In such embodiments, the microprocessor 102 (a) identify taxonomy entries 221 identified in the taxonomy identifier fields 174 of the item entries 171 representing the first set items, the identified taxonomy entries 221 corresponding to item categories of the first set items, (b) identify any complementary taxonomy entries 221 which are identified in the complementary taxonomy identifier fields 228 (shown in FIG. 9) of the taxonomy entries 221 identified at (a), and (c) identify, as the complementary second set items, item entries 171 which identify the complementary taxonomy entries 221 identified at (b) in their taxonomy identifier fields 174. In embodiments where the entered text query itself matches or substantially corresponds to certain taxonomy entries 221, block 660 may further include code for directing the microprocessor 102 to (a) identify taxonomy entries 221 which matches or substantially corresponds to the text query in a manner similar to block 658 described above, (b) identify any complementary taxonomy entries 221 which are identified in the complementary taxonomy identifier field 228 (shown in FIG. 9) of the taxonomy entries 221 identified at (a), and (c) identify, as the complementary second set items, item entries 171 which identify the complementary taxonomy entries 221 identified at (b) in their taxonomy identifier fields 174.

Block 660 may also direct the microprocessor 102 to identify, as complementary items, item entries 171 which: (b) identify vendor entries 231 (shown in FIG. 8) in the vendor identifier field 173 that are also identified by the item entries 171 representing the first set items (items sold by a same vendor as the first set items); (c) store descriptions in the description field 176 or in the vendor description field 178 which match or correspond to the description stored in the description field 176 or the vendor description field 178 of the item entries 171 representing the first set items; or (d) store descriptions in the description field 176 or in the vendor description field 178 which match the description store in the macro-item category field 224 or the micro-item category field 226 of taxonomy entries 221 identified in the taxonomy identifier field 174 of the item entries 171 corresponding to the first set items.

In embodiments where block 660 directs the microprocessor 102 to identify complementary items utilizing the model-based determination, the complementarity of different items may be determined based on a complementarity model which processes historical entries stored in the application database 122 (shown in FIG. 2) to determine complementary items or complementary item categories. The historical entries may be entries stored in the interaction history table 250, the combination history table 290, and the purchase history table 270 for example. In such embodiments, the items which are complementary to the first set items may shift over time depending on user interaction with items, user combination of items and user purchase of items. In certain embodiments, the complementarity model may categorize items into clusters based on prior user interaction with items, prior user combination of items and prior user purchase of items which are used as a proxy to indicate that certain items are complementary.

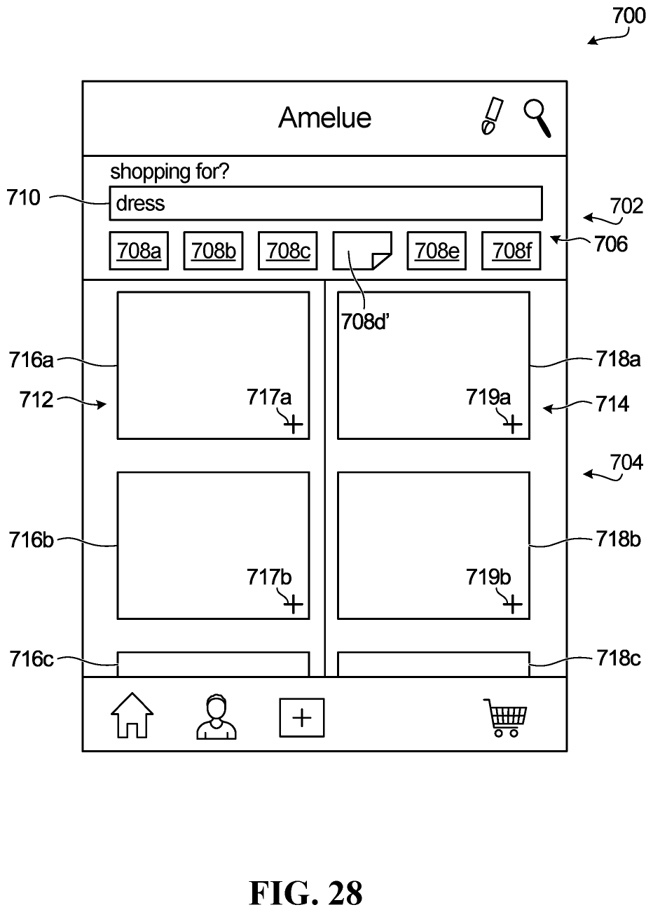

For example, the complementarity model may be trained on the interaction history entries 251 (shown in FIG. 10), wherein different items that a particular user interacts with within a short time frame may be classified as “complementary” items. In this respect, as described in greater detail below in association with a recommend items page shown generally at 700 in FIG. 28, a new instance of the interaction history entry 251 may be created each time a user interacts with an item representation 716a-716c and 719a-719c of an item entry 171 displayed on the recommend items page 700. The complementarity model may categorize the item entries 171 identified in the item identifier field 254 of a single such interaction history entry 251 as “complementary” items. Alternatively, the complementarity model may categorize different item entries 171 identified in respective item identifier fields 254 of a plurality of such interaction history entries 251 as “complementary” items if the interaction history entries 251 identify a same user in the user identifier fields 253, a same image (or palette) in the image identifier fields 255, and/or store times in the created fields 259 that are separated by a time gap below an interaction time gap threshold. The interaction time gap threshold may be 6 minutes, 10 minutes, 19 minutes or 60 minutes for example.

Alternatively or additionally, the complementarity model may be trained on the combination history entries 291 (shown in FIG. 11), wherein different items that a particular user combines and adds to the shopping cart may be classified as “complementary” items. For example, as described in greater detail below in association with the recommend items page 700 (shown in FIG. 28), a new instance of the combination history entry 291 may be created each time a user interacts with at least one item representation 716a-716c of at least one item classified within the first set and displayed in a first set region 712 of the recommend items page 700 and/or at least one item representation 719a-719c of at least one item classified within the second set and displayed in a second set region 714 of the recommend items page 700 to add the items from the first item set and/or the second item set to the shopping cart. The complementarity model may categorize item entries 171 identified in the first set item identifier field 294 and/or in the second set item identifier field 295 of such combination history entries 291 as “complementary” items.

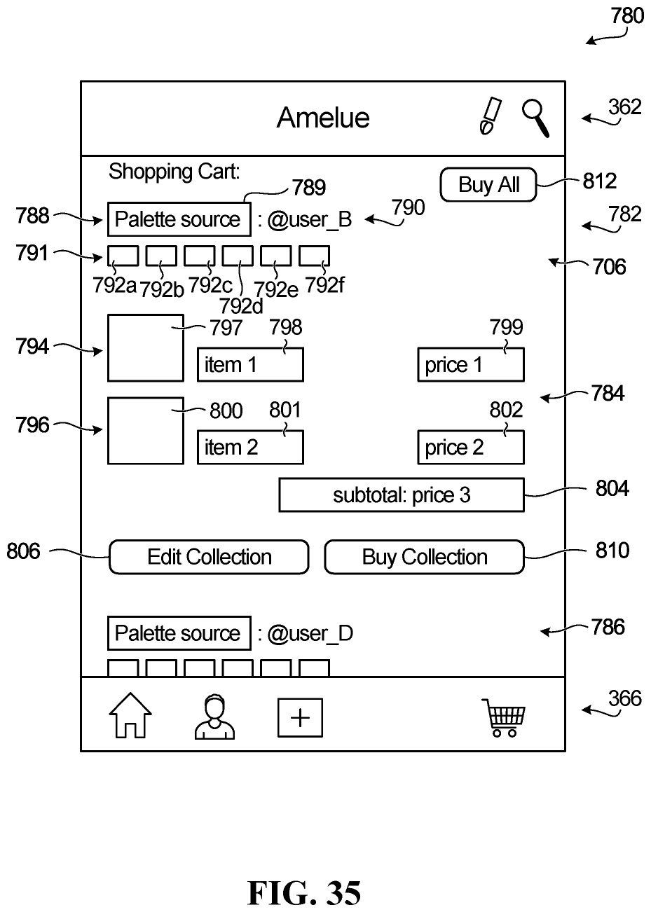

Alternatively or additionally, the complementarity model may be further be trained on the purchase history entries 271 (shown in FIG. 12), wherein items that a particular user purchases at the same time, or within a short time frame of each other, may be classified as “complementary” items. For example, as described in greater detail below in association with a shopping cart page shown generally at 780 in FIG. 35, a new instance of the purchase history entry 271 may be created each time a user purchases items or an item collection. The complementarity model may categorize item entries 171 identified in the item identifier field 274 of a single such purchase history entry 271 as “complementary” items. Alternatively, the complementarity model may also categorize different item entries 171 identified in respective item identifier fields 274 of a plurality of such purchase history entries 271 as “complementary” items, if the purchase history entries 271 also identify a same user in the user identifier fields 273, a same image (or palette) in the image identifier fields 275, and/or store times in the created fields 278 that are separated by a time gap below a purchase time gap threshold, to the complementarity model as records of the user purchasing “complementary” items. The purchase time gap threshold may be one hour, 11 hours, 23 hours, 48 hours, a week or a month for example.

After the complementarity model is trained on the historical entries, different items may be clustered into groups of item entries 171 considered to be “complementary” to each other, and such clusters may identify complementarity between specific item entries 171, and thus complementarity at the item-level. The complementarity model may then extract the taxonomy entries 221 identified in the taxonomy identifier field 174 of item entries 171 that are grouped into a cluster and to categorize such taxonomies as “complementary” to each other, which allows the complementarity model to identify complementarity at the category-level. Block 660 may thus include code for identifying items complementary to the first set items and/or complementary to the text query by determining, for example: (a) which “complementary” item entries 171 are clustered together with the first set items, (b) which taxonomy entries 221 are clustered together with the taxonomy entry 221 matching or corresponding to the text query and then “complementary” item entries 171 identifying such taxonomy entries 221 in their taxonomy identifier fields 173 (items which are in the item categories clustered with the text query) and/or (c) which taxonomy entries 221 are identified in the taxonomy identifier field 174 of the item entries 171 representing the first set items and then “complementary” item entries 171 identifying such taxonomy entries 221 in their taxonomy identifier fields 173 (items which are in the item categories clustered as the first set items). Block 660 may also include code for determining which items are similar to the items clustered together with the first set items and determining that such items are also complementary to the first set items, even if such items are not directly clustered together with the first set items. For example, block 660 may identify item entries 171 which identify taxonomy entries 221 in the taxonomy identifier field 174 also identified by clustered item entries 171 (items in a same item category as the items clustered together with the first set items).

The recommend items codes 650 the continue to block 661, which include code for directing the microprocessor 102 to order the items classified within the first set at block 658 and to order the items classified within the second set at block 660. In different embodiments, block 661 may include different codes for directing the microprocessor 102 to determine the order of the items within the first set and the within second set. Block 661 may include code for directing the microprocessor 102 to order the items within the first and second sets independently, or to order the items such that the order of the items in the first set affects the order of the items in the second set and vice versa. Block 661 may also include code for directing the microprocessor 102 to order the items classified within each set of items utilizing a curated ranking, utilizing a model-based ranking or utilizing a combination of the curated ranking and the model-based ranking.

In embodiments where the block 661 directs the microprocessor 102 to order items utilizing the curated ranking, the ranking of different item entries 171 may be explicitly programmed in the application database 122 (shown in FIG. 2). For example, block 661 may order items classified within the first set based, at least in part, on how closely the visual attribute associated with the first set item matches the selected visual attribute. Block 661 may include code similar to block 652 described above for determining how closely two visual attributes match. For example, in embodiments where the selected visual attribute is a color defined by pixel values, block 661 may order item entries 171 associated with visual attribute entries 161 having a distance of D=0 from the visual attribute entry 161 representing the single-selected visual attribute first, and item entries 171 associated with visual attribute entries 161 that are more distant subsequently. In embodiments where the selected visual attribute is a pattern or a texture, block 661 may order item entries 171 associated with visual attribute entries 161 that have pixel matrices which have a small edit distance from the pixel matrix of the single-selected visual attribute first, and item entries 171 associated with visual attribute entries 161 that have a greater edit distance subsequently. Additionally or alternatively, block 661 may order items classified within the first set based, at least in part, on how closely first set item matches or corresponds to the entered text query. For example, block 661 may order item entries 171 associated with a taxonomy entry 221 that is a perfect match or exactly corresponds to the entered text query (such as the macro-item category field 224 and the entered text query both being “dress” for example) first, and item entries 171 associated with a taxonomy entry 221 does not exactly match or correspond subsequently.

Block 661 may also order items classified within the second set based, at least in part, on how closely the visual attributes associated with the second set item matches (a) any of the visual attributes of the image (or palette) or (b) any visual attribute of the image (or palette) that is not the single-selected visual attribute. As noted above, block 661 may include code similar to block 652 described above for determining how closely two visual attributes match. Block 661 may also order items classified within the second set based, at least in part, on the number of the visual attributes of the image (or palette) which match the visual attributes associated with the second set item. For example, block 661 may order item entries 171 representing a second set item identifying visual attribute entries 161 in the visual attribute identifier field 175 which match more than one visual attribute entry 161 identified in the visual attribute identifier field 146 of the image entry 141 (or the visual attribute identifier field 193 of the palette entry 191) representing the image (or palette).

Block 661 may also order items classified within the second set based, at least in part, on explicitly programmed levels of complementarity with the first set items. As noted above, item entries 171 may explicitly specify complementary items in the complementary item identifier field 182 and may further a level of complementarity for each complementary item in the complementary item order field 183 to identify complementarity at the item-level. The levels of complementarity stored in the complementary item order field 183 may be based on specific curated combinations of items selected by the vendor selling the items or by the host of the item recommendation server 100. In this respect, second set items which are (1) particularly complementary to a particular first set item or (2) complementary to a large number of the first set items may be ordered first. As noted above in association with block 660, item entries 171 representing second set items “complementary” to first set items may be identified as the item entries 171 identified in complementary item identifier field 182 of the item entries 171 representing the first set items. Block 661 may then order such second set items according to the levels of complementarity stored in the corresponding complementary item order fields 183 of item entries 171 representing the first set items, such that second set items having a high level of stored complementary may be ordered first, and second set items having a lower level of stored complementary may be ordered subsequently. Block 661 may also order items within the second set based on the number of first set items that the second set item is complementary with, and may thus order second set items that are identified in the complementary item identifier fields 182 of a large number of item entries 171 representing first set items first, and second set items which are identified in a fewer number subsequently.

Additionally, as noted above, taxonomy entries 221 may also explicitly specify both complementary taxonomies in the complementary taxonomy identifier field 228 and a level of complementarity for each complementary taxonomy in the complementary taxonomy order field 229, to identify complementarity at the category-level. The levels of complementarity stored in the complementary taxonomy order field 229 of the taxonomy entries 221 may be based on specific curated combinations of item categories selected by the vendor selling items or by the host of the item recommendation server 100. In this respect, second set items associated with taxonomies that are complementary to: (1) item categories of a particular first set item, (2) an item category associated with a large number of the first set items, and/or (3) item categories which match or correspond to the entered text query, may be ordered first; while second set items associated with a taxonomy that is not complementary to any item categories associated with any of the first set items or any item categories which match or correspond to the entered text query may be ordered subsequently. In this respect, as noted above in association with block 660, second set items may be “complementary” to first set items when their respective item entries 171 identify complementary taxonomy entries 221 in their respective taxonomy identifier fields 174; and second set items may also be “complementary” to the text query when the item entry 171 representing the second set item identifies a taxonomy entry 221 in the taxonomy identifier field 174 which is complementary to the taxonomy entry 221 matching or corresponding to the entered text query. Block 661 may then order items within the second set based the level of complementarity between taxonomy entries 221 identified by the second set items and the taxonomy entry 221 identified by the first set items or matching or corresponding to the entered text query, as stored in the complementary taxonomy order fields 229 for example; such that second set items associated with taxonomies which are highly complementary to the taxonomy of first set items or matching or corresponding to the entered text query are ordered first. Alternatively or additionally, block 661 may also order items within the second set based on the number of taxonomy entries 221 identified by the first set items or matching or corresponding to the entered text query which are complementary with the taxonomy entry 221 identified by the second set item, and may order items within the second set identifying a taxonomy entry 221 that is identified in the complementary taxonomy identifier fields 228 of a large number of the taxonomy entries 221 representing first set items or matching or corresponding to the entered text query first.

In embodiments where block 661 directs the microprocessor 102 to order items in the first set and to order items in the second set via the model-based ranking, the ranking of different item entries 171 may be determined based on a ranking model which processes historical entries stored in the application database 122 (shown in FIG. 2) to determine order of items. The historical entries may be entries stored in the interaction history table 250, the combination history table 290, and the purchase history table 270 of the application database 122 for example. Specifically, in certain embodiments, the ranking model may order items based, at least in part, on prior user interaction with items, prior user combination of items and prior user purchase of items.

For example, the ranking model may order items classified within the first set based, at least in part, on processing interaction history entries 251 (shown in FIG. 10). The ranking model may order first set items corresponding to item entries 171 that are identified by a large number of interaction history entries 251 in the item identifier fields 254 first (such items being frequently interacted with by users) and order first set items identified in a fewer number of interaction history entries 251 subsequently. The ranking model may assign different weights for different interaction history entries 251, and the highly weighted interaction history entries 251 may be more relevant for determining order of items within the first set. For example, interaction history entries 251 which identify a same image entry 141 in the image identifier field 255 as the image the user initially selected to shop from (indicating the frequency that users interact with an item after selecting a same image), or which identify a user entry 131 in the user identifier field 253 that is the same as the current user (indicating the frequency that the current user interacts with this item), or which identify a visual attribute entry 161 in the visual attribute identifier field 256 that is the same as or matches the single-selected visual attribute (selected at block 654, and indicating the frequency that users interact with an item after selecting a same visual attribute), or which identify a taxonomy in the taxonomy identifier field 257 that matches or substantially corresponds to the entered text query (determined at block 656, and indicating the frequency that users interact with an item when searching for the same item category or the same text query), may be more highly weighted than interaction history entries 251 which identify different images, different users, different visual attributes or different taxonomies.

Additionally or alternatively, the ranking model may order items classified within the first set based, at least in part, on processing purchase history entries 271 (shown in FIG. 12). The ranking model may order first set items corresponding to item entries 171 that are identified by a large number of purchase history entries 271 in the item identifier field 274 first (such items being frequently purchased by users) and order first set items that are identified by a fewer number of purchase history entries 271 subsequently. The ranking model may also assign different weights for different purchase history entries 271 and the highly weighted purchase history entries 271 may be more relevant for determining order of items within the first set. For example, purchase history entries 271 which identify a same image entry 141 in the image identifier field 275 as the image the user initially selected to shop from (indicating the frequency that users purchase an item after selecting a same image), or which identify a visual attribute entry 161 in the visual attribute identifier field 276 that is the same as or matches the single-selected visual attribute (selected at block 654, and indicating the frequency that users purchase an item after selecting a visual attribute), or which identify a taxonomy entry 221 in the taxonomy identifier field 277 that matches or substantially corresponds to the entered text query (determined block 656, indicating the frequency that user purchase an item when searching for the same item category or the same text query), may be more highly weighted that purchase history entries 271 which identify different images, different visual attributes or different taxonomies. The ranking model may also decrease the weight of items that the user has already purchased, based on the assumption that a user would not wish to purchase the same item more than once. For example, purchase history entries 271 which identify a user entry 131 in the user identifier field 273 that is the same as the current user may be given a low or a negative weight.

The ranking model may also order items classified to be within the second set based, at least in part, on processing interaction history entries 251 (shown in FIG. 10). The ranking model may order second set items corresponding to item entries 171 identified by a large number of interaction history entries 251 in the item identifier fields 254 first. The ranking model may also assign different weights for different types of interaction history entries 251 similar to that described above in connection with ordering first set items based on processing interaction history entries 251, and interaction history entries 251 which identify a same image entry 141 as the image the user initially selected to shop from, a user entry 131 that is the same as the current user, a visual attribute entry 161 that is the same as or matches the single-selected visual attribute, or a taxonomy entry 221 that matches or substantially corresponds to the entered text query, may be more highly weighted than interaction history entries 251 which identify different images, different users, different visual attributes or different taxonomies. Specific to ordering items in the second set, interaction history entries 251 which indicate that a user interacted with a second set item within a short time of interacting with a first set item may also be highly weighted by the ranking model, such as interaction history entries 251 which identify an item entry 171 representing a second set item and an item entry 171 representing a first set item in the item identifier fields 254, a same image entry 141 in the image identifier fields 255 and a same user entry 131 in the user identifier fields 253, wherein the time stored in the created field 259 of the interaction history entry 251 identifying the second set item is within a time gap below the interaction time gap threshold of the time stored in the created field 259 of the interaction history entry 251 identifying the first set item. The second set items identified by a large number of such interaction history entries 251 (indicating that a large number of users interact with that second set item within a short time gap of interacting with a first set item) may be ordered first.

Additionally or alternatively, the ranking model may order items classified within the second set based, at least in part, processing combination history entries 291 (shown in FIG. 11). The ranking model may order second set items corresponding to item entries 171 identified by a large number of combination history entries 291 (in the second set item identifier fields 295) that also identify an item entry 171 representing at least one first set item (in the first set item identifier field 294) first, and the second set items identified by a smaller number of such combination history entries 291 subsequently. A large number of such combination history entries 291 indicate that a particular second set item is commonly combined with any of the first set items by users, whereas a small number of such combination history entries 291 indicate that a particular second set item is less commonly combined with any of the first set items by users. In other embodiments, rather than considering how commonly a particular second set item is combined with any first set item, the ranking model may instead consider how commonly a particular second set item is combined with a particular first set item (such as a highly ordered first set item for example), and may thus order second set items corresponding to item entries 171 identified by a large number of combination history entries 291 (in the second set item identifier fields 295) that also identify an item entry 171 representing a specific first set item (in the first set item identifier fields 294) first, and the second set items identified by a smaller number of such combination history entries 291 subsequently.

Additionally or alternatively, the ranking model may also order items classified within the second set based, at least in part, on processing purchase history entries 271 (shown in FIG. 12). The ranking model may order second set items corresponding to item entries 171 identified by a large number of purchase history entries 271 in the item identifier field 274 first, and order second set items identified by a fewer number of purchase history entries 271 subsequently. The ranking model also may assign different weights for different purchase history entries 271 in a manner similar to that described above in connection with ordering first set items based on processing purchase history entries 271, wherein purchase history entries 271 which identify a same image entry 141 as the image the user initially selected to shop from, a visual attribute entry 161 that is the same as or matches the single-selected visual attribute, or a taxonomy entry 221 that matches or substantially corresponds to the entered text query, may be more highly weighted than purchase history entries 271 which identify different images, different visual attributes or different taxonomies. The ranking model may also decrease the weight of second set items that the user has already purchased, based on the assumption that a user would not wish to purchase the same item more than once, and purchase history entries 271 which identify a user entry 131 in the user identifier field 273 that is the same as the current user may be given a low or a negative weight. Specific to ordering items in the second set, purchase history entries 271 which indicate that a large number of users other than the current user purchased a second set item together with a first set item, or within a short time of purchasing the first set item, may also be highly weighted. For example, a purchase history entry 271 which identifies item entries 171 representing both a first set item and a second set item in the item identifier field 274 may be weighted highly (such a second set item being purchased at the same time as the first set item). Similarly, purchase history entries 271 which identify an item entry 171 representing a second set item and an item entry 171 representing a first set item in the item identifier fields 274 and identifies a same user entry 131 in the user identifier fields 273 (that is not the current user for example), wherein the time stored in the created field 278 of the purchase history entry 271 identifying the second set item is within a time gap below the purchase time gap threshold of the time stored in the created field 278 of the purchase history entry 271 identifying the first set item may also be weighted highly (such a second set item purchased within a short time of the purchase of first set items). The second set items that a large number of users purchase together with (or within a short time gap of purchasing) first set items may be considered to be popular complementary items.

As described above, block 661 may also order items within the second set based at least in part on the order of items within the first set. For example, second set items which are complementary to a highly ordered item in the first set may be ordered before second set items which are complementary to a less highly ordered item in the first set. In certain specific embodiments, where the order of items within the first set includes first set item A ordered first and first set item B ordered second, block 661 may order second set items which are complementary to first set item A first, and then second set items which are complementary to first set item B subsequently. Alternatively or additionally, second set items which have a high level of complementarity to any of the items in the first set may be ordered first, and second set items which have a lower level of complementarity to any of the items in the first set may be ordered subsequently. In certain embodiments, block 661 may order second set items which have a high level of complementarity to either first set item A or first set item B first, and then order second set items which have a lower level complementarity to either first set item A or first set item B subsequently.

The recommend items codes 650 then continue to block 662, which include code for directing the microprocessor 102 to display the first set of items and the second set of items to be simultaneously and proximate each other. For example, block 662 may include code for causing the user interface codes 330 to direct the user device 114 to display the recommend items page 700 (shown in FIG. 28), described in greater detail below. The recommend items codes 650 then continue at block 663, which include code for directing the microprocessor 102 to determine whether the user modifies either the selection of the visual attribute or the entered text query. The user may modify either the selection of the visual attribute or the entered text query using the recommend items page 700 for example.

Referring now to FIG. 28, the recommend items page 700 allow a user to view both the first set of items and the second set of items simultaneously and proximate to each other. This allows a user to simultaneously browse items of the first set and items of the second set. The recommend items page 700 may further allow the user to: (a) interact with and view different first set items and different second set items; (b) combine different first set items with other first set items or with second set items and combine different second set items with other second set items or with first set items; (c) purchase items from at least one of the first set and the second set. In the embodiment shown, the recommend items page 700 includes a modify query region 702 and an item display region 704.

The modify query region 702 includes a visual attribute array 706 which substantially corresponds to the visual attribute array 635 displayed on the shop image page 630 (shown on FIG. 25). The visual attribute array 706 includes a plurality of visual attribute representations 708a-708f which substantially corresponds to the plurality of visual attribute representations 636a-636f displayed on the shop image page 630 (shown in FIG. 25), and thus the visual attributes associated with the image (or palette) that the user initially selected to shop from. Each of the visual attribute representations 708a-708f displayed on the recommend items page 700 may also be selectable by the user to modify which visual attribute is selected or the selection of the visual attribute (single selection, double selection or no selection) similar to the visual attribute representations 636a-636f displayed on the shop image page 630. When the user selects a particular visual attribute representation 708a-708f, the user interface codes 330 may direct the user device 114 to display a modification of the selected representation and/or a modification of the non-selected representations in a manner similar to that described above in connection with FIGS. 26A and 26B. The modify query region 702 also includes a query field 710 operable to receive a text query from the user or receive a modification of the entered text query.

In the embodiment shown in FIG. 28, the recommend items page 700 is displayed after block 661 of the recommend items codes 650 (shown in FIG. 27A). Thus, the modify query region 702 displays the single selection of the selected visual attribute (single selection determined at block 654), such as by automatically causing the modify query region 702 to display the visual attribute representation 708d corresponding to the single-selected visual attribute as a modified visual attribute representation 708d′. The modify query region 702 also displays the entered text query (entered text query determined at block 656), such as by automatically pre-populating the entered text query in the query field 710. If the user interacts with the modify query region 702 to: (a) modify the selection of the visual attribute, such as by selecting another one of the plurality of visual attribute representations 708a-708c, 708e, or 708f or modifying the selection of the selected visual attribute by double selecting the visual attribute representation 708d or de-selecting the visual attribute representation 708d for example; and/or (b) modify the entered text query, such as by modifying the text string entered in the query field 710 or by deleting the text string entered in the query field 710 for example, the user interface codes 330 may transmit the modification to the recommend items codes 650. Referring briefly back to FIG. 27A, upon receipt of the modification, block 663 may direct the microprocessor 102 to determine that the user has modified the selection of the visual attribute and/or the entered text query. The recommend items codes 650 then return to block 654, which include code for directing the microprocessor 102 to determine whether the transmitted modification includes a single selection, a double selection or no selection of the visual attribute representations 708a-708f as described above. The recommend items codes 650 then continue from block 654 as described above and below.

Referring back to FIG. 28, the item display region 704 of the recommend items page 700 includes a first set region 712 displaying items classified within the first set and a second set region 714, located proximate the first set region 712, displaying items classified the second set simultaneously. In the embodiment shown, the first set region 712 is displayed as a first vertical scrollable column including a plurality of item representations 716a-716c corresponding to respective first set items and the second set region 714 is displayed as a second vertical scrollable column including a plurality of item representations 718a-718c corresponding to respective second set items and displayed immediately adjacent the first set region 712. The first set region 712 and the second set region 714 may be independently scrollable. In other embodiments, at least one of the first set region 712 and the second set region 714 may displayed in a different format, such as horizontally scrollable rows, or in a page flip format where each page corresponds to an item from the first or second set. By displaying the first set items and the second set items simultaneously and proximate each other, the recommend items page 700 may promote user interaction with first set items and complementary second set items, may promote user combination of first set items and complementary second set items, and may encourage users to purchase more than the items that the users initial searched for (the first set items) as users are automatically and simultaneously presented with different and complementary items (the second set items) that could lead to impulse purchases. Further, by having the first set region 712 and the second set region 714 be independently scrollable, a user can browse a variety of different items (from the second set items) which may be complementary to an item that the user initially set out to purchase (from the first set items). As described above and below, user interaction, combination and purchase of first and second set items creates historical entries stored in the application database 122 (shown in FIG. 2), which may then be used by the microprocessor 102 to determine complementary items or complementary item categories via the complementarity model, or the order of items in the first set and the second set via the ranking model. By displaying the first set items and the second set items simultaneously and proximate each other, the recommend items page 700 may promote generation of such historical entries by users of the item recommendation server 100, and such historical entries may allow the microprocessor 102 to determine more relevant complementary items or item categories and more relevant item orders, which may in turn encourage greater user interaction, combination and purchase.

The item representations 716a-716c may correspond to at least one of the item representations stored in the representation database 124 (shown in FIG. 1) directed to by the URIs in the item representation path fields 177 of the item entries 171 classified within the first set by various blocks of the recommend items codes 650 (including block 658 described above, and blocks 664, 672, 678, 686 and 692 described below). The item representations 718a-718c may correspond to at least one of the item representations stored in the representation database 124 directed to by the URIs in the item representation path fields 177 of the item entries 171 classified within the second set by various blocks of the recommend items codes 650 (including block 660 described above, and blocks 666, 674, 680, 688 and 694 described below). The displayed order of the item representations 716a-716c in the first set region 712 and the displayed order of the item representations 718a-718c in the second set region 714 may correspond to the order of the first and second set items as determined by various blocks of the recommend items codes 650 (including block 661 described above, and blocks 667, 676, 682, 690 and 696 described below). As noted above, in the embodiment shown in FIG. 28, the recommend items page 700 is displayed after block 660 (shown in FIG. 27A) and thus, item representations 716a-716c displayed in the first set region 712 represent the item entries 171 classified within the first set by block 658 and are displayed in the order determined by block 661 and item representations 718a-718c displayed in the second set region 714 represent the item entries 171 classified within the second set by block 660 and are displayed in the order determined by block 661.

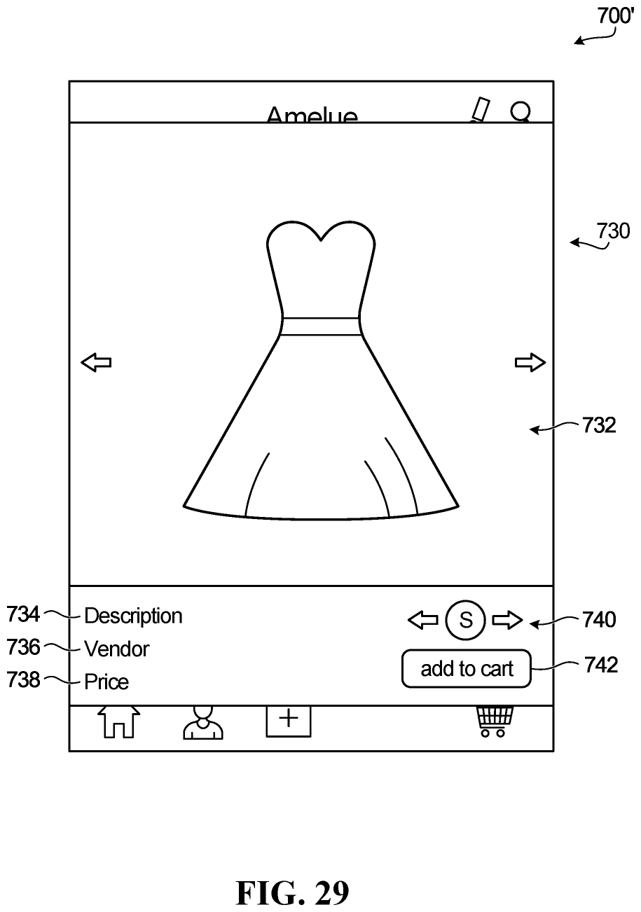

Each of the item representations 716a-716c and 718a-718c may be selectable to view additional information associated with the item represented by the item representation. For example, when a user selects any item representation 716a-716c, 718a-718c, the user interface codes 330 may direct the user device 114 to display a modified recommend items page shown generally at 700′ in FIG. 29. Referring to FIG. 29, the modified recommend items page 700′ includes an item detail region 730 which displays information associated with the selected item, which may allow the user to determine whether the user wishes to purchase the selected item. In the embodiment shown, the item detail region 730 display information from the item entry 171 (shown in FIG. 7) representing the selected item, including item representations 732, which may correspond to the representations stored in the representation database 124 (shown in FIG. 1) directed to by a URI in the item representation path fields 177 of the item entry 171 representing the selected item. In embodiments where there is more than one item representation stored in the representation database 124, the item detail region 730 may allow a user to scroll or click through the different item representations 732. The item detail region 730 also displays: an item description 734 which may display the text stored in at least one of the description field 176 or the vendor description field 178 of the item entry 171 representing the selected item; a vendor description 736 which may correspond to the vendor entry 231 (shown in FIG. 8) identified in the vendor identifier field 173 of the item entry 171 representing the selected item (identifying the vendor offering the selected item); and a price 738 which may display the price stored in the price field 179 of the item entry 171 representing the selected item. The item detail region 730 may also include an option selector 740 and an add-to-cart button 742. The option selector 740 may allow the user to select different options associated with the item as stored in the options field 180 of the item entry 171 representing the selected item. When the user selects the add-to-cart button 742, the user interface codes 330 may direct the microprocessor 102 to add the item displayed on the modified recommend items page 700′ to a shopping cart for later purchase, and to cause the shopping cart page 780 (shown in FIG. 35) to display a item representation representing the selected item when the user navigates to the shopping cart page 780.

Referring back to FIG. 28, as described above and below in connection with determining items complementary with other items or with the text query (see block 660 described above, and blocks 674 and 688 described below, for example) and determining the order of items in the first and second sets (see block 661 described above, and blocks 667, 676, 682, 690 and 696 described below, for example), each time the user interacts with an item representation 716a-716c, 718a-718c by selecting that item representation, the user interface codes 330 may direct the microprocessor 102 to add a new instance of the interaction history entry 251 (shown in FIG. 10) to the interaction history table 250 (shown in FIG. 2). The new instance of the interaction history entry 251 may function as a record indicating that a particular user interacted with a particular item after being directed to that item from a particular image (or palette). The interaction history entry 251 may also function as a record indicating that (a) a particular user interacted with a particular item after being directed to that item from a selected visual attribute and/or from an entered text query, and (b) a particular user interacted with a particular item classified within either the first set or the second set based on a selected visual attribute and/or an entered text query.

The new instance of the interaction history entry 251 stores a identifier identifying the user entry 131 (shown in FIG. 3) representing the user who selected the item (such as the user who logged on using the login page 350 (shown in FIG. 13) for example) in the user identifier field 253. The new instance of the interaction history entry 251 also stores: an identifier identifying the image entry 141 (shown in FIG. 6) representing the image that the user initially selected to shop from (image 634 (shown in FIG. 25) for example) or an identifier identifying the palette entry 191 (shown in FIG. 5) representing a customized palette that the user initially selected to shop from (a “rust” palette selected from the palette selection page 750 (shown in FIG. 34) for example) in the image identifier field 255; an identifier identifying the item entry 171 (shown in FIG. 7) representing the item that the user interacted with (item represented by the item representation 716a-716c, 718a-718c selected by the user (shown on FIG. 28) for example) in the item identifier field 254; and an indication of whether the item identified in the item identifier field 254 was classified within the first set or second set by the recommend items codes 650 (shown in FIG. 27) in the item set field 258. The new instance of the interaction history entry 251 may also store, in the created field 259 and the modified field 260, a time obtained from the clock 104 (shown in FIG. 1) corresponding to the time the new instance of the interaction history entry 251 was created or modified.

In embodiments where the user single selects or double selects a visual attribute (block 654 of the recommend items codes 650), using either the visual attribute representations 636a-636f (shown in FIG. 25) or 708a-708f (shown in FIG. 28) for example, the new instance of the interaction history entry 251 may further store identifier(s) identifying the visual attribute entry (entries) 161 (shown in FIG. 6) representing the selected visual attribute(s) in the visual attribute identifier field 256. Further, in embodiments where the user enters a text query (blocks 656, 670 and 684 of the recommend items codes 650), using either the query fields 638 (shown in FIG. 25) or 710 (shown in FIG. 28) for example, the new instance of the interaction history entry 251 may further store an identifier identifying the taxonomy entry 221 (shown in FIG. 9) matching or corresponding to the entered text query. The microprocessor 102 may determine taxonomy entries 221 matching or corresponding to the entered text query in a manner similar to block 658 described above.

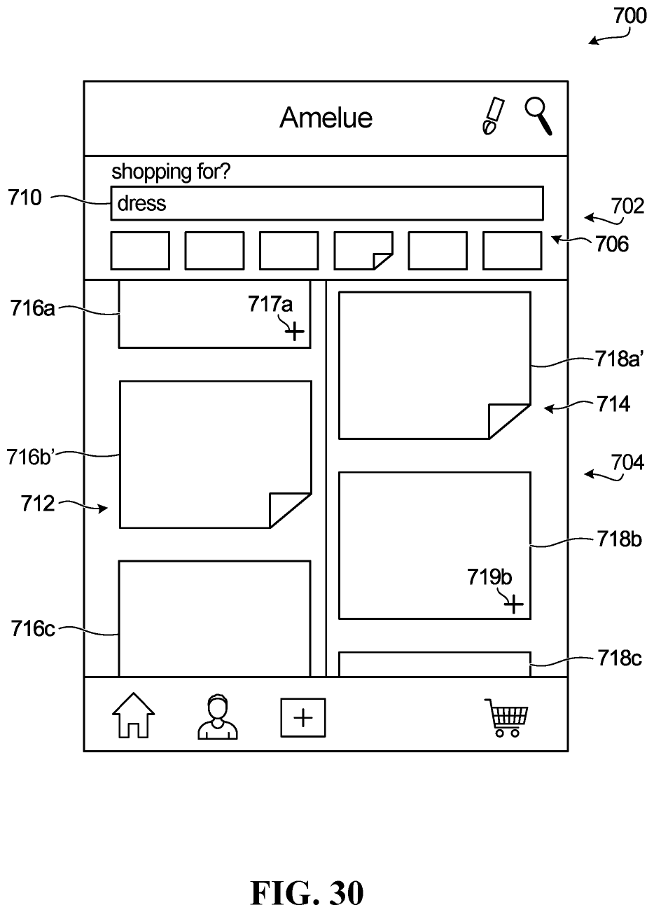

Still referring to FIG. 28, the item representations 716a-716c each include a respective add-to-cart button 717a and 717b and the item representations 718a-718c also each include a respective add-to-cart button 719a and 719b. When the user selects one or more of the add-to-cart buttons 717a, 717b, 719a, 719b, the user interface codes 330 may direct the microprocessor 102 to add the item represented by the item representation 716a-716bb, 718a-718b associated with the selected add-to-cart buttons 717a, 717b, 719a, 719b to the shopping cart for later purchase, and to cause the shopping cart page 780 (shown in FIG. 35) to display a item representation representing the selected items when the user navigates to the shopping cart page 780. Further, when the user selects an add-to-cart button 717a, 717b, 719a, 719b associated with an item representation 716a-716c, 718a-718c, the user interface codes 330 may direct the user device 114 to display a modified item representation as shown in FIG. 30. For example, when the user selects the add-to-cart button 717b associated with item representation 716b displayed in the first set region 712 and the add-to-cart button 719a associated with item representation 718b displayed in the second set region 714, user interface codes 330 may display the item representations 716b and 718a as modified item representations 716b′ and 718a′. The modified item representations 716b′ and 718a′ may be displayed with a folded bottom-right corner. In other embodiments, the item representations may be modified in a different or alternative manner, such that the entire bottom half may be folded, different corners (such as the top-left, top-right or bottom-left corners) may be folded, or the item representation may be colored in a specific or a random color. If the user re-selects a selected and a modified item representation 716a′, 718a′, the user interface codes 330 may direct the user device 114 to re-display the modified item representation 716a′, 718a′ as the unmodified item representation 716a, 718a (shown in FIG. 28) and may further direct the microprocessor 102 to remove the item represented by the item representation 716a, 718a from the shopping cart such that the user device 114 does not display an item representation representing the selected items on the shopping cart page 780 (shown in FIG. 35).

As described above and below in connection with determining items complementary with other items or with the text query (see block 660 described above, and blocks 674 and 688 described below, for example) and determining the order of items within the first and second sets (see block 661 described above, and blocks 667, 676, 682, 690 and 696 described below, for example), each time the user selects an add-to-cart button 717 associated with an item representation 716 representing a first set item and displayed in the first set region 712 and an add-to-cart button 719 associated with an item representation 718 representing a second set item and displayed in the second set region 714, the user interface codes 330 may direct the microprocessor 102 to add a new instance of the combination history entry 291 (shown in FIG. 11) to the combination history table 290 (shown in FIG. 2). The new instance of the combination history entry 291 may function as a record indicating that a particular user decided to combine at least one first set item with at least one second set item after being directed to those items from a particular image. The combination history entry 291 may also function as a record indicating that a particular user combined at least one first set item and at least one second set item after being directed to these items from a selected visual attribute and/or from an entered text query.

The new instance of the combination history entry 291 stores an identifier identifying the user entry 131 (shown in FIG. 3) representing the user whom combined the items (such as the user who logged on using the login page 350 (shown in FIG. 13) for example) in the user identifier field 293. The new instance of the combination history entry 291 also stores: identifier(s) identifying item entry (entries) 171 (shown in FIG. 7) representing the first set item(s) (represented by the item representations 716a-716c in the first set region 712 (shown on FIG. 28) for example) if the current user selected at least one first set item, in the first set item identifier field 294; and identifier(s) identifying the item entry (entries) 171 representing the second set item (represented by the item representations 718a-718c in the second set region 714 (shown on FIG. 28) for example) if the current user selected at least one second set item, in the second set item identifier field 295. In embodiments where the current user does not select any first set item or any second set item, such as if the current user only combines items within the first set or within the second set, one of the first set item identifier field 294 and the second set item identifier field 295 may not store any identifiers and the other one may store more than one identifier. In embodiments where the current user selects more than one first set item or more than one second set item, the first set item identifier field 294 and the second set item identifier field 295 may store identifiers identifying more than one item. In other embodiments, the first set item identifier field 294 and the second set item identifier field 295 may each store only a single identifier identifying a single item, and a new instance of the combination history entry 291 may be added each time a user combines a first set item with a second set item. For example, if the user selects the add-to-cart button 717a of the first set item representation 716a and the add-to-cart buttons 719b and 719a of the second set item representations 718b and 718a, two instances of the combination history entry 291 may be added to the combination history table 290: (1) a first instance identifying the item entry 171 represented by the first set item representation 716a in the first set item identifier field 294 and identifying the item entry 171 represented by the second item representation 718b in the second set item identifier field 295, and (2) a second instance identifying the item entry 171 represented by the first set item representation 716a in the first set item identifier field 294 and identifying the item entry 171 represented by the second set item representation 718a in the second set item identifier field 295. The new instance of the combination history entry 291 may also store: an identifier identifying the image entry 141 (shown in FIG. 6) representing the image that the user initially selected to shop from (image 634 (shown in FIG. 25) for example) or an identifier identifying the palette entry 191 (shown in FIG. 5) representing a customized palette that the user initially selected to shop from (the “rust” palette selected from the palette selection page 750 (shown in FIG. 34) for example) in the image identifier field 296; and a time obtained from the clock 104 (shown in FIG. 1) corresponding to the time the instance of the combination history entry 291 was created and modified in the created field 299 and the modified field 300.

In embodiments where the user single selects or double selects a visual attribute (block 654 of the recommend items codes 650), using either the visual attribute representations 636a-636f (shown in FIG. 25) or 708a-708f (shown in FIG. 28) for example, the new instance of the combination history entry 291 may further store an identifier identifying the visual attribute entry 161 (shown in FIG. 6) representing the selected visual attribute in the visual attribute identifier field 297. Further, in embodiments where the user enters a text query (blocks 656, 670 and 684 of the recommend items codes 650), using either the query fields 638 (shown in FIG. 25) or 710 (shown in FIG. 28) for example, the new instance of the combination history entry 291 may further store an identifier identifying the taxonomy entry 221 (shown in FIG. 9) matching or corresponding to the entered text query. The microprocessor 102 may determine taxonomy entries 221 matching or corresponding to the entered text query in a manner similar to block 658 described above.

Referring back to FIGS. 27A and 27B, if the microprocessor 102 determines at block 656 that the user did not enter a text query—such that the user (a) provided a single selection of a visual attribute but (b) did not enter a text query—the recommend items codes 650 then continue at block 664 shown in FIG. 27B, which include code for directing the microprocessor 102 to identify those item entries 171 of the item entries 171 initially retrieved at block 652 which (1) are associated with visual attributes which match the single-selected visual attribute. The microprocessor 102 may classify the item entries 171 which meet the criteria (1) above in the first set of items or as first set items. With respect to criteria (1), block 664 may include code similar to block 658 and may thus also direct the microprocessor 102 to identify, from the item entries 171 initially retrieved at block 652, those item entries 171 associated with visual attribute entries 161 that match only the double-selected visual attribute. Block 664 may determine whether two visual attributes match in a manner similar to block 652 described above.

The recommend items codes 650 then continue at block 666, which include code for directing the microprocessor 102 to identify those item entries 171 of the item entries 171 initially retrieved at block 652 which (1) are associated with a visual attribute matching any visual attribute of the image the user initially selected to shop from that is not the single-selected visual attribute, and (2) are not in the first set. The microprocessor 102 may then classify the item entries 171 which meet the criteria (1) and (2) above within the second set of items or as second set items. In such embodiments, the first set items include items associated with the single-selected visual attribute, whereas the second set items include items associated with visual attributes of the image (or palette) other than the single-selected visual attribute. With respect to criteria (1) and (2) above, block 666 may include code for directing the microprocessor 102 to (a) identify, from the item entries 171 initially retrieved at block 652, those item entries 171 associated with visual attributes entries 161 that match any visual attribute of the image (or palette) other than single-selected visual attribute, and (b) exclude from the item entries 171 identified at (a), those item entries 171 which were classified within the first set at block 664. Block 666 may determine whether two visual attributes match in a manner similar to block 652 described above.

The recommend items codes 650 the continue to block 667, which include code for directing the microprocessor 102 to order the items classified within the first set at block 664 and to order the items classified within the second set at block 666, such as in a manner similar to block 661 described above for example. Block 667 may thus also direct the microprocessor 102 to order the items classified within each set utilizing the curated ranking, the model-based ranking or a combination thereof.

In embodiments where block 667 directs the microprocessor 102 to order items utilizing the curated ranking, the ranking of different item entries 171 may be explicitly programmed in the application database 122 (shown in FIG. 2) in a manner similar to block 661 described above.

Block 667 may thus order items classified within the first set based, at least in part, on how closely the visual attribute associated with the first set item matches the single-selected visual attribute. Block 667 may thus also order items classified within the second set based, at least in part, on: (a) explicitly programmed levels of complementarity associated with the first set items and the second set items; (b) explicitly programmed levels of complementarity of the item category (taxonomy) associated with the second set items with the item category (taxonomy) associated with the first set items; (c) how closely the visual attributes associated with the second set item matches any visual attribute of the image (or palette) that is not the single-selected visual attribute; and/or (d) how many visual attributes of the image (or palette) that is not the single-selected visual attribute match the visual attributes associated with the second set item. Block 667 may retrieve explicitly programmed levels of complementarity in a manner similar to block 661 described above and may determine whether (and how closely) two visual attributes match in a manner similar to block 652 described above.

In embodiments where block 667 directs the microprocessor 102 to order items utilizing the model-based ranking, the ranking of different item entries 171 may be determined using the ranking model in a manner similar to block 661 described above. Block 667 may thus also utilize the ranking model to processes historical entries stored in the application database 122 (shown in FIG. 2), such as interaction history entries 251 (shown in FIG. 10) in the interaction history table 250, combination history entries 291 (shown in FIG. 11) in the combination history table 290, and purchase history entries 271 (shown in FIG. 12) in the purchase history table 270 for example, to determine order of items within both the first and second sets.

The recommend items codes 650 then return to block 662, which include code for directing the microprocessor 102 to display the first set of items and the second set of items simultaneously and proximate each other, via the recommend items page 700 (shown in FIGS. 28 and 30) for example. In embodiments where the recommend items page 700 is displayed after block 667 (shown in FIG. 27B), the modify query region 702 may: (a) display the single selection of the selected visual attribute (single selection determined at block 654) by automatically displaying the visual attribute representation 708d corresponding to the single-selected visual attribute as a modified visual attribute representation 708d′ in a manner similar to FIG. 26A described above; and (b) not display any entered text query (no text query entered as determined at block 656) in the query field 710. Further, the item display region 704 may: (a) display item representations 716a-716c representing the item entries 171 classified within the first set by block 664 in the first set region 712 in the order determined by block 667; and (b) display item representations 718a-718c representing the item entries 171 classified within the second set by block 666 in the second set region 714 in the order determined by block 667. The recommend items codes 650 then continue from block 662 as described above and below.

Referring back to FIGS. 27A and 27B, if the microprocessor 102 determines at block 654 that the user provided a double selection of one of the visual attributes, using either the visual attribute representations 636a-636f (shown in FIG. 25) or 708a-708f (shown in FIG. 28) for example, the recommend items codes 650 then continue at block 670 (shown in FIG. 27B), which includes code for directing the microprocessor 102 to determine whether the user entered any text query, using either the query fields 638 (shown in FIG. 25) or 710 (shown in FIGS. 28 and 30).

If the microprocessor 102 determines at block 670 that the user entered a text query—such that the user both (a) provided a double selection of a visual attribute and (b) entered a text query—the recommend items codes 650 then continue at block 672, which include code for directing the microprocessor 102 to identify those item entries 171 of the item entries 171 initially retrieved at block 652 which (1) are associated with a visual attribute which match the double-selected visual attribute and (2) match or correspond to the text query. The microprocessor 102 may classify the item entries 171 which meet the criteria (1) and (2) above in the first set or as first set items.

With respect to criteria (1), block 672 may include code for directing the microprocessor 102 to identify, from the item entries 171 initially retrieved at block 652, those item entries 171 associated with visual attribute entries 161 that match only the visual attribute entry 161 representing the double-selected visual attribute. Block 672 may determine whether two visual attributes match in a manner similar to block 652 described above. With respect to criteria (2), block 672 may determine whether an item matches or corresponds to a text query in a manner similar to block 658 described above. Block 672 may thus also direct the microprocessor 102 to identify, from the item entries 171 initially retrieved at block 652, item entries 171 which: (a) store a text string or other descriptive matter in the description field 176 or the vendor description field 178 which matches or corresponds to the text query; and/or (b) identify at least one taxonomy entry 221 in the item taxonomy identifier field 174 which matches or corresponds to the text query.

The recommend items codes 650 then continue at block 674, which include code for directing the microprocessor 102 to identify those item entries 171 of the item entries 171 initially retrieved at block 652 which (1) are associated with a visual attribute which match the double-selected visual attribute, (2) are complementary to a first set item classified at block 672 and/or the text query determined to be entered at block 670, and (3) are not in the first set. The microprocessor 102 may classify the item entries 171 which meet the criteria (1), (2) and (3) above within the second set or as second set items. In such embodiments, the first set items include items associated with the double-selected visual attribute and matching the text query, whereas the second set items include items also associated with the double-selected visual attribute but which is complementary to the first set items and/or the text query. With respect to criteria (1) and (3) above, block 674 may include code for directing the microprocessor 102 to (a) identify, of the item entries 171 initially retrieved at block 652, those item entries 171 associated with visual attribute entries 161 that match the double-selected visual attribute, and (b) exclude, from the item entries 171 identified at (a), those item entries 171 already classified within the first set at block 672. Block 674 may determine whether two visual attributes match in a manner similar to block 652 described above. With respect to criteria (2) above, block 674 may determine whether an item is complementary to at least one first set item and/or complementary to the text query in a manner similar to block 660 described above. For example, block 674 may also direct the microprocessor 102 to determine complementary second set items utilizing the curated determination or the model-based determination, or a combination thereof.

In embodiments where block 674 directs the microprocessor 102 to identify complementary items utilizing the curated determination, the complementarity of different item entries 171 may be explicitly programmed in the application database 122 (shown in FIG. 2) in a manner similar to block 660 described above. Block 674 may thus direct the microprocessor 102 to identify complementary second set items based at least in part on: (a) complementary items explicitly associated with the first set items and/or (b) items which explicitly identify first set items as complementary items. Block 674 may also direct the microprocessor 102 to identify complementary second set items by identifying items associated with item categories (taxonomies) which are complementary to the item categories associated with the first set items or complementary to the item categories matching or corresponding to the entered text entry.

In embodiments where block 674 directs the microprocessor 102 to identify complementary items utilizing the model-based determination, the complementarity of different item entries 171 may be determined using the complementarity model in a manner similar to block 660 described above. Block 674 may thus also utilize the complementarity model to process historical entries stored in the application database 122 (shown in FIG. 2), such as the interaction history entries 251 (shown in FIG. 10) in the interaction history table 250, combination history entries 291 (shown in FIG. 11) in the combination history table 290, and purchase history entries 271 (shown in FIG. 12) in the purchase history table 270 for example, to determine complementary items or complementary item categories.

The recommend items codes 650 the continue to block 676, which include code for directing the microprocessor 102 to order the items classified within the first set at block 672 and to order the items classified within the second set at block 674, such as in a manner similar to block 661 described above for example. Block 676 may thus also direct the microprocessor 102 to order the items classified within each set utilizing the curated ranking, the model-based ranking or a combination thereof.

In embodiments where block 676 directs the microprocessor 102 to order items utilizing the curated ranking, the ranking of different item entries 171 may be explicitly programmed in the application database 122 (shown in FIG. 2) in a manner similar to block 661 described above. Block 676 may thus order items classified within the first set based, at least in part, on: (a) how closely the visual attribute associated with the first set item matches the double-selected visual attribute, and/or (b) on how closely first set item matches or corresponds to the entered text query. Block 676 may thus also order items classified within the second set based, at least in part, on: (a) explicitly programmed levels of complementarity associated with the first set items and the second set items; (b) explicitly programmed levels of complementarity of the item category (taxonomy) associated with the second set items with the item category (taxonomy) associated with the first set items or the item category (taxonomy) matching or corresponding to the entered text query; and/or (c) how closely the visual attributes associated with the second set item matches the double-selected visual attribute. Block 676 may retrieve explicitly programmed levels of complementarity and how closely an item matches or corresponds to the entered text query in a manner similar to block 661 described above and may determine whether (and how closely) two visual attributes match in a manner similar to block 652 described above.

In embodiments where block 676 directs the microprocessor 102 to order items utilizing the model-based ranking, the ranking of different item entries 171 may be determined based on the ranking model in a manner similar to block 661 described above. Block 676 may thus also utilize the ranking model to processes historical entries stored in the application database 122 (shown in FIG. 2), such as interaction history entries 251 (shown in FIG. 10), combination history entries 291 (shown in FIG. 11), and purchase history entries 271 (shown in FIG. 12) for example, to determine order of items within the first and second sets.

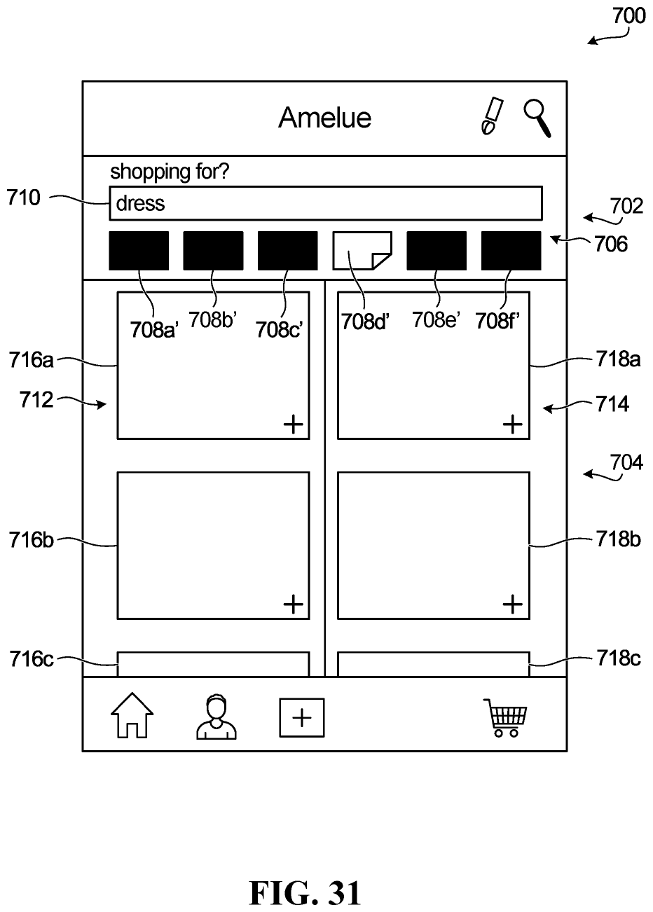

The recommend items codes 650 then return to block 662, which include code for directing the microprocessor 102 to display the first set of items and the second set of items simultaneously and proximate each other, via the recommend items page 700 (embodiments shown in FIGS. 28 and 31) for example. Referring now to FIG. 31, in the embodiment shown, the recommend items page 700 is displayed after block 676 (shown in FIG. 27B). The modify query region 702 displays the double selection of the double-selected visual attribute (double selection determined at block 654) by displaying the visual attribute representation 708d representing the double-selected visual attribute as a modified selected visual attribute representation 708d′ and the visual attribute representations 708a-708c, 708e and 708f representing the non-selected visual attributes as modified non-selected visual attribute representations 708a′-708c′, 708e′ and 708f′, in a manner similar to FIG. 26B described above. The modify query region 702 also displays the entered text query (text query entered as determined at block 670) by automatically pre-populating the entered text query (text query entered as determined at block 670) in the query field 710. Further, the item display region 704 may: (a) display item representations 716a-716c representing the item entries 171 classified within the first set at block 672 in the first set region 712 in the order determined by block 676; and (b) display item representations 718a-718c representing the item entries 171 classified within the second set by block 674 in the second set region 714 in the order determined by block 667. The recommend items codes 650 then continue from block 662 as described above.

Referring back to FIG. 27B, if the microprocessor 102 determines at block 670 that the user did not enter a text query—such that the user (a) provided a double selection of a visual attribute but (b) did not enter a text query—the recommend items codes 650 then continue at block 678, which include code for directing the microprocessor 102 to identify those item entries 171 of the item entries 171 initially retrieved at block 652 which (1) are associated with visual attributes which match the double-selected visual attribute. The microprocessor 102 may classify the item entries 171 which meet the criteria (1) above in a first set of items or as first set items. With respect to criteria (1), block 678 may include code similar to block 658 and may thus also direct the microprocessor 102 to identify, from the item entries 171 initially retrieved at block 652, those item entries 171 associated with visual attribute entries 161 which match only the double-selected visual attribute. Block 678 may determine whether two visual attributes match in a manner similar to block 652 described above. Block 678 may also include code for directing the microprocessor 102 to retrieve only a subset of the items associated with visual attributes which match the double-selected visual attribute. For example, block 678 may direct the microprocessor 102 to retrieve only item entries 171 which are also identified in a number of historical entries stored in the application database 122 (such as interaction history entries 251, combination history entries 291 and purchase history entries 271 for example) above a certain threshold, indicating that such items are popularly interacted with, combined by, or purchased by users for example, or to retrieve only item entries 171 associated with visual attributes which very closely match the double-selected visual attribute.

The recommend items codes 650 then continue at block 680, which include code for directing the microprocessor 102 to identify those item entries 171 of the item entries 171 initially retrieved at block 652 which (1) are associated with a visual attribute matching the double-selected visual attribute but (2) are not in the first set. The microprocessor 102 may then classify the item entries 171 which meet the criteria (1) and (2) above within the second set of items or as second set items. In such embodiments, the first set and second set both include items associated with the double-selected visual attribute, but the second set does not include any of the items included in the first set. With respect to criteria (1) and (2) above, block 680 may include code for directing the microprocessor 102 to: (a) identify, from the item entries 171 initially retrieved at block 652, those item entries 171 associated with visual attributes entries 161 that match only the double-selected visual attribute, and (b) exclude from the item entries 171 identified at (a), those item entries 171 which were classified within the first set at block 678. Block 680 may determine whether two visual attributes match in a manner similar to block 652 described above.

The recommend items codes 650 the continue to block 682, which include code for directing the microprocessor 102 to order the items classified within the first set at block 678 and to order the items classified within the second set at block 680, such as in a manner similar to block 661 described above for example. Block 682 may thus also direct the microprocessor 102 to order the items classified within each set utilizing the curated ranking, the model-based ranking or a combination thereof.

In embodiments where block 682 directs the microprocessor 102 to order items utilizing the curated ranking, the ranking of different item entries 171 may be explicitly programmed in the application database 122 (shown in FIG. 2) in a manner similar to block 661 described above. Block 682 may thus order items classified within the first set based, at least in part, on how closely the visual attribute associated with the first set item matches the double-selected visual attribute. Block 682 may also order items classified within the second set based, at least in part, on: (a) explicitly programmed levels of complementarity associated with the first set items and the second set items; (b) explicitly programmed levels of complementary of the item category (taxonomy) associated with the second set items with the item category (taxonomy) associated with the first set items; and/or (c) how closely the visual attributes associated with the second set item match the selected visual attribute. Block 682 may retrieve explicitly programmed levels of complementarity in a manner similar to block 661 described above and may determine whether (and how closely) two visual attributes match in a manner similar to block 652 described above.

In embodiments where block 682 directs the microprocessor 102 to order items utilizing the model-based ranking, the ranking of different item entries 171 may be determined using the ranking model in a manner similar to block 661 described above. Block 682 may thus also utilize the ranking model to processes historical entries stored in the application database 122 (shown in FIG. 2), such as interaction history entries 251 (shown in FIG. 10), combination history entries 291 (shown in FIG. 11), and purchase history entries 271 (shown in FIG. 12) for example, to determine order of items within both the first and second sets.

The recommend items codes 650 then return to block 662, which include code for directing the microprocessor 102 to display the first set of items and the second set of items simultaneously and proximate each other, such as via the recommend items page 700 for example. In embodiments where the recommend items page 700 is displayed after block 682 (shown in FIG. 27B), the modify query region 702 may: (a) display the double selection of the selected visual attribute (double selection determined at block 654) by displaying the visual attribute representation 708d corresponding to the double-selected visual attribute as the modified selected visual attribute representation 708d′ and the visual attribute representations 708a-708c, 708e and 708f corresponding to the non-selected visual attributes as modified non-selected visual attribute representations 708a′-708c′, 708e′ and 708f′ in a manner similar to FIG. 26B described above; and (b) not display any entered text query (no text query entered as determined at block 670) in the query field 710. Further, the item display region 704 may: (a) display item representations 716a-716c representing the item entries 171 classified within the first set at block 678 in the first set region 712 in the order determined by block 682; and (b) display item representations 718a-718c representing the item entries 171 classified within the second set by block 680 in the second set region 714 in the order determined by block 682. The recommend items codes 650 then continue from block 662 as described above and below.

Referring to FIGS. 27A and 27C, if the microprocessor 102 determines at block 654 that the user provided no selection of one of the visual attributes, using either the visual attribute representations 636a-636f (shown in FIG. 25) or 708a-708f (shown in FIGS. 28 and 31) for example, the recommend items codes 650 then continue at block 684 (shown in FIG. 27C), which include code for directing the microprocessor 102 to determine whether the user entered any text query, using either the query fields 638 (shown in FIG. 25) or 710 (shown in FIGS. 28, 30 and 31) for example.

If the microprocessor 102 determines at block 684 that the user entered a text query—such that the user (a) provided no selection of a visual attribute, but (b) did enter a text query—the recommend items codes 650 then continue at block 686, which include code for directing the microprocessor 102 to identify those item entries 171 of the item entries 171 initially retrieved at block 652 which (1) are associated with visual attributes which match any visual attribute of the image (or palette) user initially selected to shop from and (2) match or correspond to the text query. The microprocessor 102 may classify the item entries 171 which meet the criteria (1) and (2) above in the first set or as first set items. With respect to criteria (1) above, block 686 may include code for directing the microprocessor 102 to identify each of the item entries 171 initially retrieved at block 652. With respect to criteria (2) above, block 686 may determine whether an item matches or corresponds to a text query in a manner similar to block 658 described above. Block 686 may thus also direct the microprocessor 102 to identify, from the item entries 171 initially retrieved at block 652, item entries 171 which: (a) store a text string or other descriptive matter in the description field 176 or the vendor description field 178 which matches or corresponds to the text query; and/or (b) identify at least one taxonomy entry 221 in the item taxonomy identifier field 174 which matches or corresponds to the text query.

The recommend items codes 650 then continue at block 688, which include code for directing the microprocessor 102 to identify those item entries 171 of the item entries 171 initially retrieved at block 652 which (1) are associated with visual attributes which match any visual attribute of the image (or palette) the user initially selected to shop from, (2) are complementary to a first set item classified at block 688 and/or the text query entered at block 684, and (3) are not in the first set. The microprocessor 102 may classify the item entries 171 which meet the criteria (1), (2) and (3) above within the second set or as second set items. In such embodiments, the first set items include items associated with any visual attribute of the image (or palette) and matching the entered text query, whereas the second set items include items also associated with any visual attribute of the image (or palette) but which is complementary to the first set items and/or the text query. With respect to criteria (1) and (3) above, block 688 may include code for directing the microprocessor 102 to (a) identify each of the item entries 171 initially retrieved at block 652, and (b) exclude, from the item entries 171 identified at (a), those item entries 171 classified within the first set at block 688. With respect to criteria (2) above, block 688 may determine whether an item is complementary to at least one first set item and/or complementary to the text query in a manner similar to block 660 described above. For example, block 688 may also direct the microprocessor 102 to determine complementary second set items utilizing the curated determination, the model-based determination, or a combination thereof.

In embodiments where block 688 directs the microprocessor 102 to identify complementary items utilizing the curated determination, the complementarity of different item entries 171 may be explicitly programmed in the application database 122 (shown in FIG. 2) in a manner similar to block 660 described above. Block 688 may thus direct the microprocessor 102 to identify complementary second set items by at least in part on: (a) complementary items explicitly associated with the first set items and/or (b) items which explicitly identify first set items as complementary items. Block 688 may also direct the microprocessor 102 to identify complementary second set items by identifying items associated with item categories (taxonomies) which are identified as complementary to the item categories (taxonomies) associated with the first set items or complementary to the item categories matching or corresponding to the entered text entry.

In embodiments where block 688 direct the microprocessor 102 to identify complementary items utilizing the model-based determination, the complementarity of different item entries 171 may be determined based on the complementarity model in a manner similar to that described above in connection with block 660, wherein the complementarity model processes historical entries stored in the application database 122 (shown in FIG. 2) to determine complementary items or complementary item categories. The historical entries may be entries stored in the interaction history table 250, the combination history table 290, and the purchase history table 270 for example.

The recommend items codes 650 the continue to block 690, which include code for directing the microprocessor 102 to order the items classified within the first set at block 686 and to order the items classified within the second set at block 688 in a manner similar to block 661 described above for example. Block 690 may thus also direct the microprocessor 102 to order the items classified within each item set utilizing the curated ranking, the model-based ranking or a combination of the curated ranking and the model-based ranking.

In embodiments where block 690 directs the microprocessor 102 to order items utilizing the curated ranking, the ranking of different item entries 171 may be explicitly programmed in the application database 122 (shown in FIG. 2) in a manner similar to block 661 described above. Block 690 may thus order items classified within the first set based, at least in part, on: (a) how closely the visual attributes associated with the first set item matches any of the visual attributes of the image (or palette); (b) how many of the visual attributes of the image (or palette) the visual attributes associated with the first set item matches; and/or (c) how closely the first set item matches or corresponds to the item category (taxonomy) matching or corresponding to the entered text query. Block 690 also may order items classified within the second set based, at least in part, on: (a) explicitly programmed levels of complementarity associated with the first set items and the second set items; (b) explicitly programmed levels of complementarity of the item category (taxonomy) associated with the second set items with the item category (taxonomy) associated with the first set items or the item category (taxonomy) matching or corresponding to the entered text query; (c) how closely the visual attributes associated with the second set item matches any of the visual attributes of the image (or palette); and/or (d) how many of the visual attributes of the image (or palette) the visual attributes associated with the second set item matches. Block 690 may determine how closely two visual attributes match in a manner similar to block 652 described above. Block 690 may determine how closely an item matches or corresponds to the entered text query in a manner similar to that described above in connection with blocks 658.

In embodiments where block 690 directs the microprocessor 102 to order items utilizing the model-based ranking, the ranking of different item entries 171 may be determined based on the ranking model in a manner similar to block 661 described above. Block 690 may thus also utilize the ranking model to processes historical entries stored in the application database 122 (shown in FIG. 2), such as interaction history entries 251 (shown in FIG. 10), combination history entries 291 (shown in FIG. 11), and purchase history entries 271 (shown in FIG. 12) for example, to determine order of items within the first and second sets.

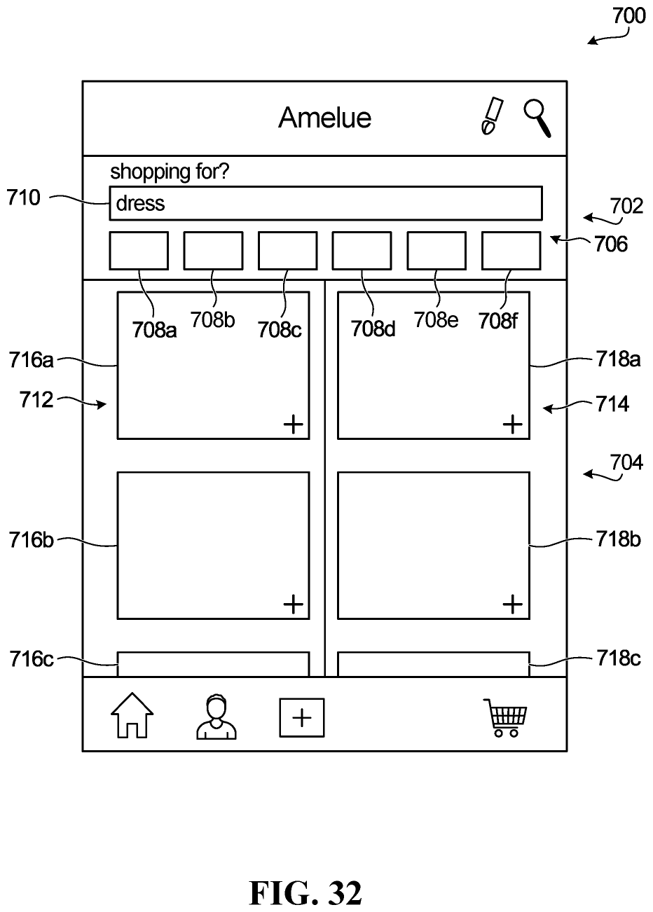

The recommend items codes 650 then return to block 662, which include code for directing the microprocessor 102 to display the first set of items and the second set of items simultaneously and proximate each other on the user device 114, such as via the recommend items page 700, (embodiments shown in FIGS. 28, 31 and 32). Referring now to FIG. 32, in the embodiment shown, the recommend items page 700 is displayed after block 690 (shown in FIG. 27C). The modify query region 702 displays the no selection of the selected visual attribute (no selection determined at block 654) by displaying the visual attribute representations 708a-708f in an unmodified state. The modify query region 702 also displays the entered text query (text query entered determined at block 684) by automatically pre-populating the entered text query (text query entered as determined at block 684) in the query field 710. Further, the item display region 704 may: (a) display item representations 716a-716c representing the item entries 171 classified within the first set at block 686 in the first set region 712 in the order determined by block 690, and (b) display item representations 718a-718c representing the item entries 171 classified within the second set by block 688 in the second set region 714 in the order determined by block 690. The recommend items codes 650 then continue from block 662 as described above and below.

Referring back to FIG. 27C, if the microprocessor 102 determines at block 684 that the user did not enter a text query—such that the user (a) provided no selection of any visual attribute and (b) did not enter a text query—the recommend items codes 650 then continue at block 692, which include code for directing the microprocessor 102 to identify those item entries 171 of the item entries 171 initially retrieved at block 652 which (1) are associated with a visual attribute matching any visual attribute of the image (or palette) the user initially selected to shop from. The microprocessor 102 may classify the item entries 171 which meet the criteria (1) above in the first set or as first set items. With respect to criteria (1) above, block 692 may include code for directing the microprocessor 102 to identify each of the item entries 171 initially retrieved at block 652. In certain embodiments, block 692 may further include code for directing the microprocessor 102 to retrieve only a subset of the item entries 171 initially retrieved at block 652. For example, block 678 may direct the microprocessor 102 to retrieve only item entries 171 which are also identified in a number of historical entries stored in the application database 122 (such as interaction history entries 251, combination history entries 291 and purchase history entries 271 for example) above a certain threshold.

The recommend items codes 650 then continue at block 694, which include code for directing the microprocessor 102 to identify those item entries 171 of the item entries 171 initially retrieved at block 652 which (1) are associated with a visual attribute matching any visual attribute of the image (or palette) the user initially selected to shop from but (2) are not in the first set. The microprocessor 102 may then classify the item entries 171 which meet the criteria (1) and (2) above within the second set of items or as second set items. In such embodiments, the first set and second set both include items associated with any visual attribute of the image (or palette), but the second set does not include any of the items included in the first set. With respect to criteria (1) and (2) above, block 694 may include code for directing the microprocessor 102 to (a) identify each of the item entries 171 initially retrieved at block 652, and (b) exclude, from the item entries 171 identified at (a), those item entries 171 classified within the first set at block 692.

The recommend items codes 650 the continue to block 696, which include code for directing the microprocessor 102 to order the items classified within the first set at block 692 and to order the items classified within the second set at block 694, such as in a manner similar to block 661 described above for example. Block 690 may thus also direct the microprocessor 102 to order the items classified within each set utilizing the curated ranking, the model-based ranking or a combination thereof.

In embodiments where block 696 directs the microprocessor 102 to order items utilizing the curated ranking, the ranking of different item entries 171 may be explicitly programmed in the application database 122 (shown in FIG. 2) in a manner similar to block 661 described above. Block 696 thus may order items classified within the first set based, at least in part, on (a) how closely the visual attributes associated with the first set item matches any of the visual attributes of the image (or palette); and/or (b) how many of the visual attributes of the image (or palette) the visual attributes associated with the first set item matches. Block 696 may also order items classified within the second set based, at least in part, on: (a) explicitly programmed levels of complementarity associated with the first set items and the second set items; (b) explicitly programmed levels of complementary of the item category (taxonomy) associated with the second set items with the item category (taxonomy) associated with the first set items; (c) how closely the visual attributes associated with the second set item matches any of the visual attributes of the image (or palette); and/or (d) how many visual attributes of the image (or palette) match the visual attributes associated with the second set item. Block 690 may determine how closely two visual attributes match in a manner similar to block 652 described above. Block 682 may retrieve explicitly programmed levels of complementarity in a manner similar to block 661 described above and may determine whether (and how closely) two visual attributes match in a manner similar to block 652 described above.

In embodiments where block 696 directs the microprocessor 102 to order items utilizing the model-based ranking, the ranking of different item entries 171 may be determined using the ranking model in a manner similar to block 661 described above. Block 696 may thus also utilize the ranking model to processes historical entries stored in the application database 122 (shown in FIG. 2), such as interaction history entries 251 (shown in FIG. 10), combination history entries 291 (shown in FIG. 11), and purchase history entries 271 (shown in FIG. 12) for example, to determine order of items within both the first and second sets.

The recommend items codes 650 then return to block 662, which include code for directing the microprocessor 102 to display the first set of items and the second set of items simultaneously and proximate each other on the user device 114, such as via the recommend items page 700 for example. In embodiments where the recommend items page 700 is displayed after block 696 (shown in FIG. 27C), the modify query region 702 may display: (a) the no selection of any visual attributes (no selection determined at block 654) by displaying the visual attribute representations 708a-708f in an unmodified state, and (b) the no entered text query (no text query entered as determined at block 684) in the query field 710. Further, the item display region 704 may: (a) display item representations 716a-716c representing the item entries 171 classified within the first set at block 692 in the first set region 712 in the order determined by block 696, and (b) display item representations 718a-718c representing the item entries 171 classified within the second set by block 694 in the second set region 714 in the order determined by block 696. The recommend items codes 650 then continue from block 662 as described above.

As briefly described above, in some embodiments (not show), the item recommendation server 100 may enable a user to search for items using visual attributes which are associated with images which do not correspond to images uploaded by users via the process image codes 550 (shown in FIG. 21). For example, a user may select visual attributes from a representation of all possible colors, or from a representation of a plurality of possible colors in a color hue, or from a representation of a plurality of textures and/or patterns. Such representations may be at least one image representation stored in the representation database 124 or may be an image generated by the microprocessor 102 automatically based on the visual attribute entries 161 stored in the visual attribute table 160.

As also briefly described above, in some embodiments, rather than a user searching for items based on an image and the visual attributes associated with the image via the shop image page 630 (shown in FIG. 25), item recommendation server 100 may allow a user to search for items based on a palette, and visual attributes selected from the palette. In some embodiments, the palette may originate from at least one image representation stored in the representation database 124 and the visual attributes of palette may represent visual attribute pre-generated from at least one image representation by a host of the item recommendation server 100.

Referring generally to the header region 362 (labelled in FIG. 14), when the user selects the palette selection button 370, the user interface codes 330 direct the user device to display the palette selection page 750 shown in FIG. 33. The palette selection page 750 allows a user to select a custom palette and generally displays a plurality of custom palettes.

Referring now to FIG. 33, in the embodiment shown, the palette selection page 750 includes a palette selection region 752. The palette selection region 752 may be vertically scrollable and displays a plurality of palette representations 753-757 which may each represent a palette entry 191 (shown in FIG. 5) stored in the palette table 190 (shown in FIG. 2). In certain specific embodiments, the palette representations 753-757 may correspond to palette representations stored in the representation database 124 (shown in FIG. 1) directed to by a URI in the palette representation path fields 196 of the corresponding palette entries 191. Each of the palette representations 753-757 may be selectable, and when the user selects one of the palette representations 754a-754d, the user interface codes 330 may direct the user device 114 to display a custom palette page shown generally at 760 in FIG. 34. In the embodiment shown, the user may select palette representation 756, corresponding to a “rust” custom palette for example.

Referring now to FIG. 34, the custom palette page 760 displays information stored in a selected palette entry 191 and may further allow a user to search for items associated with visual attributes that match visual attributes included in the palette or for images associated with visual attributes that match visual attributes included in the palette. The custom palette region 762 displays a visual attribute array 763 associated with the custom palette, a select all button 765, a deselect all button 766, a query field 767, a shop button 768 and a search button 770.

The visual attribute array 763 includes a plurality of visual attribute representations 764a-764l representing the visual attributes associated with the custom palette selected by the user. More specifically, the user interface codes 330 may display, as the visual attribute representations 764a-764l, the representations stored in the representation database 124 (shown in FIG. 2) directed to by a URI in the visual attribute representation path field 168 of the visual attribute entries 161 (shown in FIG. 6) identified in the visual attribute identifier field 193 of the palette entry 191 representing the user selected palette. In the embodiment shown, the visual attribute array 763 includes ten visual attribute representations 764a-764l, indicating that ten instances of visual attribute entries 161 are identified in the visual attribute identifier field 193 of the palette entry 191 representing the user selected “rust” palette 756 (shown in FIG. 33). In other embodiments, the visual attribute array 763 may include a greater or a fewer number of visual attribute representations.

Each of the visual attribute representations 764a-764l may be selectable, and user selection of one or more of the visual attribute representations 764a-764l may allow the user to create a smaller visual attribute array from the large visual attribute array 763. For example, the user may (1) not select any of the visual attribute representations 764a-764l, wherein every visual attribute of the visual attribute array 763 forms the smaller visual attribute array; (2) select one of the visual attribute representations 764a-764l, wherein only the selected visual attribute forms the smaller visual attribute array; (3) select more than one of the visual attribute representations 764a-764l, wherein the selected visual attribute forms the smaller visual attribute array. The user may select all unselected visual attribute representations 764a-764l of the visual attribute array 763 by selecting the select all button 765 and may de-select all selected visual attribute representations 764a-764l by selecting the deselect all button 766.

Similar to visual attribute representations 636a-636f (shown in FIG. 25) and 708a-708f (shown in FIGS. 28, 31 and 32), when the user selects a particular visual attribute representation 764a-764l, the user interface codes 330 may direct the user device 114 to display a modification of the selected visual attribute representation. For example, referring to FIG. 34, in the embodiment shown, non-selected visual attribute representations 764a-764f and 764j-764k have circular outlines, but the selected visual attribute representations 764g-764i are displayed as modified selected representations 764g′-764i′ having a circular outline with a folded bottom-left corner. In other embodiments, the outlines of the representations may be different, different portions of the outlines of the representations may be folded when the representation is selected, and the selected and non-selected representations may be modified in an alternative or an additional manner.

Similar to the query fields 638 (shown in FIG. 25) and 710 (shown in FIGS. 28 and 30-32), the query field 767 is operable to receive a text query from the user entered via the user device 114. The text query may correspond to one or more macro-item categories or micro-item categories stored in, respectively, the macro-item category field 224 and the micro-item category field 226 of one or more instances of the taxonomy entry 221 (shown in FIG. 9). In certain embodiments, the user may (1) not enter any text query in the query field 767; (2) may enter one text query in the query field 767, or (3) may enter more than one text query in the query field 767. In other embodiments, the user may not enter more than one text query in the query field 767.

When the user selects the shop button 768, the user interface codes 330 may direct the microprocessor 102 to search for items which are associated with visual attributes that match any selected visual attributes of the selected palette and which match or correspond to the entered text query, and the microprocessor 102 may be directed to executed the recommend items codes 650 (shown in FIGS. 27A-27C). For example, the user interface codes 330 may transmit information from the custom palette page 760, including the visual attribute array 763, any selection of the visual attribute representations 764a-764l and any text query entered in the query field 767 by the user, to the recommend items codes 650 in a recommend items request, and the recommend items codes 650 may process the received recommend items request in a manner similar to that described above.

For example, in embodiments where the user does not select any of the visual attribute representations 764a-764l and every visual attribute of the large visual attribute array 763 forms the smaller visual attribute array, the recommend items codes 650 may (1) identify and retrieve, at block 652, a plurality of items associated with a visual attribute which match at least one visual attribute of the large visual attribute array 763, (2) determine at block 654 that the user did not single-select or double-select any of the visual attributes, and (3) continue from block 684 as described above depending on whether the user entered a text query in the query field 767. Additionally or alternatively, in embodiments where the user selected one of the visual attribute representations 764a-764l and only the single visual attribute forms the smaller visual attribute array, the recommend items codes 650 may, (1) identify and retrieve, at block 652, a plurality of items associated with a visual attribute which match the single visual attribute, (2) determine at block 654 that the user did not single-select or double-select the single visual attribute, and (3) continue from block 684 as described above depending on whether the user entered a text query in the query field 767. Additionally or alternatively, in embodiments where the user selected more than one visual attribute representations 764a-764l and the selected visual attributes form the smaller visual attribute array, the recommend items codes 650 may (1) identify and retrieve, at block 652, a plurality of items associated with a visual attribute which match at least one visual attribute of the smaller visual attribute array, (2) determine at block 654 that the user did not single-select or double-select any visual attributes, and (3) continue from block 684 as described above depending on whether the user entered a text query in the query field 767.

When the user selects the search button 770, the user interface codes 330 may direct the microprocessor 102 to search for images which are also associated with any selected visual attributes of the selected palette in a manner similar to that described above in connection with the visual attribute search page 470 (shown in FIG. 17). For example, the user interface codes 330 may direct the microprocessor 102 to: (1) identify and retrieve, a visual attribute entry 161 (shown in FIG. 6) corresponding to each of the selected visual attribute representations 764a-764l; (2) identify and retrieve image entries 141 (shown in FIG. 4) which identify the retrieved visual attribute entry 161 in the visual attribute identifier field 146; and (3) direct the user device 114 to display the visual attribute search page 470 (shown in FIG. 17) to display the retrieved image entries 141 as search results.

Referring generally to the navigation region 366 (labelled in FIG. 14), when the user selects the shopping cart button 406, the user interface codes 330 direct the user device 114 to display the shopping cart page generally at 780 in FIG. 35. The shopping cart page 780 allows a user to view and edit items that the user selected for purchase. In some embodiments, the shopping cart page 780 may more specifically display such items in association with the image (or palette) that the user initially selected to shop from. The user may add certain items to the shopping cart by selecting the add-to-cart buttons 717a, 717b, 719a, 719b (shown in FIG. 28) or 742 (shown in FIG. 29) for example. Such items may be displayed, in the shopping cart page 780, as items of an item collection which is associated with the image or palette that the user initially selected to shop from (such as the image 634 (shown in FIG. 25) or the “rust” custom palette 756 (shown in FIG. 33) for example) and the visual attributes associated with the image or palette (such as the visual attribute array 635 (shown in FIG. 25) associated with the image 634, or the large visual attribute array 763 (shown in FIG. 34) associated with the “rust” custom palette 756). Displaying items as item collections associated with an image or palette and/or the visual attributes associated with the image or palette may encourage the user to buy multiple different items which may be complementary to each other and which each match a visual attribute associated with the image or palette to form a visually appealing combination that is similar to the image or the palette.

Referring now to FIG. 35, in the embodiment shown, the shopping cart page 780 includes a shopping cart region 782. The shopping cart region 782 includes a plurality of item collections 784 and 786, and a buy all button 812. Each item collection 784, 786 is displayed in the shopping cart region 782 as corresponding to a specific image or a specific palette. In the embodiment shown, each item collection 784, 786 includes an image source indicator 788, item indicators 794 and 796, a subtotal indicator 804, an edit collection button 806, and a buy collection button 810.

The image source indicator 788 displays information associated with the image entry 141 (shown in FIG. 4) representing the image that the user initially selected to shop from (image 634 (shown in FIG. 25) for example) or the palette entry 191 (shown in FIG. 5) representing the palette that the user initial selected to shop from (the “rust” custom palette 756 (shown in FIG. 33) for example). In the embodiment shown, the image source indicator 788 includes an image post link 789, a user indicator 790 and a visual attribute array 791. In other embodiments, the image source indicator 788 may display more or less information associated with the image entry 141 representing the initially selected image or the palette entry 191 representing the initially selected palette.

The image post link 789 may allow the user to navigate back to the image or palette that the user initially selected. When the user selects the image post link 789, the user interface codes 330 may direct the user device 114 to display the image page 440 (shown in FIG. 16) displaying information associated with the image that the user initially selected or to display the custom palette page 760 (shown in FIG. 34) displaying information associated with the palette that the user initially selected. The user indicator 790 may display the username of another user that uploaded the image or customized the palette the current user initially selected. For example, in specific embodiments, the user indicator 790 may display the username stored in the username field 137 of a user entry 131 identified in the identifier stored in the user identifier field 144 of the image entry 141 representing the image the user initially selected. The user indicator 790 may also be selectable to allow the user to navigate to the user profile of the other user to view other images uploaded by the other user or other palettes customized by the user.

For example, in specific embodiments, when the user selects the user indicator 790, the user interface codes 330 may direct the user device 114 to display the user profile page 410 (shown in FIG. 15) of the other user. The visual attribute array 791 may include a plurality of visual attribute representations 792a-792f representing visual attributes associated with the image or palette the user initially selected. The visual attribute representations 792a-792f may more specifically correspond to the visual attribute representations stored in the representation database 124 (shown in FIG. 1) directed to by a URI in the visual attribute representation path fields 168 of visual attribute entries 161 (shown in FIG. 6) identified in the visual attribute identifier field 146 of the image entry 141 representing the image or by a URI in the visual attribute representation path fields 168 of visual attribute entries 161 identified in the visual attribute identifier field 193 of the palette entry 191 representing the palette.

The item indicators 794 and 796 display information associated with the item entries 171 (shown in FIG. 7) representing the items placed into the shopping cart by the user, such as by selecting the associated add-to-cart buttons 717a, 717b, 719a, 719b on the recommend items page 700 (shown in FIG. 28) or the add-to-cart button 742 on the modified recommend items page 700′ (shown in FIG. 29). Each item indicator 794, 796 corresponds to an item, and in embodiments where more than one item was placed into the shopping cart by the user, the item collection 784 includes more than one item indicator 794, 796. In the embodiment shown, each item indicator 794, 796 includes an item representation 797, 800, an item name 798, 801 and an item price 799, 802. In other embodiments, the item indicator 794, 796 may display more or less information associated with the item entry 171 representing the item placed into the shopping cart.

The item representation 797, 800 provides a visual representation of the item and may specifically correspond to the item representation stored in the representation database 124 (shown in FIG. 1) directed to by a URI in the item representation path field 177 of the item entry 171 (shown in FIG. 7). The item name 798, 801 may display a name of the item and may specifically display at least a portion of the description stored in the description field 176 or the vendor description field 178 of the item entry 171. The item price 799, 802 displays the price of the item, and may specifically display the price stored in the price field 179 of the item entry 171.

In the specific embodiment shown in FIG. 35, the user navigates to the shopping cart page 780 after the user selected to shop from the image 634 on the shop image page 630 (shown in FIG. 25), and then selected item representation 716b′, representing a first item, from the first set region 712 and then item representation 718a′, representing a second item, from the second set region 714 (shown in FIG. 28). The shopping cart region 782 displays an item collection 784 as including a first item indicator 794 representing the first item and a second item indicator 796 representing the second item, and further displays the item collection 784 as associated with the image 634 and the visual attributes of the image 634. More specifically, in the embodiment shown, the first and second item indicators 794 and 796 may display, from the item entries 171 representing the first item and the second item respectively, (a) the item representation stored in the representation database 124 (shown in FIG. 1) directed to by a URI in the item representation path field 177 as the item representation 797, 800, (b) a portion of the description stored in the vendor description field 178 as the item name 798, 801, and (c) a price stored in the price field 179 as the item price 799, 802. The image source indicator 788 may display, from the image entry 141 (shown in FIG. 4) representing the image 634, (a) a hyperlink back to the image page 440 (shown in FIG. 16) of the image entry 141 as the image post link 789, (b) a username stored in the username field 137 of a user entry 131 identified in the identifier stored in the user identifier field 144 as the user indicator 790 and (c) visual attribute representations stored in the representation database 124 (shown in FIG. 1) directed to by the URIs stored in the visual attribute representation path fields 168 of visual attribute entries 161 (shown in FIG. 6) identified in the visual attribute identifier field 146 as the representation of visual attributes 792a-792f.

Still referring to the item collection 784, the subtotal indicator 804 provides a subtotal of the prices displayed in the item prices 799, 802 of the item indicators 794, 796 and thus generally corresponds to the total price to purchase all of the items in a particular item collection 784, 786. The edit collection button 806 allows a user to remove items from a particular item collection 784, and may further allow a user to change options associated with the item (such as clothing size, shoe widths, and furniture configurations stored in the options field 180 of the item entry 171 representing the item) and/or to change a purchased quantity of the item.

The buy collection button 810 enables the user to purchase the all items in a particular item collection 784, 786. For example, when the user selects the buy collection button 810, the user interface codes 330 may direct the microprocessor 102 to communicate with the vendor server 116 (shown in FIG. 1) or directly with the payment processor 117 (shown in FIG. 1) via information stored in the purchase path field 181 of the item entries 171 representing each item of the item collection 784, 786, to facilitate purchase of each item in that item collection 784, 786.

Still referring to FIG. 35, the buy all button 812 enables the user to purchase all items in the shopping cart, and thus all items of all item collections 784, 786 displayed on the shopping cart page 780. For example, when the user selects the buy all button 812, the user interface codes 330 may direct the microprocessor 102 to communicate with the vendor server 116, or directly with the payment processor 117, via information stored in the purchase path field 181 of the item entries 171 representing each item of each item collection 784, 786 displayed on the shopping cart page 780, to facilitate purchase of each item.

As described above in connection with determining which items are complementary with other items or with the text query (see blocks 660, 674 and 688 described above for example) and determining the order of items in the first and second sets (see blocks 661, 667, 676, 682, 690 and 696 described above for example), each time the user selects either the buy collection button 810 or the buy all button 812 of the shopping cart page 780, the user interface codes 330 may direct the microprocessor 102 to add a new instance of the purchase history entry 271 (shown in FIG. 12) to the purchase history table 270 (shown in FIG. 2). The new instance of the purchase history entry 271 functions as a record indicating that a particular user decided to purchase at least one item after being directed to that at least one item from a particular image (or palette). In certain embodiments, the purchase history entry 271 may also function as a record indicating that the particular items were purchased based on a selected visual attribute and/or an entered text query.

The new instance of the purchase history entry 271 stores, in the user identifier field 273, an identifier identifying the user entry 131 (shown in FIG. 3) representing the user whom purchased the items (such as the user who logged on using the login page 350 (shown in FIG. 13) for example). The new instance of the purchase history entry 271 also stores, in the item identifier field 274, at least one identifier identifying at least one item entry 171 (shown in FIG. 7) representing the at least one item purchased by the user. In embodiments where the user purchases more than one item, the item identifier field 274 may store more than one identifier identifying more than one item entry 171. The new instance of the combination history entry 291 also stores, in the image identifier field 296, an identifier identifying the image entry 141 (shown in FIG. 6) representing the image that the user initially selected to shop from (image 634 of the shop image page 630 (shown in FIG. 25) for example) or an identifier identifying the palette entry 191 (shown in FIG. 5) representing a customized palette that the user initially selected to shop from (a “rust” palette selected from a palette selection page 750 (shown in FIG. 34) for example). The new instance of the purchase history entry 271 may also store, in the created field 278, a time obtained from the clock 104 (shown in FIG. 1) generally corresponding to the time the instance of the purchase history entry 271 was created.

In certain embodiments, and specifically in embodiments where the user single selects or double selects a visual attribute (block 654 of the recommend items codes 650) using either the visual attribute representations 636a-636f displayed in the shop image page 630 (shown in FIG. 25) or using the visual attribute representations 708a-708f of the recommend items page 700 (shown in FIG. 28), the new instance of the purchase history entry 271 may further store, in the visual attribute identifier field 276, the identifier identifying the visual attribute entry 161 (shown in FIG. 6) representing the selected visual attribute. Further, in certain embodiments, and specifically in embodiments where the user enters a text query (blocks 656, 670 and 684 of the recommend items codes 650) using either the query fields 638 (shown in FIG. 25) or the 710 (shown in FIGS. 28 and 30-32), the new instance of the purchase history entry 271 may further store, in the taxonomy identifier field 298, an identifier identifying the taxonomy entry 221 (shown in FIG. 9) representing or generally corresponding to the text query entered by the user.

In general, embodiments such as those described above may facilitate customized recommendation of items based on visual attributes associated with the items and complementarity of items. Embodiments such as those described above may use (1) images received from users and (2) items representations of items received or retrieved from vendors to generate visual attributes associated with the images and the items. Embodiments described above then present items in an automatically generated first set of items and in an automatically generated second set of items different from the first set of items. The first set and the second set are displayed simultaneously and proximate each other to facilitate user perusal of options for an item that they searched for (the first set items for example) as well as different and possibly complementary items (the second set items for example). Some embodiments described above automatically retrieve first set items associated with visual attributes which match one visual attribute of an image and second set items associated with visual attributes which match other visual attributes of the image, such that all items of the first and second sets may have generally cohesive and complementary visual attributes that are based on a specific image. Further, some embodiments described above may automatically retrieve second set items which are different from the first set items but are complementary to the first set items. The user may then be automatically presented with, and may select or combine or purchase, items associated with complementary visual attributes (color, pattern, textures, etc.) and which are also complementary (of a same item category, of a matching item category, from a same vendor, etc.) to each other.

By presenting items in a first set and a complementary second set, the embodiments described above may facilitate an improved online shopping experience by allowing the user to view items in a manner that allows the user to visualize desirable ensembles, may further increase the likelihood that a user will purchase more items than the items the user initially searched for, and may provide a more efficient and targeted online shopping experience when compared to other methods of online shopping.

While specific embodiments have been described and illustrated, such embodiments should be considered illustrative of the subject matter described herein and not as limiting the claims as construed in accordance with the relevant jurisprudence.

1. A computer-implemented method comprising:
causing at least one processor configured with specific computer-executable instructions to:
cause a user device to display a visual attribute representation for each visual attribute of a plurality of visual attributes generated from at least one image, wherein each visual attribute is based at least in part on the at least one image and each visual attribute representation is selectable by a user of the user device;
identify a plurality of items based on information stored in an electronic database, wherein each item of the plurality of items is associated with a visual attribute matching at least one visual attribute of the plurality of visual attributes;
classify the plurality of items into a first set and a second set, wherein the items in the first set and the items in the second set are mutually exclusive and wherein:
if the at least one processor receives a single selection of a first visual attribute representation of a first visual attribute of the plurality of visual attributes, the first set consist of items associated with a visual attribute matching the first visual attribute and the second set comprise items associated with a visual attribute matching at least one visual attribute of the plurality of visual attributes; and
cause the user device to simultaneously display the first set and the second set proximate to each other.

2. The computer-implemented method of claim 1, wherein if the at least one processor receives the single selection, the second set also comprise items associated with a visual attribute matching the first visual attribute.

3. (canceled)

3. The computer-implemented method of claim 1, wherein if the at least one processor receives a double selection of the first visual attribute representation, the first set and the second set consist of items associated with a visual attribute matching the first visual attribute.

4. The computer-implemented method of claim 1, wherein if the at least one processor does not receive any selection of any of the visual attribute representations, the first set and second set both comprise items associated with a visual attribute matching any visual attribute of the plurality of visual attributes.

5. The computer-implemented method of claim 1, further comprising causing the at least one processor to determine a first order of the items in the first set and a second order of the items in the second set based at least in part on at least one of purchase history information, interaction history information and combination history information stored in association with the plurality of items in the electronic database, and
wherein causing the at least one processor to cause the user device to simultaneously display the first set and the second set comprises simultaneously displaying the first set in the first order and the second set in the second order.

6. The computer-implemented method of claim 1, wherein if the at least one processor receives a text query, the first set consist of items matching or corresponding to the text query and the second set comprise items at least one of complementary to at least one of the items in the first set and complementary to the text query.

7. The computer-implemented method of claim 1, wherein if the at least one processor receives a text query comprising a micro-item category or a macro item category, causing the at least one processor to classify items of the plurality of items into the first set comprises causing the at least one processor to classify the items into the first set based on first label information stored in association with the items in the electronic database, the first label information representing that the items are in a taxonomy matching or corresponding to the micro-item category or the macro-item category.

8. The computer-implemented method of claim 1, wherein if the at least one processor receives a text query comprising a micro-item category or a macro item category, causing the at least one processor to classify items of the plurality of items into the second set comprises causing the at least one processor to classify the item into the second set based on second label information stored in association with the items in the electronic database, the second label information representing at least one of:
the items are complementary to at least one of the items in the first set,
the items are in a taxonomy complementary to a taxonomy of at least one of the items in the first set, and
the items are in a taxonomy complementary to the micro-item category or the macro-item category included in the text query.

9. The computer-implemented method of claim 8, further comprising causing the at least one processor to determine the second label information based at least in part on at least one of purchase history information, interaction history information and combination history information stored in association with the items in the second set in the electronic database.

10. The computer-implemented method of claim 1, wherein causing the at least one processor to cause the user device to simultaneously display the first set and the second set comprises causing the at least one processor to cause the user device to display the first set and the second set such that the user can at least one of:
select at least one item from the items in the first set;
select at least one item from the items in the second set; and
simultaneously select at least one item from the items in the first set and at least one item from the items in the second set to form a combination.

11. The computer-implemented method of claim 10, further comprising causing the at least one processor to:
store an indication that the user selected an item from the items in the first set or an item from the items in the second set as interaction history information in association with the item in the electronic database; and
store an indication that the user formed the combination as combination history information in association with each item in the combination in the electronic database.

12. The computer-implemented method of claim 10, further comprising causing the at least one processor to store an indication that the user purchased at least one item from the items in the first set or from the items in the second set as purchase history information in association with the at least one item in the electronic database.

13. The computer-implemented method of claim 1, further comprising causing the at least one processor to:
receive the at least one image from the user device; and
process the at least one image to generate the plurality of visual attributes.

14. A system comprising:
a user device;
an electronic database; and
a computer readable medium storing non-transitory instructions, which, when executed by at least one processor in communication with the electronic database and the user device, cause the at least one processor to:
cause the user device to display a visual attribute representation for each visual attribute of a plurality of visual attributes generated from at least one image, wherein each visual attribute is based at least in part on the at least one image and each visual attribute representation is selectable by a user of the user device;
identify a plurality of items based on information stored in the electronic database, wherein each item of the plurality of items is associated with a visual attribute matching at least one visual attribute of the plurality of visual attributes;
classify the plurality of items into a first set and a second set, wherein the items in the first set and the items in the second set are mutually exclusive and wherein:
if the at least one processor receives a single selection of a first visual attribute representation of a first visual attribute of the plurality of visual attributes, the first set consist of items associated with a visual attribute matching the first visual attribute and the second set comprise items associated with a visual attribute matching at least one visual attribute of the plurality of visual attributes; and
cause the user device to simultaneously display the first set and the second set proximate to each other.

15. The system of claim 14, wherein if the at least one processor receives the single selection, the second set also comprise items associated with a visual attribute matching the first visual attribute.

16. The system of claim 14, wherein if the at least one processor receives a double selection of the first visual attribute representation, the first set and the second set consist of items associated with a visual attribute matching the first visual attribute.

17. The system of claim 14, wherein if the at least one processor does not receive any selection of any of the visual attribute representations, the first set and second set both comprise items associated with a visual attribute matching any visual attribute of the plurality of visual attributes.

18. The system of claim 14, wherein if the at least one processor receives a text query, the first set consist of items matching or corresponding to the text query and the second set comprise items at least one of complementary to at least one of the items in the first set and complementary to the text query.

19. The system of claim 14, wherein if the at least one processor receives a text query comprising a micro-item category or a micro-item category, the first set comprises items associated with first label information representing that the items are in a taxonomy matching or corresponding to the micro-item category or the macro-item category.

20. The system of claim 14, wherein if the at least one processor receives a text query comprising a micro-item category or a micro-item category, the second set comprises items associated with second label information representing at least one of:
the items are complementary to at least one of the items in the first set,
the items are in a taxonomy complementary to a taxonomy of at least one of the items in the first set, and
the items are in a taxonomy complementary to the micro-item category or the macro-item category included in the text query.
